(19) United States
(12) Patent Application Publication
(10) Pub. No.: US 2024/0346885 A1
(43) Pub. Date: Oct. 17, 2024

(54) METHOD AND SYSTEM FOR CONDUCTING A SECONDARY GAME BASED ON AN UNDERLYING, HISTORICAL-EVENT BASED PRIMARY GAME

(71) Applicant: Castle Island IP Holding LLC, Charlottesville, VA (US)

(72) Inventors: Daniel FULTON, Charlottesville, VA (US); Alan ROIREAU, Charlottesville, VA (US); Jason SPRINKLE, Charlottesville, VA (US); Barry SCOTT, Charlottesville, VA (US); Thomas ZAHORIK, Charlottesville, VA (US); Joshua LARSON, Charlottesville, VA (US); Brandon BOOKER, Charlottesville, VA (US)

(21) Appl. No.: 18/638,294

(22) Filed: Apr. 17, 2024

Related U.S. Application Data
(60) Provisional application No. 63/459,932, filed on Apr. 17, 2023.
(60) Provisional application No. 63/466,924, filed on May 16, 2023.
(60) Provisional application No. 63/520,753, filed on Aug. 21, 2023.
(60) Provisional application No. 63/583,453, filed on Sep. 18, 2023.
(60) Provisional application No. 63/632,120, filed on Apr. 10, 2024.
(60) Provisional application No. 63/471,354, filed on Jun. 6, 2023.
(60) Provisional application No. 63/520,758, filed on Aug. 21, 2023.
(60) Provisional application No. 63/590,972, filed on Oct. 17, 2023.
(60) Provisional application No. 63/602,905, filed on Nov. 27, 2023.

(51) Int. Cl. G07F 17/32

(52) U.S. Cl. CPC G07F 17/3265; G07F 17/3211

(57) ABSTRACT

An improved gaming systems, machines, and methods are provided enabling variable gameplay using a primary game underlying a secondary game. A gaming machine includes a display device configured to display an output to a user, an input device configured to accept a wager from the user for a primary game, the primary game being based on one or more historic events, a processor coupled to a memory, the input device and the display device. The gaming machine is configured to provide a secondary game to the user, receive an input from the user for the secondary game and convert the user input to the wager for the primary game, determine a result of the wager for the primary game, and provide an output of the secondary game to the user corresponding to the result of the wager.

### CROSS-REFERENCE TO RELATED APPLICATIONS

This application claims the benefit of and priority to U.S. Provisional Patent Application Ser. No. 63/459,932 filed on 17 Apr. 2023, U.S. Provisional Patent Application Ser. No. 63/466,924 filed on 16 May 2023, U.S. Provisional Patent Application Ser. No. 63/520,753 filed on 21 Aug. 2023, U.S. Provisional Patent Application Ser. No. 63/583,453 filed on 18 Sep. 2023, and U.S. Provisional Patent Application Ser. No. 63/632,120 filed on 10 Apr. 2024, which applications are each expressly incorporated herein by reference in their entirety.

This application further claims the benefit of and priority to U.S. Provisional Patent Application Ser. No. 63/471,354 filed on 6 Jun. 2023, U.S. Provisional Patent Application Ser. No. 63/520,758 filed on 21 Aug. 2023, U.S. Provisional Patent Application Ser. No. 63/590,972 filed on 17 Oct. 2023, and U.S. Provisional Patent Application Ser. No. 63/602,905 filed on 27 Nov. 2023, which applications are each expressly incorporated herein by reference in their entirety.

### FIELD OF THE DISCLOSURE

The field of the disclosure relates generally to gameplay stations, wagering terminals, and gaming servers, including gaming consoles, gaming machines or networked gaming machines, such as gameplay stations, wagering terminals, and gaming servers found in casinos or betting environments, and related methods of operation. The gaming devices include systems that may enable pari-mutuel wagering on past events, such as gaming consoles, mobile devices, personal computers, gaming machines or networked gaming machines, and related methods for conducting wagering games.

### BACKGROUND

Within the gambling or gaming industry, including sports betting, esports betting, games of chance, etc., traditional gaming machines include slot machines, poker machines, video lottery terminals, gaming consoles, and similar devices. These traditional gaming machines are configured to provide an interface for wagering on game events and have proven popularity. However, players quickly become tired of various adaptations of existing gaming machines, requiring the development of new and inventive ways to represent or play games on such gaming machines. For this reason, game creators must continually invent new and innovative ways to represent games and gameplay to stimulate players and encourage further interest.

Gaming in the United States is generally categorized into class I, class II and class III for the purposes of regulation. Class I gaming is generally defined as traditional tribal gaming which is subject to the least regulation. Class II gaming includes bingo and non-banked card games. And Class III gaming includes casino-style gambling such as table games (blackjack, craps, etc.), slots, and video poker. Class III gaming is subject to the greatest regulation and broadly encompasses all forms of gaming that are neither class I or II.

Many traditional gaming machines rely on displaying a game of chance, for example, games based on randomized events and/or fixed odds. These gaming machines employ lights, video displays, creative animations, and sounds to engage a player's interest and may allow a player the opportunity to play independently of others at their own selected pace, placing wagers up to every few seconds. The display and individualized control of gameplay accommodate players that seek a game that provides more immediate and sustained rewards than traditional games of skill or strategy.

Many players prefer games where they feel they can influence the outcome at least to some degree based on mental skill and knowledge, for example, using experience from the study of the game and/or mathematical analysis to place a more informed, or handicapped, wager. These traditional games of skill may often involve multiple players and require increased information, coordination and time to successfully conduct, but have proven popular throughout history and are generally more widely permitted by regulators than pure games of chance.

As a non-limiting example of a game where players can influence the outcome based on mental skill and knowledge, horse racing is a particularly popular and long-enduring basis for gaming that has won more widespread acceptance, such that it is subject to less regulation than other games of chance. Horse racing is recognized as a game of skill where experienced players can analyze information on the race participants before placing informed or handicapped wagers, and the racing itself provides an entertaining presentation for the players. Gaming associated with horse racing can differ from fixed-odds betting and may benefit from the advantages of pari-mutuel betting, where a player's wager may be placed into a pool or may be divided into several betting pools for different winning possibilities, such as picking the winner of a race, picking the top three finishers in exact order, or any of three selections finishing first and second, with the money in different pools accumulating until it is won.

The strategic elements associated with horse racing allow players to feel more like a participant in a larger event and increase both a player's interest and excitement.

To facilitate their analysis of the race, a player may require access to a variety of data, such as historical data relating to a particular horse and to how the horse has performed in different distances, different environmental conditions, and other racing conditions, as well as data on the jockey and trainer associated with the horse. This information is generally provided to players at a racetrack in a daily racing form or horse-racing form. Players may also require information on the betting pools and the payouts involved.

Although drawn to the strategic elements of the game, casual players are often intimidated by the amount of information presented and its format. These players can become frustrated when interpreting the information to have a coherent and enjoyable gaming strategy. New players are also limited by access to horse races due to the limited racing schedules and facilities required by such events.

Unfortunately, the inventors of the present application have found that existing efforts to develop a gaming machine or system capable of combining the advantages of traditional gaming machines and traditional games of skill have had only limited success.

In view of the foregoing, the inventors of the present application have identified a significant need for an improved gaming machine and method that incorporates the advantages of traditional games of skill in gaming machines, to combine the most appealing features of each. The inventors of the present application have identified a need that exists for an improved gaming machine capable of providing a user with rapid, varied, and entertaining gameplay while presenting the information necessary for strategic wagering in an easy-to-use and understandable manner.

### SUMMARY

A gaming machine for conducting a secondary game based on an underlying, historical-event based primary game is provided comprising a display device configured to display an output to a user, an input device configured to accept a wager from the user for a primary game, the primary game being based on one or more historic events, and a processor coupled to a memory, the input device and the display device. The gaming machine may be configured to provide a secondary game to the user, receive an input from the user for the secondary game and convert the user input to the wager for the primary game, determine a result of the wager for the primary game, and provide an output of the secondary game to the user corresponding to the result of the wager.

A method for conducting a secondary game based on an underlying, historical-event based primary game is provided comprising providing a primary game at a gaming machine, providing a secondary game to a user at the gaming machine, receiving an input from the user for the secondary game and converting the user input to a wager for the primary game, determining a result of the wager for the primary game, and providing an output of the secondary game to the user corresponding to the result of the wager.

A gaming machine for conducting a secondary game based on an underlying, historical-event based primary game is provided comprising a display device configured to display an output to a user, an input device configured to accept a wager from the user for a primary game, the primary game being based on one or more historic events, and a processor coupled to a memory, the input device and the display device. The gaming machine may be configured to provide a secondary game to the user, the secondary game comprising a table game, determine a result of the wager for the primary game, and provide an output of the secondary game to the user corresponding to the result of the wager.

A method for conducting a secondary game based on an underlying, historical-event based primary game is provided comprising providing a primary game at a gaming machine, providing a secondary game to a user at the gaming machine, determining a result of a wager for the primary game, and providing an output of the secondary game to the user corresponding to the result of the wager.

In the above-noted gamine machines and methods, the one or more selected events may be historical horse races. The secondary game may be a table game, including for example, but not limited to, one or more of poker, baccarat, blackjack, craps, roulette, a big six wheel or wheel of fortune, pool, pachinko, chemin de fer, pai gow, a lottery, keno, or any other table game, or bingo. If required, the input from the user for the secondary game comprises one or more of a “hit”, “stay”, “roll”, a predicted winning number, and a predicted winning entity.

These and other features of the disclosure will become better understood by reference to the following description, appended claims, and accompanying drawings.

### BRIEF DESCRIPTION OF THE DRAWINGS

FIG. 1 is a perspective view of a gaming machine according to the present disclosure.

FIG. 2A is a diagrammatic view of an electronic system of a gaming machine according to the present disclosure.

FIG. 2B is a diagrammatic view of a gaming system according to the present disclosure.

FIG. 3 is a flowchart of a method of operating a gaming machine according to the present disclosure.

FIG. 4A is a flowchart of a method of operating a gaming machine according to the present disclosure.

FIG. 4B is a flowchart of a method of operating a gaming machine according to the present disclosure.

FIG. 4C is a flowchart of a method of operating a gaming machine according to the present disclosure.

FIG. 5A is an illustration of an embodiment of a keno style extra game according to the present disclosure.

FIG. 5B is an illustration of the embodiment of a keno style extra game according to the embodiment of FIG. 5A.

FIG. 5C is an illustration of the embodiment of a keno style extra game according to the embodiment of FIG. 5A.

FIG. 5D is an illustration of the embodiment of a keno style extra game according to the embodiment of FIG. 5A with a secondary game of roulette.

FIG. 6A is an illustration of an embodiment of a secondary game of roulette according to the present disclosure.

FIG. 6B is an illustration of the embodiment of a secondary game of roulette according to the embodiment of FIG. 6A including a multiplier ball according to the present disclosure.

FIG. 7 is an illustration of pay lines or scorecards for a primary game of HHR according to the present disclosure.

FIG. 8 is an illustration of a secondary game of blackjack including a secondary attribute of a scratcher space according to the present disclosure.

FIG. 9 is an illustration of a bonus picking game according to the present disclosure.

FIGS. 10A-10C include illustrations of pay lines or scorecards for a primary game of HHR according to the present disclosure.

FIG. 11 is an illustration of a secondary game of blackjack including a secondary attribute of a scratcher space according to the present disclosure.

FIGS. 12A-12B include illustrations of a secondary game of blackjack including a secondary attribute of a joker card according to the present disclosure.

FIG. 13 is an illustration of a secondary game of blackjack including a secondary attribute of a joker card according to the present disclosure.

FIG. 14 is an illustration of an embodiment of a Lucky 7 style extra game according to the present disclosure.

FIGS. 15A-15F include illustrations of a Lucky 7 style extra game for a secondary game of blackjack according to the present disclosure.

FIGS. 16A-16G include illustrations of a secondary game of keno according to the present disclosure.

FIG. 17 is an illustration of pay lines or scorecards for a primary game of HHR according to the present disclosure.

FIGS. 18A-18E include illustrations of a secondary game of blackjack according to the present disclosure.

FIG. 19 includes an illustration of an embodiment of a secondary game having tertiary decisions based on an underlying primary game of HHR.

FIG. 20 includes an illustration of a secondary game of blackjack according to the present disclosure.

FIG. 21 includes an illustration of an embodiment of a secondary game having tertiary decisions based on an underlying primary game of HHR.

FIG. 22 includes an illustration of an embodiment of a multiplayer secondary game based on an underlying primary game of HHR.

FIG. 23 includes an illustration of an embodiment of a multiplayer secondary game based on an underlying primary game of HHR.

FIGS. 24A and 24B include illustrations of an embodiment of a multiplayer secondary game based on an underlying primary game of HHR.

FIG. 25 includes an illustration of an embodiment of a multiplayer secondary game based on an underlying primary game of HHR.

FIG. 26 includes an illustration of a secondary game of baccarat according to the present disclosure.

FIG. 27 includes an illustration of a secondary game of baccarat according to the present disclosure.

FIG. 28 includes an illustration of a primary game and a corresponding secondary game based thereon according to the present disclosure.

FIG. 29 includes an illustration of a secondary game according to the present disclosure.

FIG. 30 includes an illustration of a secondary game according to the present disclosure.

FIG. 31 includes an illustration of a secondary game according to the present disclosure.

FIG. 32 includes an illustration of a secondary game of poker according to the present disclosure.

FIGS. 33A-33E include illustrations of a secondary game of poker according to the present disclosure.

FIGS. 34A-34C include illustrations of a secondary game of poker according to the present disclosure.

FIG. 35 includes an illustration of a secondary game of roulette having a secondary attribute according to the present disclosure.

FIGS. 36A-36F include illustrations of a secondary game of roulette having a secondary attribute of an inner wheel according to the present disclosure.

FIG. 37 includes an illustration of a secondary game of roulette having a secondary attribute of a bonus spot according to the present disclosure.

FIG. 38 includes an illustration of a secondary game of roulette having a secondary attribute of a re-spin spot according to the present disclosure.

FIGS. 39A-39D include illustrations of a secondary game of blackjack having an additional poker hand pay table according to the present disclosure.

FIG. 40 includes an illustration of a secondary game of blackjack having a secondary attribute of a bonus spot on a backside according to the present disclosure.

FIG. 41 includes an illustration of a scorecard for a primary game of HHR according to the present disclosure.

FIG. 42 includes an illustration of a secondary game of keno having a secondary attribute of a bonus pattern pay in a pay table according to the present disclosure.

FIGS. 43A-43C include illustrations of a secondary game of keno having a secondary attribute of a cumulative bonus pattern pay according to the present disclosure.

FIG. 44 includes an illustration of a secondary game of blackjack with insurance using an underlying primary game according to the present disclosure.

FIG. 45 includes an illustration of a pay table for a primary game according to the present disclosure.

FIG. 46 includes an illustration of a pay table for a primary game according to the present disclosure.

FIG. 47 includes an illustration of a method of conducting a secondary game with insurance using an underlying primary game according to the present disclosure.

FIG. 48 includes an illustration of a method of conducting a secondary game without insurance using an underlying primary game according to the present disclosure.

FIG. 49 illustrates scorecard packs according to the present disclosure.

FIG. 50 illustrates a multiplayer secondary game of blackjack based on an underlying primary game of HHR using scorecard packs according to the present disclosure.

FIGS. 51A and 51B illustrate gameplay for a first player according to the embodiment of FIG. 50.

FIGS. 52A, 52B and 52C illustrate gameplay for a second player according to the embodiment of FIG. 50.

The figures are not necessarily drawn to scale, but instead are drawn to provide a better understanding of the components, and are not intended to be limiting in scope, but to provide exemplary illustrations. The figures illustrate exemplary configurations of a system and method for gaming, and in no way limit the structures, configurations, or methods of the system and method for gaming according to the present disclosure.

### DETAILED DESCRIPTION OF VARIOUS EMBODIMENTS

### I. Introduction

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. The dimensions, angles, and curvatures represented in the figures introduced above are to be understood as exemplary and are not necessarily shown in proportion. It should be understood, however, there is no intention to limit the disclosure to the specific embodiments disclosed, but on the contrary, the intention covers all modifications, alternative constructions, combinations, and equivalents falling within the spirit and scope of the disclosure.

The flowchart illustrations and block diagrams in the flow diagrams illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart illustrations and/or block diagram block or blocks.

The disclosed embodiments relate to systems and methods for gaming that overcome the problems of static gameplay in existing gaming machines and provide an improved experience for players. The disclosure outlines some example improvements and practical applications provided by the disclosed embodiments. These are just examples only and the embodiments are not limited to only these improvements.

Examples of the current disclosure may be provided to facilitate betting on one or more historical events, such as historical racing events, including, for example, historical horse racing (HHR), historical dog racing events, historical car racing events. The historical events may include other sporting events that concluded in the past, including, but not limited to historical basketball events, football events, soccer events, bowling events, golf events, baseball events, rugby events, hockey events. As used herein, an event could include a single game, series of games or competitions, tournament play, or season play as a whole, or other combinations of games or competitions. Indeed the historical event could also include other events that could form the basis of wagering, such as, but not limited to political events or outcomes or even weather events. While some embodiments may be described in terms referring to HHR, there is no intention to limit the disclosure thereto. Rather, the possibility of applying the same or similar principles of embodiments of the current disclosure to alternative forms of gaming.

The inventive concepts disclosed herein and embodiments may be implemented to overcome many of the technical difficulties and computational expenses associated with gaming, including obtaining and transforming data of one or more events which included multiple participants or variables, including features of the multiple participants and/or associated odds. The inventive concepts disclosed herein and embodiments may provide a combined order of specified rules that render the data of the events and/or the features of the multiple participants into a specific format used to create varying reward values dependent on one or more of an award level, a total pool value of a pari-mutuel pool, and an entertaining display or secondary game. By providing the system and method for gaming according to the inventive concepts disclosed herein and embodiments, the defining rules and procedures for determining the reward values may be applied to multiple entertaining displays or secondary game types, thereby providing improved variety and variability in gameplay.

The disclosed embodiments operate to improve how a gaming machine comprising a computing device operates and/or functions. For instance, the disclosed embodiments are able to automatically increase the variety and variability of entertaining displays or secondary game types available for gaming by following the disclosed principles. Furthermore, the processing speed and operational efficiency of the gaming machine can be improved. As a consequence, the disclosed embodiments operate to improve the computing efficiency and resource utilization of a gaming machine and related computing architecture. As an additional example, by varying the entertaining display or secondary game type based on the reward values and the result of the player's wager, the disclosed embodiments will also improve the presentation of the game to a player.

The disclosed embodiments may be implemented in various configurations for gaming machines, gaming devices, or gaming systems, including but not limited to: (1) a dedicated gaming machine, gaming device, or gaming system wherein the computerized instructions for controlling any games (which are provided by the gaming machine or gaming device) are provided with the gaming machine or gaming device prior to delivery to a gaming establishment; and (2) a changeable gaming machine, gaming device, or gaming system wherein the computerized instructions for controlling any games (which are provided by the gaming machine or gaming device) are downloadable to the gaming machine or gaming device through a data network after the gaming machine or gaming device is in a gaming establishment.

In embodiments, the computerized instructions for controlling games may be executed by at least one central server, central controller, or remote host. In such a “thin client” embodiment, the central server remotely controls any games (or other suitable interfaces) and the gaming machine is utilized to display such games (or suitable interfaces) and receive one or more inputs or commands from a player. In another embodiment, the computerized instructions for controlling games may be communicated from the central server, central controller, or remote host to a gaming machine's local processor and memory devices. In such a “thick client” embodiment, the gaming machine's local processor executes the communicated computerized instructions to control any games (or other suitable interfaces) provided to a player.

### II. Gaming Machine and Gaming System

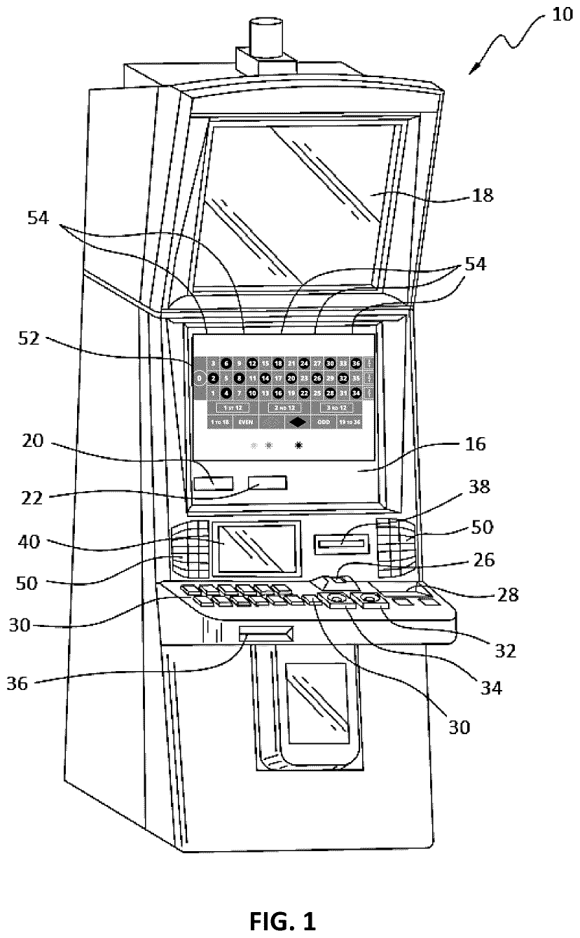

Referring to FIG. 1, one embodiment of a gaming machine 10, according to an embodiment of the present disclosure, has a support structure, housing, or cabinet which provides support for a plurality of displays, inputs, controls, and other features of a conventional gaming machine. It may be configured so that a player can operate it while standing or sitting. The gaming machine 10 can be positioned on a base or stand or can be configured as a pub-style table-top game (not shown) which a player can operate preferably while sitting. The gaming machine 10 may have varying cabinet and display configurations.

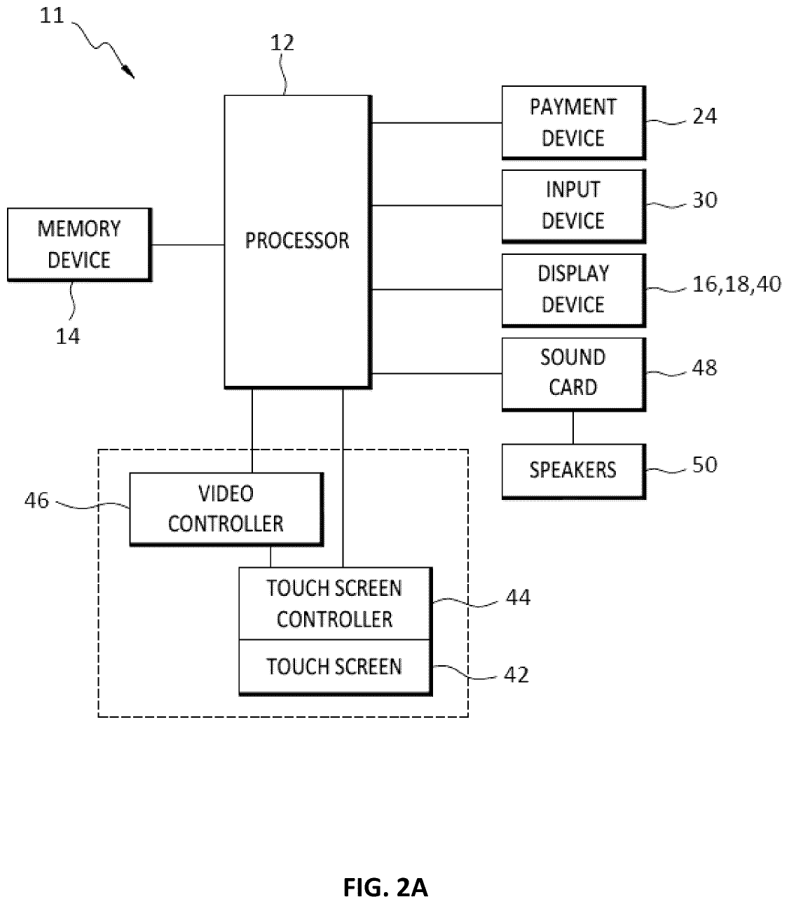

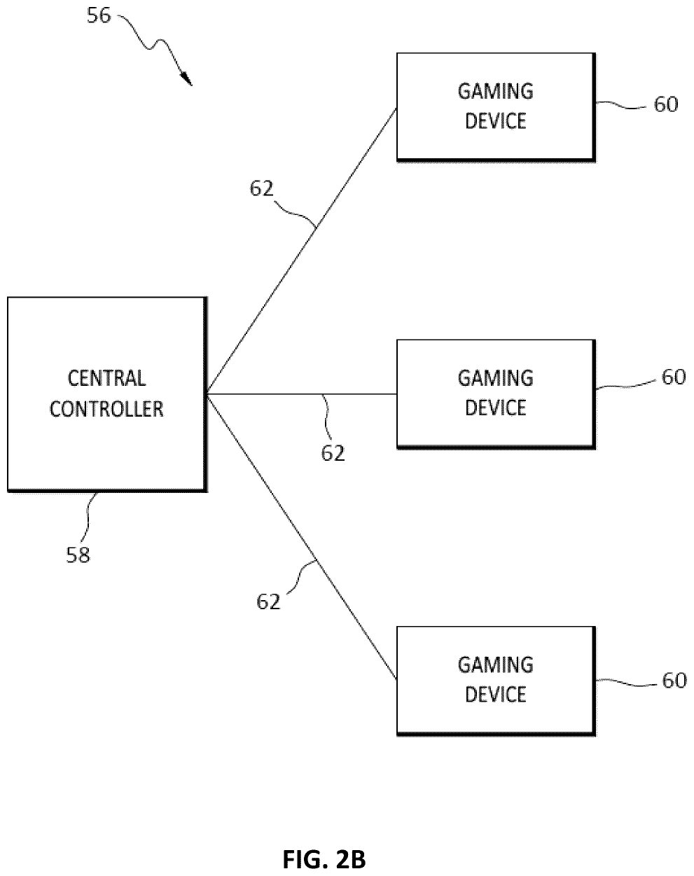

In one embodiment, as illustrated in FIG. 2A, an electronic system for facilitating gaming by a player according to the present disclosure is generally shown at 11. The electronic system 11 may be a separate gaming machine or used with the gaming machine 10 of FIG. 1. The electronic system 11 may include at least one processor 12, such as a microprocessor, a microcontroller-based platform, a suitable integrated circuit or one or more application-specific integrated circuits (ASIC's). The processor 12 may be in communication with or operable to access or to exchange signals with at least one data storage or memory device 14.

In an embodiment, the processor 12 and the memory device 14 may reside within the cabinet of the gaming machine 10. The memory device 14 may store program code and instructions, executable by the processor 12, to control the gaming machine 10. The memory device 14 may also store other data such as image data, event data, player input data, random or pseudo-random number generators, pay-table data or information, and applicable game rules that relate to the play of the game. In an embodiment, the memory device 14 may include random access memory (RAM), which can include non-volatile RAM (NVRAM), magnetic RAM (MRAM), ferroelectric RAM (FeRAM), and other forms. In one embodiment, the memory device 14 may include read only memory (ROM). In one embodiment, the memory device 14 may include flash memory and/or EEPROM (electrically erasable programmable read only memory). Any other suitable magnetic, optical, and/or semiconductor memory may operate in conjunction with the electronic system 11.

In one embodiment, part or all of the program code and/or operating data described above may be stored in a detachable or removable memory device 14, including, but not limited to, a suitable cartridge, disk, CD ROM, DVD, or USB memory device. In other embodiments, part or all of the program code and/or operating data described above may be downloaded to the memory device 14 through a suitable network.

In one embodiment, an operator or a player can use such a removable memory device in a desktop computer, a laptop computer, a hand-held device, such as a personal digital assistant (PDA), a portable computing or mobile device, or another computerized platform to implement embodiments of the present disclosure. In one embodiment, the electronic system 11 is operable over a wireless network, for example as part of a wireless gaming machine. In one such embodiment, the electronic system 11 may be a hand-held device, a mobile device, or any other suitable wireless device that enables a player to play any suitable game at a variety of different locations.

In various embodiments in which the electronic system 11 may be a hand-held device, a mobile device, or any other suitable wireless device, at least one memory device 14 and at least one processor 12 which control the game or other operations of the hand-held device, mobile device, or other suitable wireless device may be located: (a) at the hand-held device, mobile device or other suitable wireless device; (b) at a central server or central controller; or (c) any suitable combination of the central server or central controller and the hand-held device, mobile device or other suitable wireless device. A gaming device or gaming machine as disclosed herein may be a device that has obtained approval from a regulatory gaming commission or a device that has not obtained approval from a regulatory gaming commission. The processor 12 and memory device 14 may be collectively referred to herein as a “computer,” “computing device” or “controller.”

In embodiments, as illustrated in FIG. 2A, the electronic system 11 may include one or more display devices 16, 18, 40 controlled by the processor 12. The display devices 16, 18, 40 may preferably be connected to or mounted on the cabinet of the gaming machine 10. The embodiment shown in FIG. 1 includes a central display device 16 which displays a primary or base game and an upper display device 18. The central display device 16 may also display any suitable secondary game associated with the primary or base game as well as information relating to the primary or secondary game. The upper display device 18 may display the primary game, any suitable secondary game associated or not associated with the primary game, and/or information relating to the primary or secondary game. These display devices 16, 18 may also serve as digital glass operable to advertise games or other aspects of the gaming establishment.

As seen in FIG. 1, in various embodiments, the gaming machine 10 may include a credit display 20 which displays a player's current number of credits, cash, account balance, or the equivalent. The gaming machine 10 may include a bet display 22 which displays a player's amount wagered. The gaming machine 10 may include a player tracking display 40 which displays information regarding a player's play status, such as including past wins, number of past wagers, etc. One or more of these display devices 16, 18, 20, 22, 40 may be in communication with the processor 12.

In another embodiment, at least one display device may be a mobile display device, such as a PDA or tablet PC, that enables play of at least a portion of the primary or secondary game at a location remote from the gaming machine 10 or electronic system 11.

The display devices 16, 18, 40 may include, without limitation, a monitor, a television display, a plasma display, a liquid crystal display (LCD) a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In one embodiment, as described in more detail below, the display devices 16, 18, 40 include a touch-screen with an associated touch-screen controller. The display devices 16, 18, 40 may be of any suitable size and configuration, such as a square, a rectangle or an elongated rectangle.

The display devices 16, 18, 40 of the gaming machine 10 may be configured to display at least one and preferably a plurality of games or other suitable images, symbols and indicia such as any visual representation or exhibition of the movement of objects such as mechanical and/or virtual.

In one embodiment, the symbols, images and indicia displayed on or of the display device may be in mechanical form. That is, the display devices 16, 18, 40 may include any electromechanical device, such as one or more mechanical objects. An example of an exemplary electromechanical device according to embodiments of the disclosure may include a roulette wheel, dice, cards, or the like, configured to display at least one or a plurality of games or other suitable images, symbols or indicia.

As illustrated in FIG. 2A, the electronic system 11 may include at least one payment device 24 in communication with the processor 12. The payment device 24 may be a payment acceptor including a note, ticket or bill acceptor 28 (FIG. 1) wherein the player inserts paper money, a ticket, or voucher, and/or a coin slot 26 (FIG. 1) where the player inserts money, coins, or tokens. In other embodiments, other payment devices 24 such as readers or validators for credit cards, debit cards or credit slips may accept payment. A player may insert an identification card into a card reader 24 of the gaming machine 10.

An identification card may be a smart card having a programmed microchip, a coded magnetic strip or coded rewritable magnetic strip, wherein the programmed microchip or magnetic strips are coded with a player's identification, credit totals (or related data), and/or other relevant information. In another embodiment, a player may carry a portable device, such as a cell phone, a radio frequency identification tag, or any other suitable wireless device, which communicates a player's identification, credit totals (or related data), and other relevant information to the gaming machine 10. In one embodiment, money may be transferred by a player to a gaming machine 10 through electronic funds transfer. When a player funds the gaming machine 10, the processor 12 may determine the amount of funds entered and display the corresponding amount on the credit or other suitable display as described previously.

As seen in FIGS. 1 and 2A, in an embodiment the gaming machine 10 and electronic system 11 may include at least one input device 30 in communication with the processor 12. The at least one input device 30 can include any suitable device which enables the player to produce an input signal which is received by the processor 12. In one embodiment, after appropriate funding of the gaming machine 10, the input device 30 is a game-activation device, such as a play button 32 or a pull arm (not shown) which is used by the player to start any primary or base game or sequence of events in the gaming machine 10. The play button 32 can be any suitable play activator such as a bet-one button, a max-bet button, or a repeat-the-bet button. In an embodiment, upon appropriate funding, the gaming machine 10 may begin game play automatically. In another embodiment, upon the player engaging one of the play buttons 32, the gaming machine 10 automatically activates game play.

In an embodiment, one input device may be a bet one button. The player may place a bet by pushing the bet-one button 32. The player can increase the bet by one credit each time the player pushes the bet-one button 32. When the player pushes the bet-one button 32, the number of credits shown in the credit display 20 preferably decreases by one, and the number of credits shown in the bet display preferably increases by one. In another embodiment, one input device 30 is a bet-max button (not shown) which enables the player to bet the maximum wager permitted for a game of the gaming machine 10.

In one embodiment, one input device is a cash out button 34. The player may push the cash out button 34 and cash out to receive a cash payment or other suitable form of payment corresponding to the number of remaining credits. In one embodiment, when the player cashes out, a payment device, such as a ticket, payment, or note generator 36 prints or otherwise generates a ticket or credit slip to provide to the player. The player receives the ticket or credit slip and may redeem the value associated with the ticket or credit slip via a cashier (or other suitable redemption system).

In another embodiment, when the player cashes out, the player receives the coins or tokens in a coin payout tray. In one embodiment, the gaming machine 10 includes at least one card reader 38 in communication with the processor 12. In this embodiment, a player is issued a player identification card which has an encoded player identification number that uniquely identifies the player. When the player inserts their playing tracking card into the card reader 38 to begin a gaming session, the card reader 38 reads the player identification number off the player tracking card to identify the player. Any suitable payout mechanism, such as funding to the player's electronically recordable identification card or smart card, may be implemented in accordance with the gaming machine 10.

In one embodiment, as mentioned above and as seen in FIG. 2A, one input device may be a touch-screen 42 coupled with a touch-screen controller 44 or some other touch-sensitive display overlay to allow for player interaction with the images on the touch screen 42. The touch-screen 42 and the touch-screen controller 44 may be connected to a video controller 46. A player can make decisions and input signals into the gaming machine 10 or the electronic system 11 by touching the touch-screen 42 at the appropriate locations. One such input device is a conventional touch-screen button panel.

The electronic system 11 may further include a plurality of communication ports for enabling communication of the processor with external peripherals, such as external video sources, expansion buses, game or other displays, a SCSI port, or a keypad.

In an embodiment, as seen in FIG. 2A, the electronic system 11 may include a sound generating device controlled by one or more sounds cards 48 which function in conjunction with the processor 12. In one embodiment, the sound-generating device includes at least one and preferably a plurality of speakers 50 or other sound-generating hardware and/or software for generating sounds. The sound-generating device may, for example, play music for the primary and/or secondary game or play music for other modes of the gaming machine 10, such as an attract mode.

In one embodiment, the gaming machine 10 may provide dynamic sounds coupled with attractive multimedia images displayed on one or more of the display devices 16, 18, 40 to provide an audio-visual representation or to otherwise display full-motion video with sound to attract players to the gaming machine 10. During idle periods, the gaming machine 10 may display a sequence of audio and/or visual attraction messages to attract potential players to the gaming machine 10. The videos may also be customized to provide any appropriate information.

In one embodiment, the gaming machine 10 may include a sensor, such as a camera, in communication with the processor 12 (and possibly controlled by the processor 12), that is selectively positioned to acquire an image of a player actively using the gaming machine 10 and/or the surrounding area of the gaming machine 10. In one embodiment, the camera may be configured to selectively acquire still or moving (e.g., video) images and may be configured to acquire the images in an analog, digital, or other suitable format. The display devices 16, 18, 40 may be configured to display the image acquired by the camera as well as to display the visual features of the game in split screen or picture-in-picture fashion. For example, the camera may acquire an image of the player and the processor may incorporate that image into the primary and/or secondary game as a game image, symbol or indicia.

The gaming machine 10 may incorporate a historical-event based wagering game as the primary or base game, and may incorporate a table game as the secondary game or as the entertaining display game. The gaming machine 10 may include some or all of the features of conventional gaming machines or devices.

In one embodiment, as illustrated in FIG. 1, an entertaining display may be provided on the gaming machine corresponding to a secondary game 52. In various embodiments, the gaming machine 10 may include one or more secondary game elements 54, such as a roulette table, a craps table, a roulette wheel, cards, dice, or the like, in either electromechanical form with mechanical elements or video form with simulated elements and movement thereof. The secondary game elements 54 preferably correspond to a theme associated with one or more secondary game 52 of the gaming machine 10. The gaming machine 10 may control the secondary game elements 54 of the entertaining display to be displayed in an arrangement corresponding to a result of the player's wager.

In one embodiment, as illustrated in FIG. 2B, a gaming system according to the present disclosure is generally shown at 56. The gaming system 56 may include at least one central controller 58 and one or more gaming controllers or devices 60 in communication with each other and/or the at least one central controller 58 through a data network or remote communication link 62. In this embodiment, the central server, central controller, central computer, or remote host is any suitable server or computing device which includes at least one processor and at least one memory or storage device. In different such embodiments, the central server is a progressive controller or a processor of one of the gaming machines in the gaming system.

In these embodiments, the processor of each gaming machine is designed to transmit and receive events, messages, commands, or any other suitable data or signal between the individual gaming machine and the central server. The gaming machine processor is operable to execute such communicated events, messages, or commands in conjunction with the operation of the gaming machine. Moreover, the processor of the central server is designed to transmit and receive events, messages, commands, or any other suitable data or signal between the central server and each of the individual gaming machines. The central server processor is operable to execute such communicated events, messages, or commands in conjunction with the operation of the central server. One, more or each of the functions of the central controller, central server or remote host as disclosed herein may be performed by one or more gaming machine processors. One, more or each of the functions of one or more gaming machine processors as disclosed herein may be performed by the central controller, central server or remote host.

In one embodiment, a plurality of the gaming machines 60 are capable of being connected together through a data network. In one embodiment, the data network is a local area network (LAN), in which one or more of the gaming machines 60 are substantially proximate to each other and an on-site central server or controller as in, for example, a gaming establishment or a portion of a gaming establishment. In another embodiment, the data network is a wide area network (WAN) in which one or more of the gaming machines are in communication with at least one off-site central server or controller. In this embodiment, the plurality of gaming machines 60 may be located in a different part of the gaming establishment or within a different gaming establishment than the off-site central server or controller. Thus, the WAN may include an off-site central server or controller and an off-site gaming machine located within gaming establishments in the same geographic area, such as a city or state. The WAN gaming system may be substantially identical to the LAN gaming system described above, although the number of gaming machines in each system may vary relative to one another.

In another embodiment, the data network 62 may include the internet or an intranet. In this embodiment, the operation of the gaming machine 60 may be viewed at the gaming machine 60 using at least one internet browser implemented thereon. In this embodiment, operation of the gaming machine 60 and accumulation of credits may be accomplished with only a connection to the central server or controller 58 (the internet/intranet server) through a conventional phone or other data transmission line, digital subscriber line (DSL), T-1 line, coaxial cable, fiber optic cable, or other suitable connection. In this embodiment, players may access an internet game page from any location where an internet connection and computer or other internet facilitator is available. The expansion in the number of computers and number and speed of internet connections in recent years increases opportunities for players to play from an ever-increasing number of remote sites. The enhanced bandwidth of digital wireless communications may render such technology suitable for some or all communications, particularly if such communications are encrypted. Higher data transmission speeds may be useful for enhancing the sophistication and response of the display and interaction with the player.

As mentioned above, embodiments may be employed in a server-based gaming system. In one such embodiment, as described above, one or more gaming machines 60 may be in communication with a central server or controller 58. The central server or controller 58 may be any suitable server or computing device which includes at least one processor and a memory or storage device. In alternative embodiments, the central server is a progressive controller or another gaming machine in the gaming system. In one embodiment, the memory device of the central server stores different game programs and instructions, executable by a gaming machine processor, to control the gaming machine. Each executable game program may represent a different game or type of game which may be played on one or more of the gaming machines in the gaming system. Such different games may include the same or substantially the same game play with different pay tables. In different embodiments, the executable game program is for a primary game, a secondary game or both. In another embodiment, the game program may be executable as a secondary game to be played simultaneous with the play of a primary game (which may be downloaded to or fixed on the gaming machine) or vice versa.

In this embodiment, each gaming machine 60 at least includes one or more display devices and/or one or more input devices for interaction with a player. A local processor, such as the above-described gaming machine processor or a processor of a local server, is operable with the display device(s) and/or the input device(s) of one or more of the gaming machines.

In operation, the central controller 58 may be operable to communicate one or more of the stored game programs to at least one local processor. In different embodiments, the stored game programs may be communicated or delivered by embedding the communicated game program in a device or a component (e.g., a microchip to be inserted in a gaming machine), writing the game program on a disc or other media, or downloading or streaming the game program over a dedicated data network, internet, or a telephone line. After the stored game programs are communicated from the central server, the local processor may execute the communicated program to facilitate play of the communicated program by a player through the display device(s) and/or input device(s) of the gaming machine. That is, when a game program is communicated to a local processor, the local processor changes the game or type of game played at the gaming machine.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis.

The methodologies described herein may be implemented by various means depending upon applications according to particular examples. For example, such methodologies may be implemented in hardware, firmware, software, or combinations thereof. In a hardware implementation, for example, the controller or processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the description included herein are presented in terms of algorithms or symbolic representations of operations on binary digital signals stored within a memory of a specific apparatus or special purpose computing device or platform. In the context of this particular specification, a specific apparatus or the like includes a general-purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities.

Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be appreciated, however, that all of these or similar terms are to be associated with appropriate physical quantities and are merely convenient labels. Unless specifically stated otherwise, as apparent from the discussion herein, throughout this specification discussions utilizing terms such as “processing,” “computing,” “calculating,” “determining” or the like refer to actions or processes of a specific apparatus, such as a special purpose computer or a similar special purpose electronic computing device. In the context of this description, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

For clarity in discussing the various functions of the system, multiple computers and/or servers are discussed as performing different functions. These different computers (or servers) may, however, be implemented in multiple different ways such as modules within a single computer, as nodes of a computer system, etc. The functions performed by the system (or nodes or modules) may be centralized or distributed in any suitable manner across the system and its components, regardless of the location of specific hardware. Furthermore, specific components of the system may be referenced using functional terminology in their names. The function terminology is used solely for purposes of naming convention and to distinguish one element from another in the following discussion. Unless otherwise specified, the name of an element conveys no specific functionality to the element or component. In selected embodiments, the software, hardware, and associated components of the system may be programmed and configured to implement one or more embodiments described herein. The various aspects of the system may be exemplified as software, modules, nodes, etc. of a computer or server device.

Embodiments of the current disclosure may include a gaming machine or system configured to facilitate wagering on one or more events. The central controller or server 58 of the system may include databases, terminals, and computing devices, such as to manage one or more common betting pools in a pari-mutuel wagering environment. The central controller 58 may include a totalizer for accepting and processing wagers of a plurality of players, making pool allocations, calculating odds and prices of wagers, calculating the commission for the operator, and distributing winnings. Reward values may be distributed to players based on scorecards including positive and negative picks that are associated with a wagering pool of the totalizer. The central controller 58 may maintain separate math models and separate pari-mutuel wagering pools for different denominations and wager levels offered by each model.

### III. Primary Game

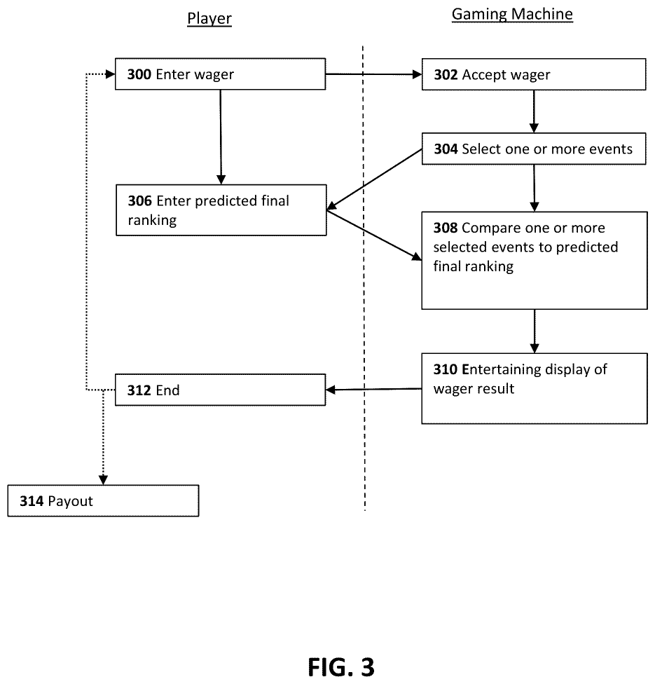

According to an embodiment of the current disclosure, the gaming machine 10 may be configured to facilitate wagering on events by a player as illustrated in the flowchart illustration of FIG. 3. The gaming machine 10 may incorporate a historical-event based wagering game as a primary or base game.

The player may initiate a game on the gaming machine 10 and may place a wager 300 by any suitable method, such as described previously by transferring money to the gaming machine 10. At least one or a plurality of input devices 30 may be used to facilitate the wager and the gaming machine 10 may accept the wager 302.

The wager may be transferred to a common pool associated with the wager level of the wager provided by the player. Transferring the wager to a common pool may include transferring the wager to a central controller 58. The central controller 58 may include a totalizer for allocating or managing wagers among common pools in accordance with a pari-mutuel gaming system.

The gaming machine 10 may control the processor to communicate with an event database for selecting one or multiple events 304 and an associated final outcome and/or final rankings of the participants together with listings of features of the participants. The event database may be located in a remote server, in the memory of the gaming machine 10 or in another suitable location. According to an embodiment of the current disclosure, the processor of the gaming machine may be configured to select one or more events randomly or may select one or more events based on a secondary game type. The one or more events may include only one event, at least two events, at least three events, at least four events, at least five events, at least six events or may include eight events. The aforementioned numbers of events are merely exemplary and any number of events may be included.

Event data for the one or more selected events may include a final outcome and/or final ranking for one or more participants of each event. For example, in the case that the event is a racing event, event data for the one or more selected events may include the final ranking for the respective participants in each event determined by the finishing position in the field and ranking the participants with respect to other participants who competed in the same event. Other ranking systems may be used, such as rankings based on both subjective or objective performance metrics that are assigned by the rules of a sport, a judge, or a panel of judges.

In like manner, a final outcome according to the disclosed embodiments may include one or more characteristics of one or more participants in one or more events. For example, a final outcome may comprise or be based on whether a participant finished in a top-half of participants, whether a participant finished in a bottom-half of participants, whether a participant finished the event, whether a participant was disqualified from the event, whether a participant finished the event in a predetermined time-frame, whether a participant did not finish the event in a predetermined time-frame, a difference between a time required for a participant to finish an event relative to times of other participants, an amount of winnings achieved by a participant, an amount of winnings achieved by other participants, whether a participant finished in a predetermined position relative to other participants, a participant's final ranking in more than one event, whether a participant improved relative to another participant or another event, or any other characteristic of a participant in an event.

In an embodiment, the processor of the gaming machine 10 or the central controller may provide the final outcome and/or final ranking of participants (e.g. horses of a historical horse-racing event) of the one or more selected events to define a scorecard. The final outcome and/or final ranking of participants of the one or more selected events may include all of the participants for each event or a number of participants that is less than the total number of participants for each event, for example one participant for each event, three participants for each event, or eight participants for each event.

To define a scorecard according to an embodiment of the current disclosure, the processor may consider both negative and positive predictions. A reward may be tied to predicting the results of two events where the user must select the first, second and third finishers correctly in a first event but also incorrectly select the first, second and third finishers in a second event. Given these two events and the corresponding reward, the gaming machine may provide a scorecard assigning a (1) for a positive or correct selection and a (0) for a negative or incorrect selection such that the scorecard reads (111000) for the two events.

Additional scorecards may include the correct selection of the first finisher and the incorrect selection of the second and third finishers for each race (100100), the correct selection of the second finisher and the incorrect selection of the first and third finishers for each race (010010), and the correct selection of the third finisher and the incorrect selection of the first and third second finishers for each race (001001). Additional combinations may be employed covering any number of combinations, e.g. (101010), (100010), (001110), etc.

Variations in the scorecard with different combinations of positive and negative selections within the selected events may be tied to different award levels within a single pari-mutuel pool controlled by the totalizer and/or the central controller 58.

While described as a scorecard, varying embodiments may employ other approaches to evaluate a predicted outcome and/or predicted ranking. As such, no specific architecture is required for evaluating a predicted outcome and/or predicted ranking submitted by a user with respect to a final outcome and/or final ranking of the one or more selected events.

The processor 12 may obtain performance profiles for each participant in the selected events based on the listings of features of the participants. The listings of features of the participants may include physical characteristics of a participant, historical performances of a participant in different distances, different environmental conditions, odds, post-time odds and/or other conditions. In some embodiments, the processor may obtain performance profiles for each participant based on all of the events provided in the database by searching the database for all previous events and providing a single-value score which incorporates such past performance data. The single-value score may be provided as a graphical representation such as a bar graph or similar graphic demonstrating the score for the participant.

It will be understood that the disclosed embodiments of HHR games are merely exemplary, and that features of the present disclosure may also extend to other historical games and events, and the like. In varying embodiments, any possible combinations of correct and incorrect picks may be provided as scorecards, with rewards varying according to the odds, difficulty, or based on another factor as would be understood from the current disclosure.

A player may create a predicted final outcome and/or a predicted final ranking 306 based on the one or more selected events, desired reward, and/or the associated scorecard. According to the current disclosure there is the possibility for the player to select an auto-select or auto-fill option, wherein the processor automatically creates a predicted final outcome and/or a predicted final ranking based on a randomized selection, the performance profiles for each participant, corresponding selections made in a secondary game, or some combination thereof. The auto-select or auto-fill option according to the present disclosure may be used in combination with a manual selection, such that the player may create a partial predicted final outcome and/or a partial predicted final ranking prior to selecting the auto-select or auto-fill option to automatically complete the predicted final outcome and/or predicted final ranking.

The predicted outcomes and/or predicted rankings may be submitted to the processor for comparison 308 to the scorecards or the one or more selected events of the gaming machine. In varying embodiments, a pay table may be provided wherein the pay table may identify which scorecards are available for comparison to the predicted outcomes and/or predicted rankings based on the wager provided by the player. If there is an available scorecard that is an exact match with the predicted outcomes and/or predicted rankings provided by the player, including one or both of positive and negative selections, the final result may be communicated to the totalizer or the central controller 58 to determine the reward associated with the scorecard, for example based on the value of the common pool at the totalizer. The totalizer or the central controller 58 may be arranged to dynamically determine the reward value associated with the scorecard based on an award level of the scorecard.

The processor may create and/or select an entertaining display corresponding to the final result of the player's wager 310, based on whether a scorecard is found that is an exact match to the predicted outcomes and/or predicted rankings, which scorecard was an exact match, and/or the reward value won. The entertaining display may break the value won from the common pool into multiple animations or bonus games. Breaking the value won into multiple animations or bonus games can increase the enjoyment and successful feeling of the player and encourage continued gaming.

In some embodiments, the entertaining display may include a separate component (not shown), such as a separate display screen or mechanical element. The separate components may include a video display, window or a mechanical element corresponding to a plurality of possible results of the player's wager.

During the presentation of the entertaining display, a portion of the gaming device may remain dedicated to illustrating the one or more selected events. The illustration of the selected events may include an animation of the final outcome and/or final ranking of the participants in the one or more selected events and/or an illustration of a final result identifying the accuracy of each prediction of the player's wager, while the gaming machine may also illustrate the entertaining display and/or a wager result 310. The animation of the final outcome and/or final ranking of the participants may include replay information such as video clips or graphical representations of the results of various events.

The wager may end 312 with a payout 314, beginning another wager 300, another round, a bonus game, and/or by reverting to a menu providing additional options for the player.

### IV. Secondary Game

The entertaining display may be based on a theme or a secondary game as described previously. The theme or secondary game may be selected by a player based on preference and/or may be manipulated by the processor in response to a particular final result of a wager and/or a current total pool value available for a wager. The theme or secondary game may include accompanying depictions and animated highlights of a winning game as the participants complete the event. The entertaining display may include matches with graphics, symbols, and other indicia particular to the theme or the secondary game. In a preferred embodiment, the secondary game is a table game. A secondary game may include a casino game, table game, class III game or the like. For example, a secondary game may include one or more of poker, baccarat, blackjack, craps, roulette, a big six wheel or wheel of fortune, pool, pachinko, chemin de fer, pai gow, a lottery, keno, or any other table game, or bingo, and the like.

In a first aspect, the entertaining display may provide a secondary game that is playable by the player on the gaming machine or otherwise responsive to player input, but that has an outcome that corresponds to the outcome of the wager. For example, the secondary game may be played after the wager is completed so that the outcome of the secondary game may be provided as a controlled simulation, animation or video. In one example, after initializing a wager of the primary game, a secondary game may be shown as an entertaining display. The player may be allowed to “play” the secondary game by making a selection, using the input of the gaming machine, and the result of the secondary game may be simulated with a predetermined game result that directly corresponds to the result of the primary game wager (e.g., showing a roulette loss for a wager loss and a roulette win for a wager win by controlling where the ball lands in view of the players predicted roulette result; allowing a player to select a “hit”, “stay”, “roll”, or a predicted winning number or entity, where the result shown for the secondary game is predetermined by the result of the primary game).

In some embodiments, the reward value of the player's wager may correspond to a simulated result of a single secondary game or to more than one secondary game and/or iterations thereof. In certain aspects, a pay table or scorecard of the primary game may be associated with a display element, action or result of the secondary game. When a player makes a wager or gameplay decision in the secondary game, this action may be correlated to enabling a set of awards to build an award table for that gameplay.

Various embodiments of the disclosure may be better understood by reference to specific examples of a method for conducting games based on HHR according to the current disclosure, as detailed below. The examples provided are illustrative in nature of a single application of principles according to the disclosure and are not intended to be limiting. As such, while described with reference to one or more table games, the various embodiments may be adapted to employ one or more other table games, for example by switching a secondary game from roulette to baccarat or the like.

### A. Roulette

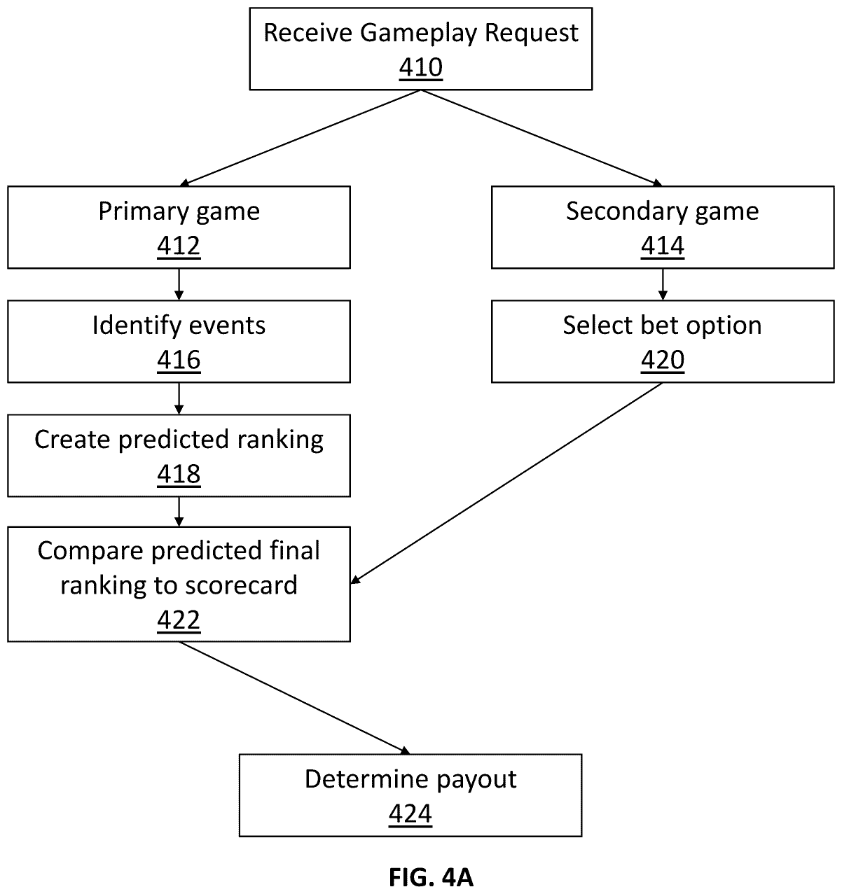

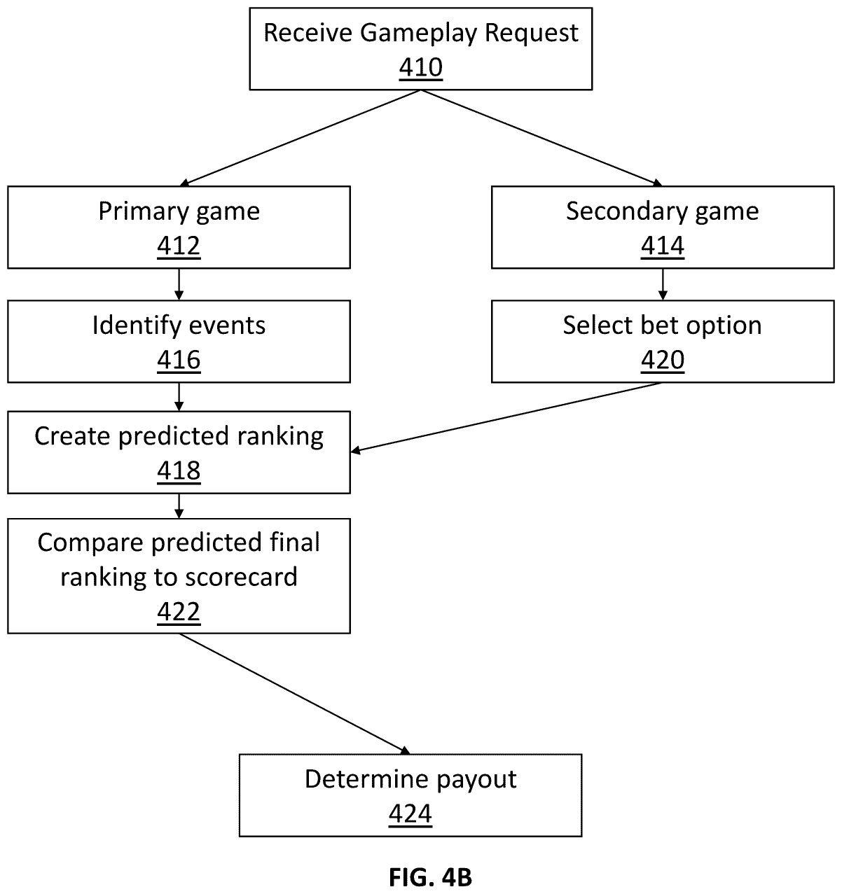

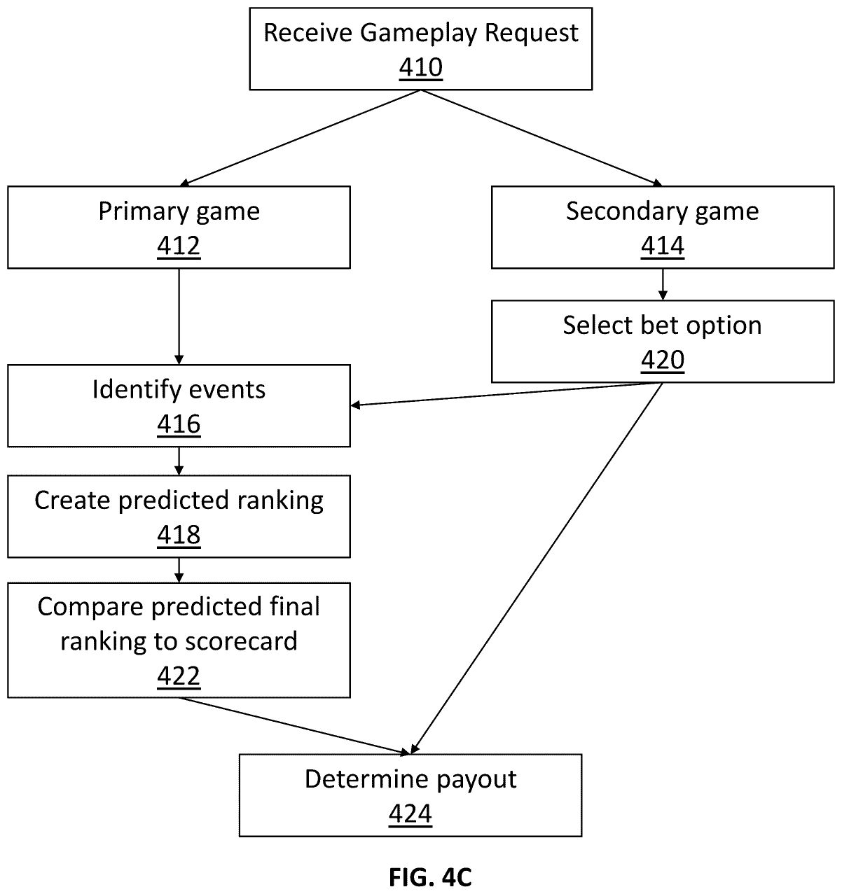

In the game of roulette a player is permitted to place one or more wagers based on a predicted final location of a ball on a wheel. Using roulette as the secondary game, the player's decision to bet on a particular number, color, set of numbers, or combination thereof may be associated with specific scorecard options, such as different scorecards representing a mix of win, show, exacta and related bets for an HHR primary game. This method is further described with respect to FIG. 4A.

FIG. 4A illustrates a process 400 that may be performed at a gaming server, station, or device for conducting a secondary game based on an underlying primary game according to a method of the disclosure. In a first step 410, an initial gameplay request may be provided by the player to initiate gameplay. The gameplay request may include a selection or initialization of a primary game, a secondary game, a wager amount, and/or a wager level. For case of understanding, the embodiment of FIG. 4A is described herein with reference to HHR as a primary game 412 and roulette as a secondary game 414, although the current disclosure is not limited thereto.

As noted above, the primary game 412 may be based on one or more identified events 416, such as a historical horse race. The events may include simulated events, historical events, and/or the like. The events further comprise parameters necessary for governing a wager on the events, such as information regarding participants, event conditions, etc. In one aspect, the pending events may be selected from a database of events based on a number of predetermined criteria. For example, the pending events may be selected from a database of events based on a number of participants in the event, the location of the event, the type of event, the location of the gaming server, or the results of the event (number of finishers, disqualifications, etc.). The predetermined criteria may result from regulatory constraints, house requirements or otherwise, and may advantageously facilitate flexibility in conducting wagers across geographic and regulatory domains.

Based on the one or more identified events 416, a predicted final outcome and/or final ranking 418, for example comprising an ordered final ranking of participants for the one or more identified events, may be provided. A player may create the predicted final outcome and/or predicted final ranking, such as by manually handicapping a horse race, or the gaming machine may automatically create the predicted final outcome and/or predicted final ranking. Event data about the one or more events may be provided to facilitate the creation of the predicted final outcome and/or predicted final ranking. The event data may include information relating to the participants in the one or more events and/or the events' conditions. For example, where the event is a horse race or historical horse race, the participants may be racehorses and the information may include characteristics of the racehorse, a jockey riding the horse, a trainer affiliated with the racehorse and/or jockey, etc., such as is generally provided to players at a racetrack in a daily racing form or horse racing form. Conditions of such a horse race may additionally include the length of the track, location, weather, date, time, etc.

Various forms of ordered rankings may be used in an outcome according to the disclosure, such that a predicted final outcome and/or predicted final ranking may be provided in the form of a wager card adapted for use with varying types of wagering, including sports wagering or other event-based wagering. The wager cards may therefore take varying forms, including a predicted finisher, score, time, arrangement of numbers or places, etc. For example, a wager card may include a prediction of a first-place finisher, a second-place finisher, and a third-place finisher for each of the one or more events. In the step of identifying the one or more events, a plurality of events may be selected as an ordered combination of events, such that a wager card provides a prediction for a first-place finisher, a second-place finisher, and a third-place finisher for a first selected event from the first plurality of events, followed by a first-place finisher, a second-place finisher, and a third-place finisher for a second selected event from the first plurality of events, and so forth.

In the secondary game 414, a player may select a bet option 420 corresponding to the secondary game. For example, where the secondary game is roulette, the player may select one or more bets based on predicted characteristics of a final location of a ball in a roulette wheel, such as predicting a number or color of a pocket the ball may land in, predicting the ball will land in an odd or even numbered pocket, or the like. The selected bet option 420 may be associated with a corresponding pay table or scorecard 422 for the primary game, such that the player's selection 420 adjusts the available awards for the primary game.

The scorecard 422 may identify correct and incorrect predictions of the player's predicted final outcome and/or predicted final ranking required to receive a reward or payout. For example, where three events are selected as the one or more events and a first-, second- and third-place finisher are considered for each event, a binary scorecard where the predicted final outcome and/or predicted final ranking matches an actual final outcome and/or final ranking (i.e. the player perfectly predicted the first-, second-, and third-place finishers for all events) could be presented as 111111111. In another example, where the predicted final outcome and/or predicted final ranking indicated the first-place finisher of each event correctly while incorrectly indicating the second- and third-place finishers, a binary scorecard could be presented as 100100100.

As such, a reward or payout may be determined 424 based on whether the selected scorecard matches the result of the predicted final outcome and/or predicted final ranking. Each possible scorecard may be associated with a different award level, and a reward value may be determined from the award level corresponding to the scorecard only when the selected scorecard matches the result of the predicted final outcome and/or predicted final ranking. In embodiments, the determination of the reward value may be based on the award level, an amount wagered by the player, and/or a wager pool value. The amount wagered by the player may be included in the gameplay request. In like manner, the wager pool value may be governed by a totalizer or other control device.

In a specific example of the method of FIG. 4A, each pay table/scorecard entry is associated with a bet option of the secondary game, such as associating the ball landing in the number 5 slot of the roulette wheel with associated payout options as follows:

```
<scorecard value=“0011000001110101001000” ball=“5”>
  <winIndexes>
      <straight id=“12”/>
      <red id=“1” />
      <odd id=“1” />
      <low id=“2” />
      <column1 id=“2” />
      <dozens1 id=“4” />
      <45split id=“10” />
      <56split id=“10” />
      <25split id=“10” />
      <58split id=“10” />
      <4row id=“9” />
      ....
      <1245Corner id=“8” />
      <2356Corner id=“8” />
      <4578Corner id=“8” />
    <5689Corner id=“8” />
    <sixline1 id=“6” />
  </winIndexes>
</scorecard>
```

A more detailed understanding may be provided by considering an example where a player selects bet options of the straight 5, a 5/4 split, and 1^{st} 12 in roulette. The selected bet options may then enable the pay table/scorecard entries associated with these bet options as follows:

```
<scorecard value=“1011000001110101001000” ball=“1”>
  <winIndexes>
    <dozens1 id=“4” />
  </winIndexes>
</scorecard>
...
<scorecard value=“0111000001110101001000” ball=“4”>
  <winIndexes>
    <dozens1 id=“4” />
    <45split id=“10” />
  </winIndexes>
</scorecard>
<scorecard value=“0011000001110101001000” ball=“5”>
  <winIndexes>
    <straight id=“12”/>
    <dozens1 id=“4” />
    <45split id=“10” />
  </winIndexes>
</scorecard>
...
<scorecard value=“0011000001110101001001” ball=“12”>
  <winIndexes>
    <dozens1 id=“4” />
  </winIndexes>
</scorecard>
```

The same principles can be applied to any secondary game by associating relevant betting options, such as “hit” or “stay” in blackjack, etc., with pay table/scorecard entries of the primary game. In this way, the player's actions in the secondary game have a direct effect on a result of the underlying primary game, while advantageously maintaining the primary game as the source of the wager and the wager result.

Some game types may have a set payout structure, such that a direct correspondence between the payout of the wager and a simulated payout of the secondary game may not exist. By breaking the reward value of the wager into more than one secondary game, a correspondence between the payout of the wager and the simulated payouts may be provided. For example, where a player's wager was successful based on the predicted final outcome and/or predicted ranking of the participants in the one or more events a secondary game of roulette may be provided and the player may be permitted to select one or more result predictions, whether simultaneously or iteratively, so that the simulated result of the secondary game cumulatively corresponds to the wager result. Due to the static nature of awards in many table games, such as roulette, an added flexible award table may be used to handle an effect of variation in player pool size on an underlying pari-mutuel payout characteristic of HHR games. The awards of the extra game may be progressive values, static or a mix of progressive and static. In certain embodiments, the awards may all be static but the number of awards available may be varied to correlate the payouts of the secondary games and the primary game. The secondary game thereby provides an advantageous variability and increased entertainment for the player, while maintaining a simplified and streamlined underlying gaming mechanism based on one or more selected events.

In an embodiment, a secondary game of roulette may be provided having a static award table while the primary game includes a pari-mutuel payout structure that varies based on player pool size, etc. As the payout award of the secondary game is based on the underlying wager in the primary game, the secondary game may be modified to address any discrepancies between the value of the static award table of the secondary game and the pari-mutuel payout of the primary game by including a bonus game having a flexible award table. The bonus game may comprise any additional game, such as a further roulette game or a new game, configured to provide a bonus award equal to the difference between the static award and the award of the primary game.

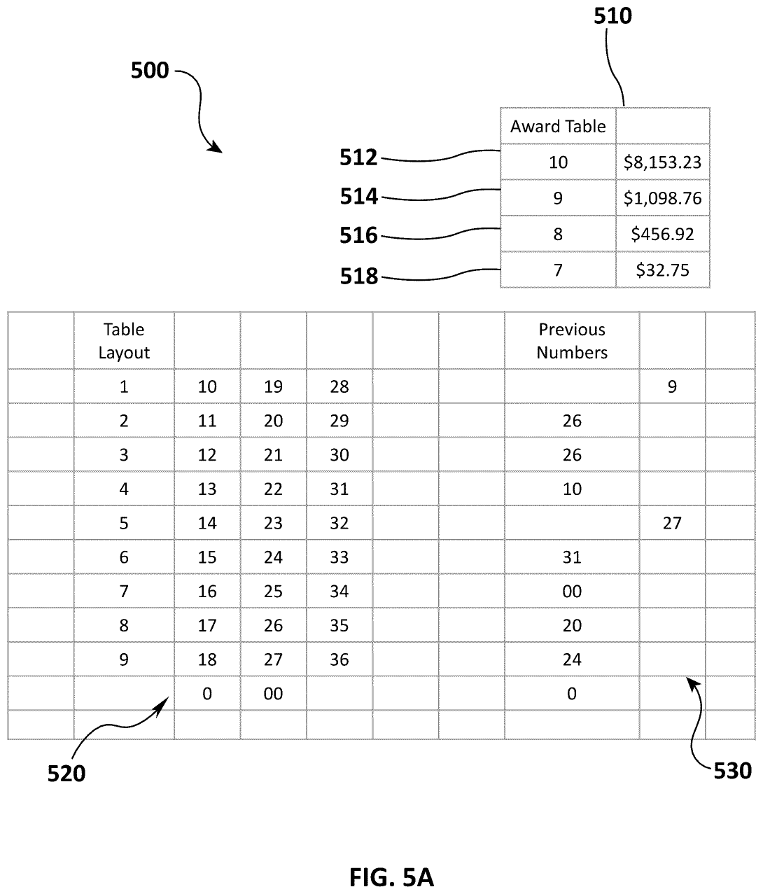

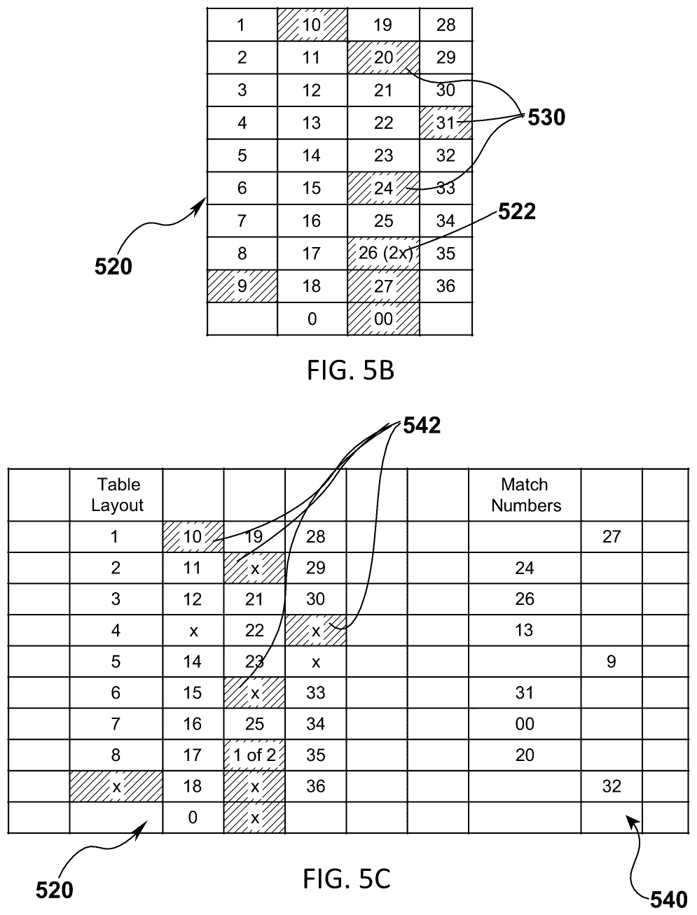

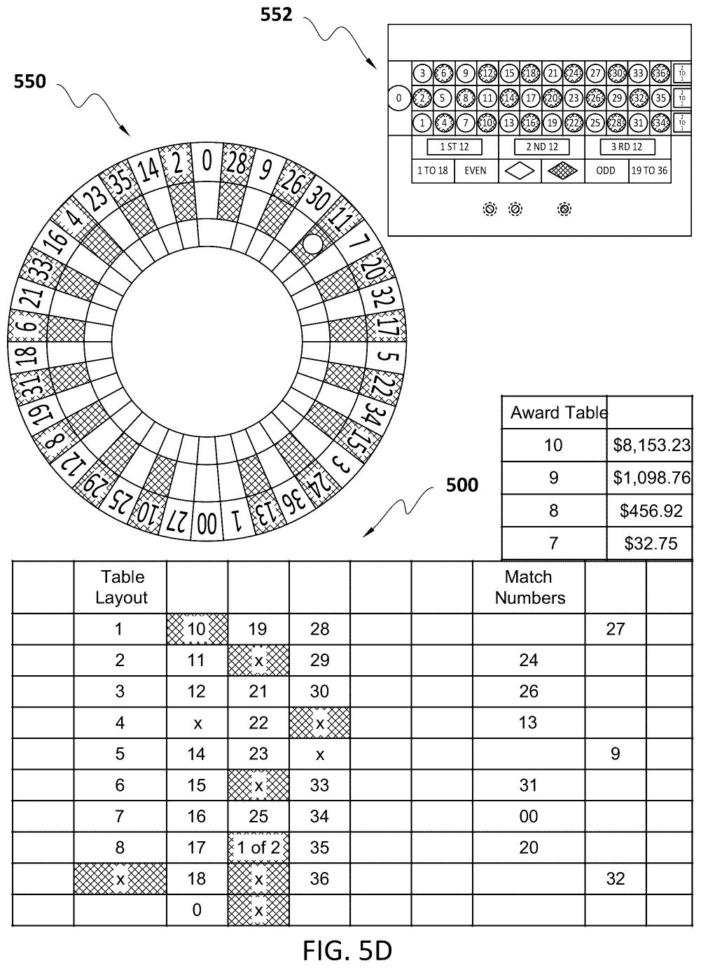

In one example, the bonus game may be provided as a keno style extra game 500 according to FIGS. 5A-5D. The extra game 500 may be presented after an initial secondary game, such as roulette, or may be presented concurrently. According to the illustrated example of FIG. 5A, the extra game 500 includes a flexible award table 510 that has four prize awards 512, 514, 516, 518 that are all progressive value awards. At the illustrated time, the first prize award 512 corresponds to a payout of $8,153.23 when ten match spots are hit, the second prize award 514 corresponds to a payout of $1,098.76 when 9 match spots are hit, the third prize award 516 corresponds to a payout of $456.92 when 8 match spots are hit, and the fourth prize award 518 corresponds to a payout of $32.75 when 7 match spots are hit. In variations, the prize awards may be static value awards or progressive value awards, and/or some combination of static value awards and progressive value awards. In like manner, the number of awards available may be more than or less than four, and the number of awards available may be static or may be progressively varied based on the value of the parimutuel pool.

The picked spots for the keno game 500 may be or appear to be randomly populated in a table layout 520 for each play of the game and a ball call may be provided, for example corresponding to a set of previous roulette results 530, for example the last four, the last five, the last nine, the last ten, or any other number of the previous roulette results. The previous roulette results 530 may correspond to roulette results from gameplay of the current player, previous players, some combination of previous players and the current player, or may be arbitrarily generated. To allow for repeat numbers, there may be a multiplier 522 on the number of times a match is needed to generate a win.

Using the example of FIG. 5A-5D, gameplay for the keno style extra game 500 may begin with the last nine roulette results or previous numbers 530 being marked on the table layout 520, as best seen in FIG. 5B. A set of seemingly random match numbers 540 may then be generated and marked for matches or “hits” 542 with the previous numbers. As shown in FIG. 5C, in this example there are seven “hits” 542, where the previous numbers 530 correspond to at least one match number 540, with the possibility of an additional hit with a pending roulette spin of the secondary game. In this example, it is indicated to the player already that the bonus game award will be at least $32.75 based on the seven hits 542, and the player may then initiate the pending roulette spin with the possibility of receiving an award based on a perceived roulette wager as well as the bonus game result, including at least the award for seven hits 518 and possibly the greater award level of $456.92 for eight hits 516.

FIG. 5D illustrates an example of a final roulette spin 550 as may be provided to the player. In the illustrated embodiment the roulette spin 550 results in an eleven, meaning that the bonus game award remains at the award level 518 for 7 matches, or $32.75. This bonus award is then combined with the results of the roulette wager 552 or wagers to equal the award of the underlying primary game.

In this manner, the wager result of the secondary game, including the roulette game and the bonus keno style game 500, may correspond to the wager result or scorecard of the primary game, such as an HHR game, which may be shown in another window, part of the entertaining display, or only used in a game engine. This is realized even though the secondary game of roulette generally requires static award values and the primary game may include parimutuel awards that vary based on player counts and the like, due to the bonus game providing the difference between the award values.

It should be noted that various modifications and alternative arrangements of the extra game 500 are possible without departing from the principles of the illustrated embodiment. For example, one or more of the table layout, match count, ball call, or other attributes may be adjusted, or another game may be provided in place of a keno style game.

Similarly, while the example of FIGS. 5A-5D started gameplay with the last nine roulette results or previous numbers being marked on the table layout, in an alternative the keno style extra game 500 may be played concurrently with the secondary game. In this example, a single wager made in a primary game may correspond to a package of roulette spins and corresponding wagers for a secondary game of roulette, for example five spins, ten spins, or any other number of spins. Each roulette spin may then provide a wager result, such as with static award values, while the keno style extra game is progressively marked with the result of each spin until a bonus award is determined by the final roulette spin based on the number of “hits” as described above. Of course, the cumulative results of the secondary game including the roulette spins and the bonus game may be controlled to correspond to the result of the primary game.

The bonus style game presented as an extension of the secondary game increases player engagement and enjoyment, by providing the player with increasingly varied and exciting gameplay based on a primary game wager, such as HHR. Advantageously, the use of the secondary game including a bonus game as described allows the player to enjoy playing a secondary game even where the awards corresponding to the secondary game are static, such as with a table game or more specifically in the example of FIGS. 5A-5D a roulette game, and the awards for the primary game are parimutuel or otherwise varied.

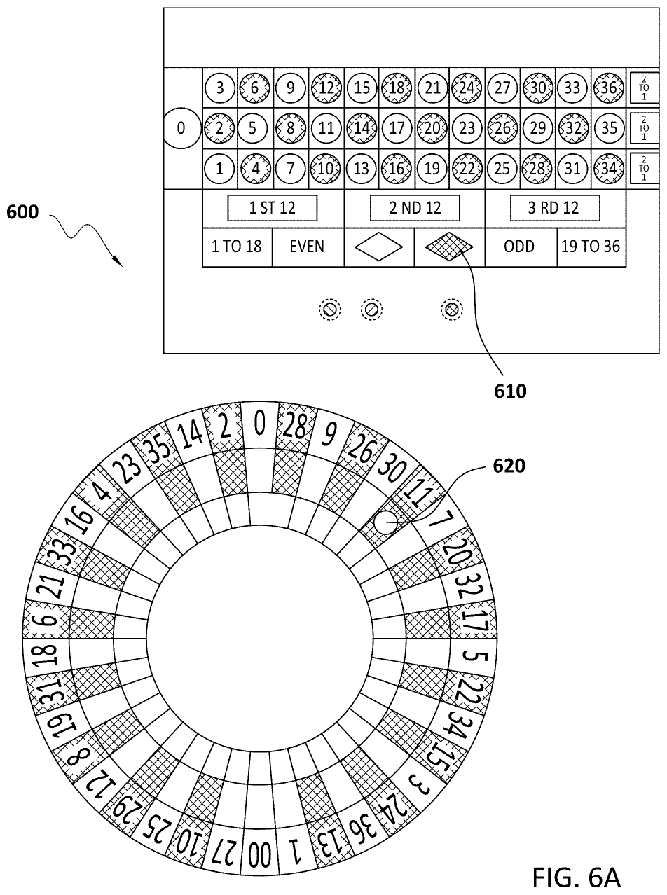

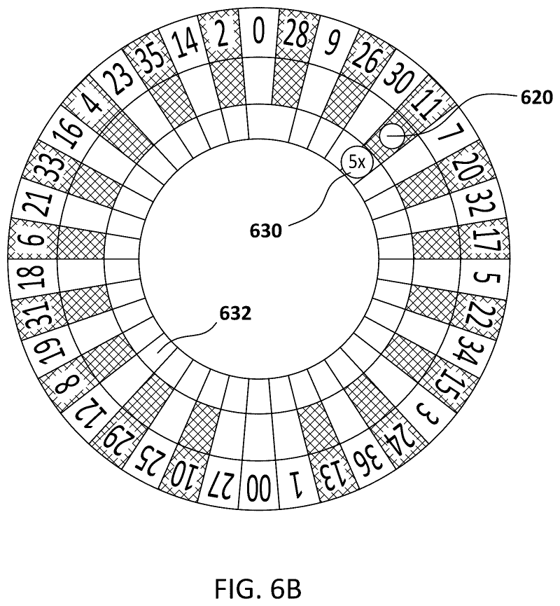

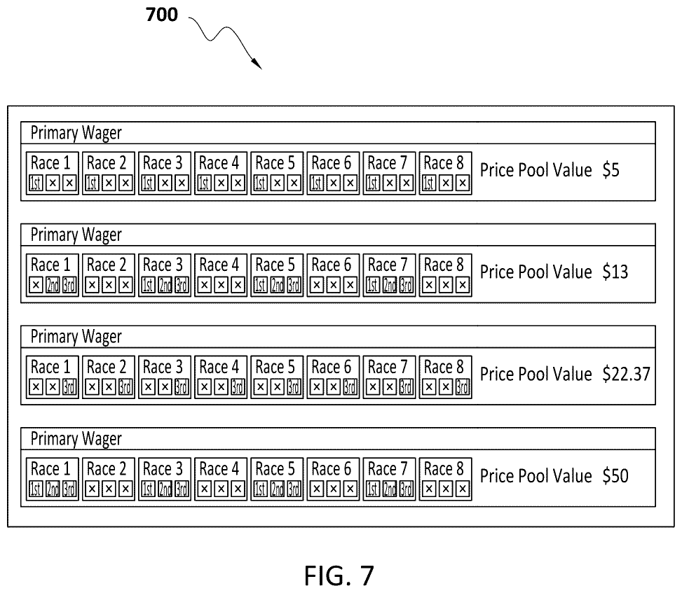

In an embodiment according to FIGS. 6A-7, rather than a bonus game that is separate or separate but related to or dependent on the secondary game as with the keno style extra game, a bonus game or flexible award table may be directly integrated into the gameplay of the secondary game as a secondary aspect of the secondary game. In this way, as the payout award of the secondary game is based on the underlying wager in the primary game, the secondary game may be modified to address any discrepancies between the value of the static award table of the secondary game and the pari-mutuel payout of the primary game by including a bonus game having a flexible award table.

As shown in FIG. 6A, a roulette game 600 may be provided as a secondary game. In the secondary game 600, a player may select a bet option 610 corresponding to the secondary game. For example, where the secondary game is roulette 600, the player may select one or more bets based on predicted characteristics of a final location of a ball in a roulette wheel, such as predicting a number or color of a pocket the ball may land in, predicting the ball will land in an odd or even numbered pocket, or the like. The result of the secondary game 600 may be associated with a corresponding pay table or scorecard 700 for the primary game, as shown in FIG. 7.

In the illustrated example of FIG. 6A, the player has selected a bet option 610 of five credits on black and the roulette ball 620 has landed at black eleven. With this result, the win of the secondary game 600 corresponds to a static award value of ten credits, based on the five credits wagered and the five credit win. However, as seen in FIG. 7, the wager of the primary game is based on scorecards and pool values 700 that can vary and that do not include a ten credit win.

Rather than use a separate bonus game or multiple iterations of the secondary game to flexibly adjust the award of the secondary game to correspond with the wager result of the primary game, the embodiment of FIGS. 6A-6B includes a flexible award directly in the secondary game 600 using a secondary attribute in the form of a multiplier ball 630 that is released in the event of a win. The value of the multiplier ball 630 may be flexibly adjusted, and the multiplier ball 630 may use the same wheel ring as the original roulette ball 620 or may use a ring 632 specifically added for the multiplier ball 630 as is the case in FIGS. 6A-6B.

In this example, if the multiplier ball 630 lands in the same position as the original ball 620 then the original ten credit win will be multiplied by the value of the multiplier ball 630. In the illustrated example the player will win fifty credits because the multiplier ball 630 landed on the same position as the original ball 620, multiplying the original win by five times. Accordingly, the wager result of the secondary game 600 can be flexibly adjusted to correspond to a primary game wager result where the scorecard matched to the prediction corresponds to a prize pool value of fifty credits. Of course, the value of the multiplier ball 630 may be adjusted as needed to correspond to variations in the prize pool values, while the award system of the secondary game 600 may remain static, with the value of the multiplier ball including integer and/or non-integer values.

Several variations to the embodiment of FIGS. 6A-6B are contemplated, including releasing multiple balls at once for the original wager of the secondary game, adding a multiplier value directly to the original ball in the secondary game, and/or informing the player of the multiplier value of a multiplier ball before the game starts. In each case, the wager result of the secondary game is controlled to correspond to the wager result of the primary game, allowing the player to enjoy playing a secondary game even where the awards corresponding to the secondary game are static, such as with a table game or more specifically in the example of FIGS. 6A-6B a roulette game, and the awards for the primary game are parimutuel or otherwise varied. These variations in the secondary game increase player engagement and enjoyment, by providing the player with increasingly varied and exciting gameplay based on a primary game wager, such as HHR.

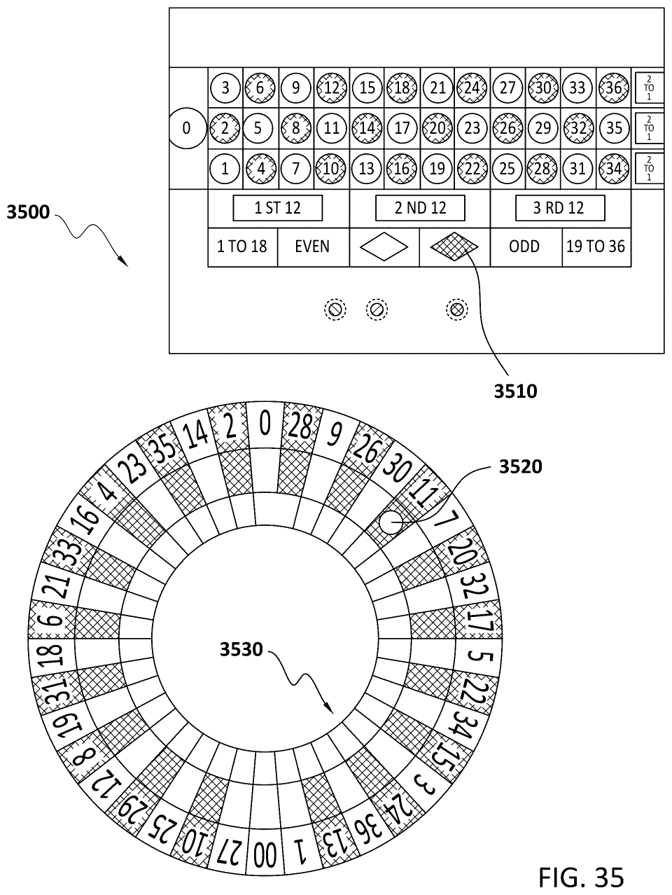

Another embodiment is shown in FIG. 35, where a roulette game 3500 may be provided as a secondary game. In the secondary game 3500, a player may select a bet option 3510 corresponding to the secondary game. For example, where the secondary game is roulette 3500, the player may select one or more bets based on predicted characteristics of a final location of a ball in a roulette wheel, such as predicting a number or color of a pocket the ball may land in, predicting the ball will land in an odd or even numbered pocket, or the like. The result of the secondary game 3500 may be associated with a corresponding pay table or scorecard for an underlying primary game, such as an HHR-based primary game or another historical-events based primary game.

In the illustrated example of FIG. 35, the player has selected a bet option 3510 of five credits on black and the roulette ball 3520 has landed at black eleven. With this result, the win of the secondary game 3500 may correspond to a static award value of ten credits, based on the five credits wagered and the five-credit win. However, the wager of the primary game may be based on scorecards and pool values that can vary, for example based on pool size and/or a number of players, and that do not include a ten-credit win.

Rather than use a separate bonus game or multiple iterations of the secondary game to flexibly adjust the award of the secondary game to correspond with the wager result of the primary game, the embodiment of FIG. 35 provides a flexible award directly in the secondary game 3500 using a secondary attribute in the form of an additional wheel 3530, changed outer wheel spots, sub-attributes, etc.

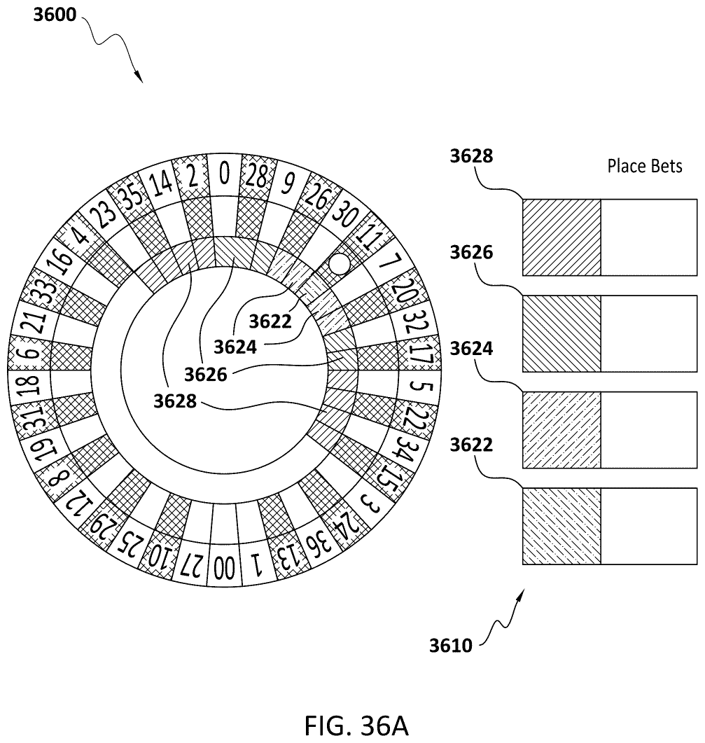

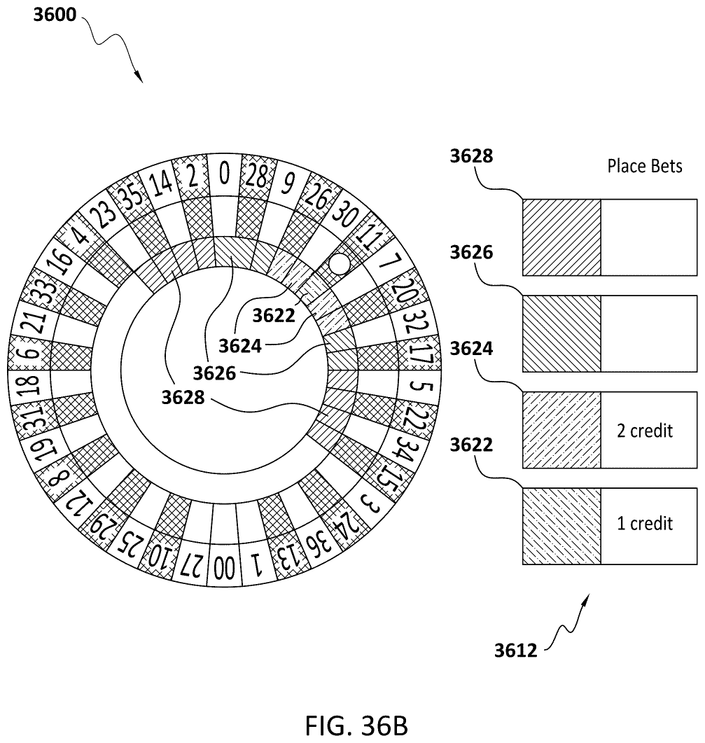

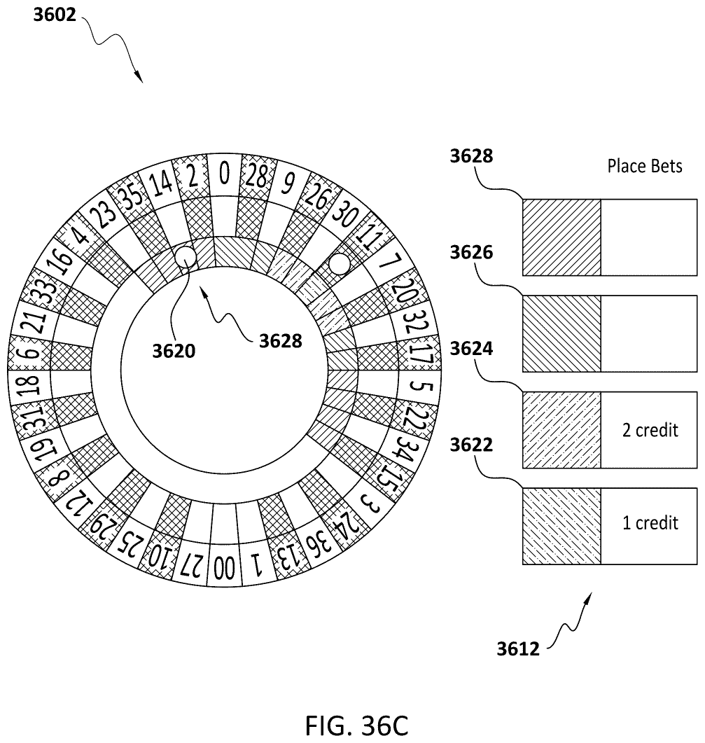

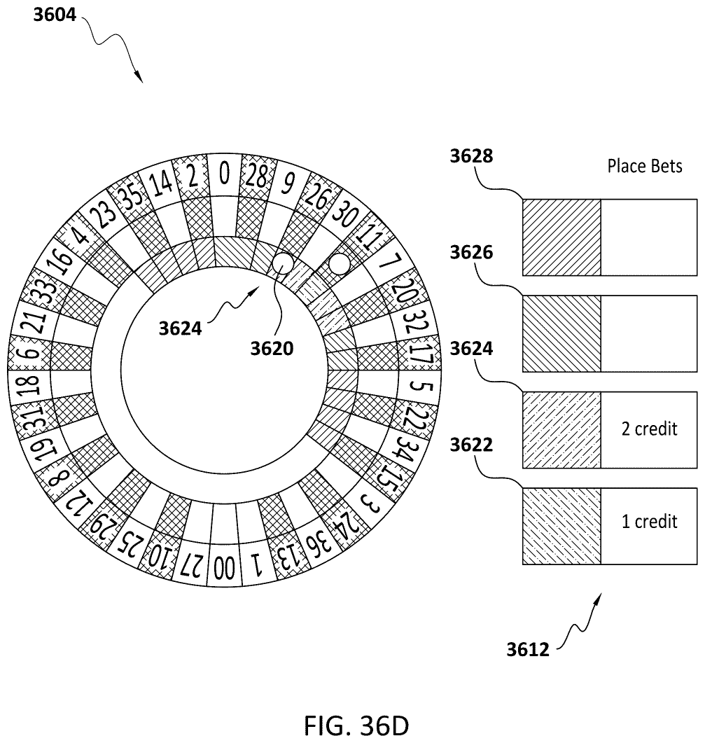

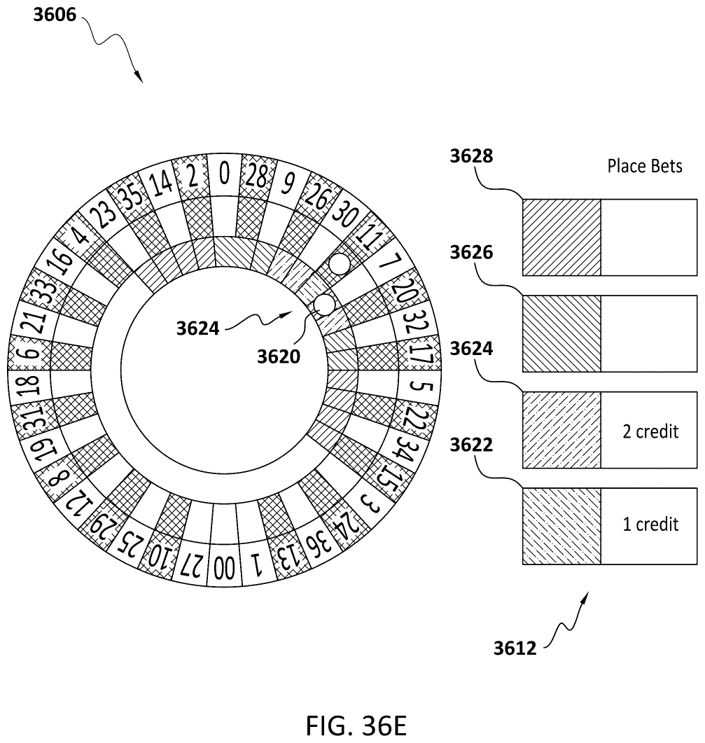

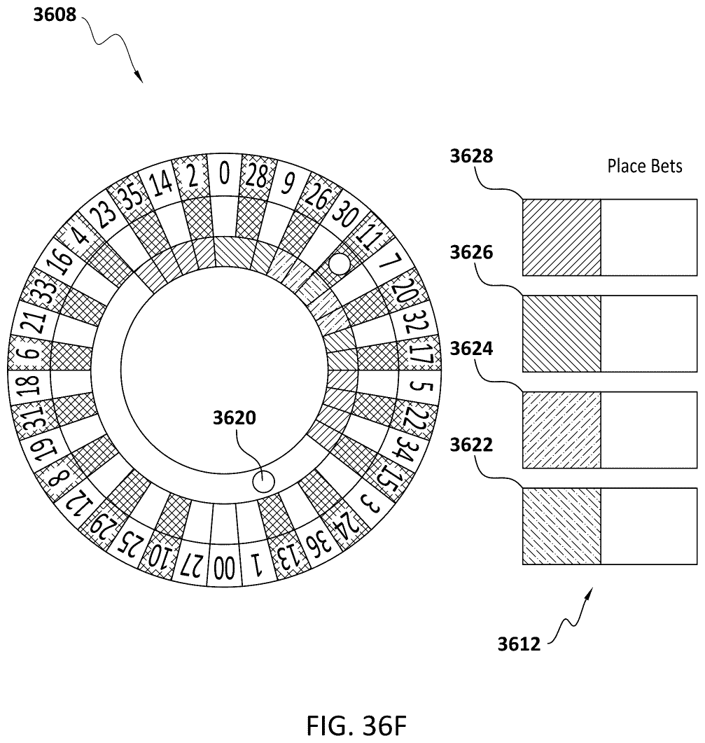

In the example of FIG. 36A, zones 3622, 3624, 3626, 3628 on an additional wheel are defined and unlocked and the player is given a secondary bet option 3610 in a secondary game 3600 of roulette. In this case, the secondary bet option 3610 may correspond to a bet on whether an additional ball will land in a respective zone, a first zone 3622 comprising a single space corresponding to a number eleven space of the secondary game of roulette 3600, a second zone 3624 comprising four spaces corresponding to numbers twenty-six, thirty, seven and twenty of the secondary game of roulette 3600, a third zone 3626 comprising five spaces corresponding to numbers zero, twenty-eight, nine, thirty-two and seventeen of the secondary game of roulette 3600, and a fourth zone 3628 comprising eight spaces corresponding to numbers twenty-three, thirty-five, fourteen, two, five, twenty-two, thirty-four, and fifteen of the secondary game of roulette 3600. The remaining spaces of the additional wheel are left open in this embodiment and correspond to a loss. Various secondary bet options are contemplated, including the possibility of one or more secondary bet options, varying bet values, varying zones, varying entertaining displays, etc.

Continuing the example of FIG. 36A, FIG. 36B shows a secondary bet option 3612 where the player has placed two bets, a bet of a single credit on a first zone 3622 and a bet of two credits on a second zone 3624. FIG. 36C shows the result of a first roll 3602 of an additional ball 3620. In this case, the additional ball 3620 has landed in the fourth zone 3628 corresponding to number fourteen of the roulette wheel, and no win is awarded to the player. At this stage, the secondary bet option 3612 may end, such as after a single spin or after a predetermined number of spins, or the secondary bet option 3612 may be continued until a predetermined result occurs, such as a win or the additional ball 3620 landing in a predetermined space or zone. In the embodiment of FIG. 36C, the secondary bet option 3612 remains active until the additional ball 3620 lands outside of zones 3622, 3624, 3626, 3628.

FIG. 36D, FIG. 36E and FIG. 36F illustrate additional rolls of the additional ball 3620 corresponding to the secondary bet option 3612. In a second roll 3604, according to FIG. 36D, the additional ball 3620 has landed in the second zone 3624 corresponding to number twenty-six of the roulette wheel, and the player is awarded a corresponding payout. Play continues as shown in FIG. 36E, and a third roll 3606 results in the additional ball 3620 again landing in the second zone 3624 corresponding to number seven of the roulette wheel, with the player being awarded another corresponding payout. Play continues in a fourth roll 3608 according to FIG. 36F, but in this case the additional ball 3620 lands outside of zones 3622, 3624, 3626, 3628, corresponding to number thirteen of the roulette wheel, ending the secondary bet option 3612.

Accordingly, the wager result of the secondary game 3600 can be flexibly adjusted to have a total value corresponding to a value of a primary game wager result, e.g., where the scorecard matched to the prediction corresponds to a prize pool value of fifty credits or another value that differs from an award of a conventional game of roulette. Of course, the values of zones 3622, 3624, 3626, 3628 may be adjusted as needed to correspond to variations in the prize pool values, while the award system of the secondary game 3500, 3600 may remain static, with the value of zones 3622, 3624, 3626, 3628 including integer and/or non-integer values.

While described in some embodiments as a “secondary bet option”, the secondary bet option does not have to be or otherwise include an additional wager from a player. Rather, the secondary bet option may be used as an additional wager, a bonus (e.g., a bonus feature of an original wager), or the like.

The addition of secondary features and/or secondary bet options to a secondary game as described in the above embodiments allows for increased variability in gameplay, player enjoyment, and compatibility with an underlying primary game. Values for the secondary bet options, such as for inner wheel matches according to FIGS. 36A-36F, could be provided in the form of credits, a multiplier, progressives, bonus triggers, etc. The values for the secondary bet options may or may not be static values, for example the values could change and/or grow from spin to spin, increasing the options available to a provider and expanding the gameplay available to a player.

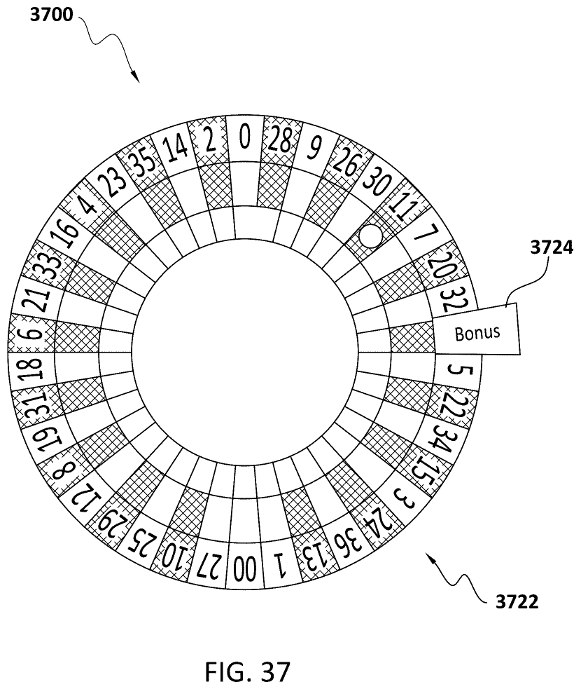

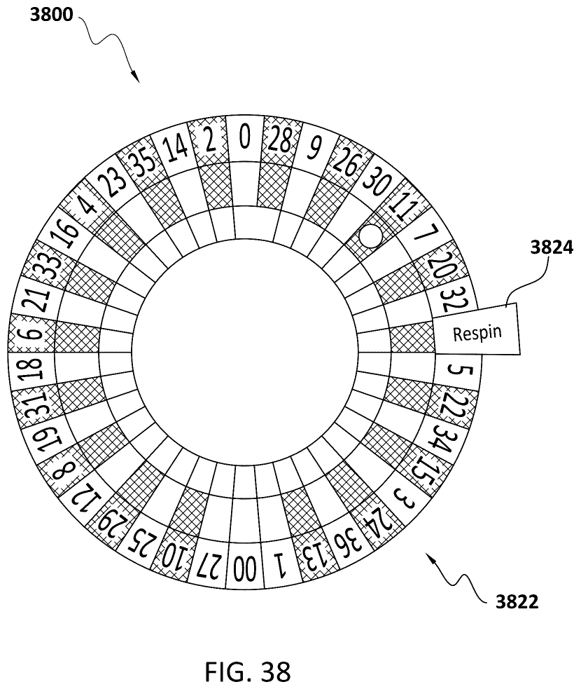

Several variations to the embodiment of FIGS. 36A-36F are contemplated in addition to or in combination with the specific examples disclosed, including releasing multiple balls at once for the original wager of the secondary game and for the secondary bet option, adding extra pay zones as in FIGS. 36A-36F to the original wheel in the secondary game and basing the secondary bet options on the original ball, and/or adding other features/functions to certain spots on the wheels. In addition to or in combination with an inner wheel, changes to the outer wheel could be used to achieve/enhance a similar outcome. For example, when an HHR pari-mutuel pool reaches a predetermined size or based on other criteria, one or more of the numbers on the outer wheel 3722 of the secondary game of roulette 3700 may be changed to reflect a higher value bonus and/or progressive trigger instead of a credit award, as in the illustrated example of FIG. 37 where number seventeen is changed to “Bonus” 3724. In a related embodiment according to FIG. 38, the outer wheel 3822 of the secondary game of roulette 3800 is changed for number seventeen to “Respin” 3824, making the other spots seemingly more likely to happen and advantageous for the player. Several variations and combinations of the described features and secondary attributes are contemplated.

In each case, the wager result of the secondary game together with the added features, bonuses, secondary attributes, or the like, are controlled to correspond to the wager result of the primary game, allowing the player to enjoy playing a secondary game even where the awards corresponding to the secondary game are traditionally static, such as with a table game or more specifically in the example of FIGS. 36A-36F a roulette game, and the awards for the primary game may be parimutuel or otherwise varied. These variations in the secondary game increase player engagement and enjoyment, by providing the player with increasingly varied and exciting gameplay based on a primary game wager, such as an HHR wager.

In another aspect according to the embodiment of FIG. 4B, the secondary game may correspond to an auto-select or auto-fill option, wherein the processor automatically creates a predicted final outcome and/or predicted final ranking based on the players selected betting option, action and/or predictions in the secondary game 420. In certain examples, the processor may be configured to match odds or other parameters of predicted results of the secondary game to automatic selection of a predicted final outcome and/or predicted final ranking for participants in the one or more selected events having the same or similar odds of occurring. As such, the player may be able to play a secondary game in a manner that is reflected in a corresponding wager, such as by having the same odds or possible payout.

In certain aspects, the processor may be configured to select specific events for use in the wager in order to facilitate the matching of odds or other parameters of predicted results of the secondary game to automatic selection of a predicted final outcome and/or predicted final ranking for participants in the one or more selected events having the same or similar odds of occurring.

A predetermined data filter according to the current disclosure may be arranged for selecting one or more events according to the specific odds, possible odds, and the like for a corresponding secondary game. Starting from raw HHR data, or other event data, a series of filters may be applied in a predetermined sequence to efficiently create sets of event data for a given secondary game or related odds, probabilities, and possible actions or strategies. In certain embodiments, the odds associated with the secondary game may be responsive to player input.

For a secondary game of roulette, the gaming machine may present the player with a roulette wheel and a plurality of betting options based on the predicted final location of a ball or other indicator relative to the wheel. Roulette players have a variety of betting options. Placing inside bets may include selecting the exact number of a pocket the ball will land in, or a small range of pockets based on their proximity on the layout of the wheel. Players wishing to bet on the outside may select bets on larger positional groupings of pockets, a pocket color, or whether a winning pocket number is odd or even. The payout odds for each type of bet are based on its probability.

In an embodiment of the current disclosure where roulette is provided as a secondary game, the player may place a bet through an input device of the gaming machine. The processor may then identify the payout odds of the player's bet and auto-fill a predicted final outcome and/or predicted ranking of one or more selected events in order to match the payout odds of the player's bet and the odds of a successful wager in the predicted final outcome and/or predicted final ranking. The predicted final outcome and/or predicted final ranking may then be compared to the actual final outcome and/or final ranking and a wager result derived therefrom. The roulette game may then be led to a wager outcome matching the wager result.

For the roulette game, a bet odds table may be provided as follows:

| | | | | Expected |
|---|---|---|---|---|
| | | | | value |
| | | | Odds against | (on a $1 |
| Bet name | Winning spaces | Payout | winning | bet) |
| 0 | 0 | 35 to 1 | 37 to 1 | −$0.053 |
| 00 | 00 | 35 to 1 | 37 to 1 | −$0.053 |
| Straight up | Any single number | 35 to 1 | 37 to 1 | −$0.053 |
| Row | 0, 00 | 17 to 1 | 18 to 1 | −$0.053 |
| Split | any two adjoining numbers vertical or | 17 to 1 | 18 to 1 | −$0.053 |
| | horizontal | | | |
| Street | any three numbers horizontal (1, 2, 3 or 4, | 11 to 1 | 11 + ⅔ to 1 | −$0.053 |
| | 5, 6, etc.) | | | |
| Corner | any four adjoining numbers in a block (1, | 8 to 1 | 8 + ½ to 1 | −$0.053 |
| | 2, 4, 5 or 17, 18, 20, 21, etc.) | | | |
| Top line or Basket | 0, 00, 1, 2, 3 | 6 to 1 | 6 + ⅗ to 1 | −$0.079 |
| (US) | | | | |
| Top line or Basket | 0, 1, 2, 3 | 8 to 1 | | |
| (European) | | | | |
| Double Street | any six numbers from two horizontal rows | 5 to 1 | 5 + ⅓ to 1 | −$0.053 |
| | (1, 2, 3, 4, 5, 6 or 28, 29, 30, 31, 32, 33 | | | |
| | etc.) | | | |
| 1st column | 1, 4, 7, 10, 13, 16, 19, 22, 25, 28, 31, 34 | 2 to 1 | 2 + ⅙ to 1 | −$0.053 |
| 2nd column | 2, 5, 8, 11, 14, 17, 20, 23, 26, 29, 32, 35 | 2 to 1 | 2 + ⅙ to 1 | −$0.053 |
| 3rd column | 3, 6, 9, 12, 15, 18, 21, 24, 27, 30, 33, 36 | 2 to 1 | 2 + ⅙ to 1 | −$0.053 |
| 1st dozen | 1 through 12 | 2 to 1 | 2 + ⅙ to 1 | −$0.053 |
| 2nd dozen | 13 through 24 | 2 to 1 | 2 + ⅙ to 1 | −$0.053 |
| 3rd dozen | 25 through 36 | 2 to 1 | 2 + ⅙ to 1 | −$0.053 |
| Odd | 1, 3, 5, . . . , 35 | 1 to 1 | 1 + 1/9 to 1 | −$0.053 |
| Even | 2, 4, 6, . . . , 36 | 1 to 1 | 1 + 1/9 to 1 | −$0.053 |
| Red | 32, 19, 21, 25, 34, 27, 36, 30, 23, 5, 16, 1, | 1 to 1 | 1 + 1/9 to 1 | −$0.053 |
| | 14, 9, 18, 7, 12, 3 | | | |
| Black | 15, 4, 2, 17, 6, 13, 11, 8, 10, 24, 33, 20, | 1 to 1 | 1 + 1/9 to 1 | −$0.053 |
| | 31, 22, 29, 28, 35, 26 | | | |
| 1 to 18 | 1, 2, 3, . . . , 18 | 1 to 1 | 1 + 1/9 to 1 | −$0.053 |
| 19 to 36 | 19, 20, 21, . . . , 36 | 1 to 1 | 1 + 1/9 to 1 | −$0.053 |

### B. Blackjack

In another example according to the embodiment of FIG. 4B, the secondary game may correspond to an auto-select or auto-fill option, wherein the processor automatically creates a predicted final outcome and/or predicted final ranking based on the players selected betting option, action and/or predictions in the secondary game 420 of blackjack. In certain examples, the processor may be configured to match odds or other parameters of predicted results of the secondary game to automatic selection of a predicted final outcome and/or predicted final ranking for participants in the one or more selected events having the same or similar odds of occurring. As such, the player may be able to play a secondary game in a manner that is reflected in a corresponding wager, such as by having the same odds or possible payout.

In certain aspects, the processor may be configured to select specific events for use in the wager in order to facilitate the matching of odds or other parameters of predicted results of the secondary game to automatic selection of a predicted final outcome and/or predicted final ranking for participants in the one or more selected events having the same or similar odds of occurring. For example, the game of blackjack involves dealing cards to a player and a dealer with the winner having the higher hand without surpassing a combined value of twenty-one. Based on the known value of cards in the deck, the probability of winning the hand may be determined and may be matched with the odds of successfully predicting a final outcome and/or final ranking of one or more participants of one or more selected events.

A predetermined data filter according to the current disclosure may be arranged for selecting one or more events according to the specific odds, possible odds, and the like for a corresponding secondary game. Starting from raw HHR data, or other event data, a series of filters may be applied in a predetermined sequence to efficiently create sets of event data for a given secondary game or related odds, probabilities, and possible actions or strategies.

In certain embodiments, the odds associated with the secondary game may be responsive to player input. For example, in blackjack the player receives an initial hand and may select whether to “hit” and receive an additional card or “stay” and proceed with the initial hand as dealt. The odds of winning the game of blackjack may be based on this decision, and the processor may automatically select a predicted final outcome and/or predicted final ranking for the one or more selected events on the basis of these same odds that the player's decision in the secondary game of blackjack creates.

In varying embodiments, the use of a secondary game as an entertaining display and an auto-select or auto-fill option, allows for concurrent progression of the secondary game and the underlying wager. In this manner, while the player is conducting a wager using a predicted final outcome and/or predicted ranking of participants in one or more selected events, the player may advantageously only experience the gameplay of the secondary game which influences the wager result by providing an auto-select or auto-fill feature based on the player's actions and/or predictions in the secondary game.

In some embodiments, the predicted outcome and/or predicted ranking may be iteratively completed by the processor in response to the player's iterative decisions in the secondary game. For example, the processor may auto-fill a first position of the predicted final outcome and/or predicted final ranking with a participant having the same odds as the player's position in the secondary game. Following the player's decision in the secondary game, such as whether to hit or stay in blackjack, the processor may then auto-fill another position of the final outcome and/or final ranking with a participant having odds corresponding to the change in odds from the player's decision. Additional embodiments may iteratively complete selected events. For example, the processor may auto-fill a predicted final outcome and/or predicted final ranking for one selected event to have the same odds as the player's position in the secondary game. Following the player's decision in the secondary game, such as whether to hit or stay in blackjack, the processor may then auto-fill the predicted final outcome and/or predicted final ranking for another of the selected events having odds corresponding to the change in odds from the player's decision.

In another aspect of a secondary game of blackjack, the gaming machine may present the player with an initial hand and the option to “hit” or “stay” in an attempt to beat the dealer's hand. In an embodiment of the current disclosure where blackjack is provided as a secondary game, the odds of winning for the decision to “hit” or “stay” may be obtained and the player may place a bet by selecting “hit” or “stay” through an input device of the gaming machine.

The processor may then identify the payout odds of the “hit” or “stay” decision of the player's bet and auto-fill a predicted final outcome and/or predicted ranking of one or more selected events in order to match the payout odds of the player's bet and the odds of a successful wager in the predicted final outcome and/or predicted final ranking. The predicted final outcome and/or predicted final ranking may then be compared to the actual final outcome and/or final ranking and a wager result derived therefrom. The blackjack game may then be led to a wager outcome matching the wager result.

One issue that arises with secondary games, such as blackjack, poker or the like where a player is allowed to make mid-game or iterative decisions, is how to account for the impact of the player's decisions on the game. For example, in one aspect of the secondary game of blackjack, a player may be presented with an initial hand and, in addition to the option to “hit” or “stay”, the player may be given the option to “split” the hand into two separate hands, then receive an additional card for each hand from the dealer. Commonly, the option to split the cards into two separate hands is given when a player's initial two-card hand includes two cards of the same value, although this is not necessarily required in all embodiments of the current disclosure.

The decision to split in blackjack has a direct impact on the pay table for the game, as the player must place an additional wager or bet on the newly created hand, commonly equal to the original wager or bet placed on the initial hand. In disclosed embodiments having a secondary game based on an underlying primary game, player decisions in the secondary game may be configured to correspond with changes to the scorecards and/or pay table of the primary game, providing a more enjoyable and interactive experience relative to a secondary game where features of the game are restricted to match the result to the primary game.

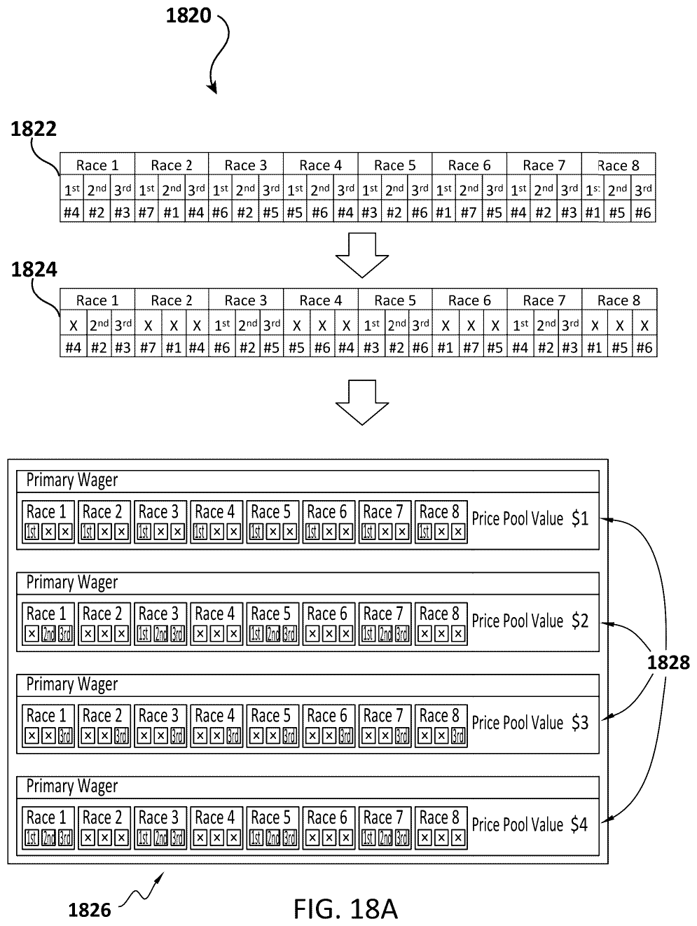

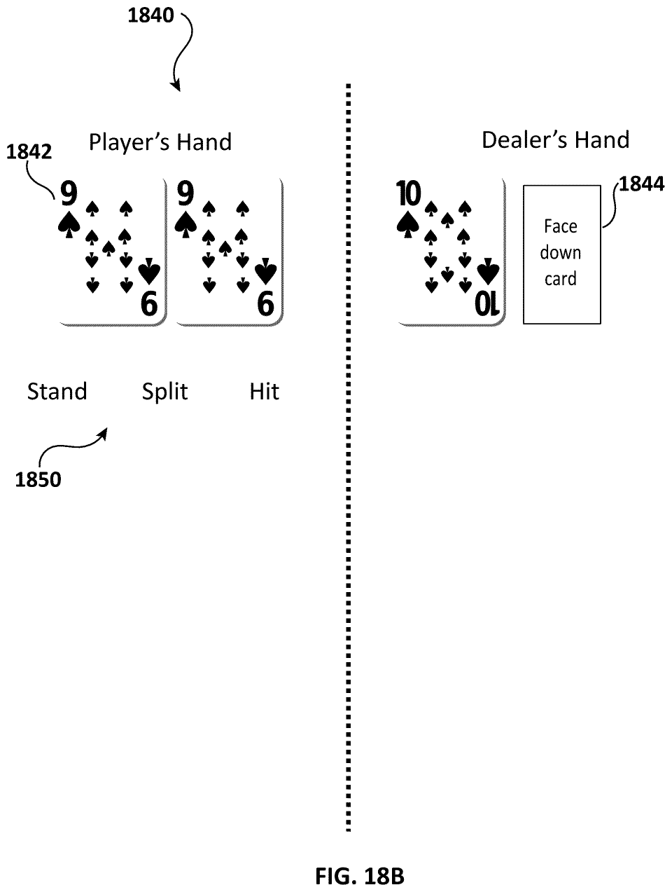

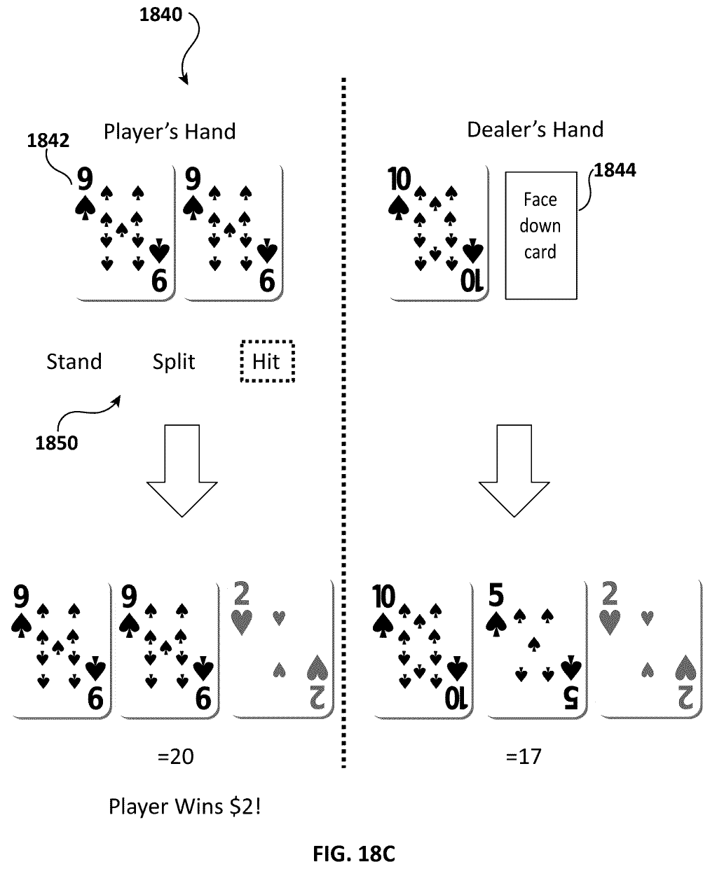

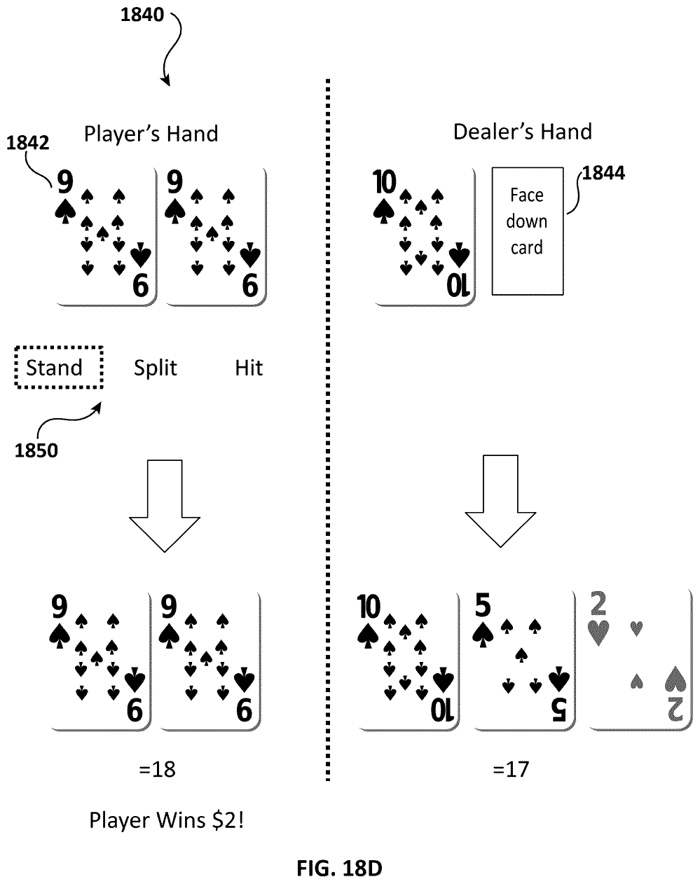

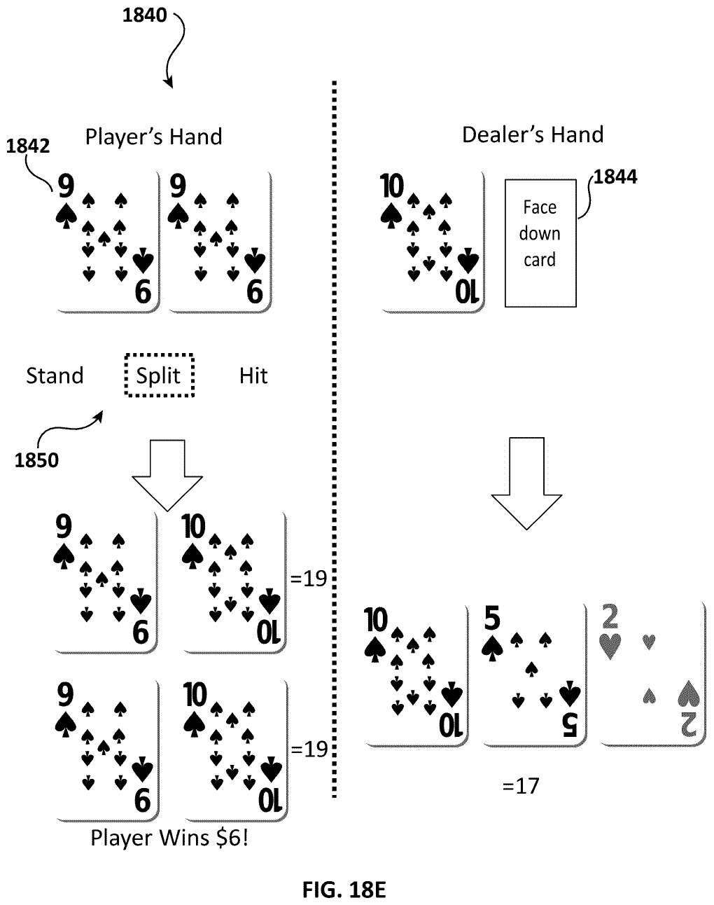

One embodiment for conducting a secondary game based on an underlying primary game where the player's decisions in the secondary game are configured to correspond with changes to the scorecards and/or pay table of the primary game is further described with respect to FIG. 18A-E. For case of understanding, the embodiment of FIG. 18A-E is described herein with reference to HHR as a primary game 1820 and blackjack as a secondary game 1840, although the current disclosure is not limited thereto.

In a first step, an initial gameplay request may be provided by the player to initiate gameplay at a gaming server, station, or device for conducting a secondary game 1840 based on an underlying primary game 1820 according to a method of the disclosure. The gameplay request may include a selection or initialization of a primary game, a secondary game, a wager amount, and/or a wager level.

The primary game 1820 may be based on one or more identified events, such as a historical horse race. The events may include simulated events, historical events, and/or the like. The events further comprise parameters necessary for governing a wager on the events, such as information regarding participants, event conditions, etc. In one aspect, the pending events may be selected from a database of events based on a number of predetermined criteria. For example, the pending events may be selected from a database of events based on a number of participants in the event, the location of the event, the type of event, the location of the gaming server, or the results of the event (number of finishers, disqualifications, etc.). The predetermined criteria may result from regulatory constraints, house requirements or otherwise, and may advantageously facilitate flexibility in conducting wagers across geographic and regulatory domains.

Based on the one or more identified events, a predicted final outcome and/or predicted final ranking 1822 comprising an ordered final ranking of participants for the one or more identified events may be provided. A player may create the predicted final outcome and/or predicted final ranking, such as by manually handicapping a horse race, or the gaming machine may automatically create the predicted final outcome and/or predicted final ranking. Event data about the one or more events may be provided to facilitate the creation of the predicted final outcome and/or predicted final ranking. The event data may include information relating to the participants in the one or more events and/or the events' conditions. For example, where the event is a horse race or historical horse race, the participants may be racehorses and the information may include characteristics of the racehorse, a jockey riding the horse, a trainer affiliated with the racehorse and/or jockey, etc., such as is generally provided to players at a racetrack in a daily racing form or horse racing form. Conditions of such a horse race may additionally include the length of the track, location, weather, date, time, etc.

Various forms of ordered rankings may be used, such that a predicted final outcome and/or predicted final ranking 1822 may be provided in the form of a wager card adapted for use with varying types of wagering, including sports wagering or other event-based wagering. The wager cards may therefore take varying forms, including a predicted finisher, score, time, arrangement of numbers or places, etc. For example, a wager card may include a prediction of a first-place finisher, a second-place finisher, and a third-place finisher for each of the one or more events. In the step of identifying the one or more events, a plurality of events may be selected as an ordered combination of events, such that a wager card provides a prediction for a first-place finisher, a second-place finisher, and a third-place finisher for a first selected event from the first plurality of events, followed by a first-place finisher, a second-place finisher, and a third-place finisher for a second selected event from the first plurality of events, and so forth.

The predicted final outcome and/or predicted final ranking 1822 may be compared to actual results of the events for determining a prediction result 1824, where an “X” is provided to indicate an incorrect prediction. Based on the prediction result 1824, a wager result for the primary game 1820 is determined from a pay table 1826 including a plurality of scorecards 1828 corresponding to various combinations of correct and incorrect predictions from the prediction result 1824. As such, a reward or payout may be determined based on whether a scorecard 1828 matches the prediction result 1824 of the predicted final outcome and/or predicted final ranking 1822.

Each possible scorecard 1828 may be associated with a different award level, and a reward value may be determined from the award level corresponding to the scorecard only when the selected scorecard 1828 matches the prediction result 1824 of the predicted final outcome and/or predicted final ranking 1822. In embodiments, the determination of the reward value may be based on the award level, an amount wagered by the player, and/or a wager pool value. The amount wagered by the player may be included in the gameplay request. In like manner, the wager pool value may be governed by a totalizer or other control device.

For the specific example of FIG. 18A, the primary game 1820 may provide the player with a reward value or payout corresponding to the second scorecard with a prize pool value of $2, in view of the prediction result 1824 matching the second scorecard. A secondary game 1840 may then be displayed for the player based on the result of the primary game 1820, the secondary game 1840 having a result corresponding to the result of the primary game 1820, for example a winning hand in blackjack or the like as discussed in various embodiments herein.

In the secondary game 1840 according to FIG. 18B-18E, a player may select bet options 1850 corresponding to the secondary game 1840 that are configured to correspond with changes to the scorecards 1828 and/or pay table 1826 of the primary game 1820. For example, where the secondary game 1840 is blackjack, the player may be provided an initial hand 1842 and a dealer may be provided an initial hand 1844. Based on the initial hand 1842, 1844, the player may select one or more bet options 1850, for example a decision between “Stand”, “Split”, or “Hit” according to traditional blackjack. The options “Stand”, “Split”, or “Hit” of the secondary game are correlated to one or more options in the underlying primary game. For example, HHR options of an underlying primary game may be configured as “Buy Wildcard”=“Split” and “Don't Buy Wildcard”=“Stand” or “Hit”. Notably, more than one option in one of the primary or secondary game can be configured to correlate to the same option in the other of the primary or secondary game, or the options can be correlated in a one-to-one manner.

For the underlying primary game 1820 of FIG. 18A, a player's decision in the secondary game 1840 to “Stand” or “Hit” results in a winning hand relative to the dealer, with a reward value or payout of $2 based on the second scorecard 1828 of the primary game 1820 matching the prediction result 1824 of the primary game 1820. A visual result of a decision to “Stand” is depicted in FIG. 18C, while a visual result of a decision to “Hit” is depicted in FIG. 18D.

A player's decision in the secondary game 1840 to “Split” presents particular challenges for a secondary game 1840 that is based on an underlying primary game 1820, as the decision to split changes a wager value provided by the player and possible reward values. However, the disclosed embodiments of the present disclosure may be configured such that player decisions, such as to split in blackjack, correspond to changes or options in the primary game.

FIG. 18E illustrates a specific example where a player selects one or more bet option 1850 corresponding to the secondary game 1840 that is configured to correspond to an option to buy a wildcard spot in the scorecards 1828 and/or pay table 1826 of the primary game 1820. When purchased, the wildcard spot may be marked as correct no matter what the player's prediction was. For example, the player may purchase a wildcard spot corresponding to the 1^{st} place of Race 1 for the primary game 1820 of FIG. 18A. Now, in this example, the player's prediction result 1824 matches both the second and the fourth scorecards 1828, resulting in a payout of $6. A visual result of the decision to “Split” is depicted in FIG. 18E.

The description of a wildcard is only one possibility for a change or option of an underlying primary game, and various configurations are possible. For example, in addition to or in place of a wildcard spot, a player's decision in a secondary game may be configured to correspond to enabling different scorecards, multiple wildcard spots, an increase of a wager value, or the like. In some embodiments, the decision may initiate a second primary game, such that more than one primary game wagers are conducted concurrently, for example, where a player selects to split in the secondary game of blackjack, makes an odds wager in craps, fold in three-card poker, etc. Multiple primary game wagers may be made on the basis of the same event or set of events, or may be made on the basis of different events or sets of events.

While described with respect to a secondary game of blackjack, variations on the embodiments of FIGS. 18A-18E may be applied to other table games and the like. For example, embodiments may be provided for any secondary game having more than one wager, such as corresponding to side-bets in table games, e.g., an insurance bet in blackjack. In this manner, players can place more than one wager at a time, and past and future plays may be related.

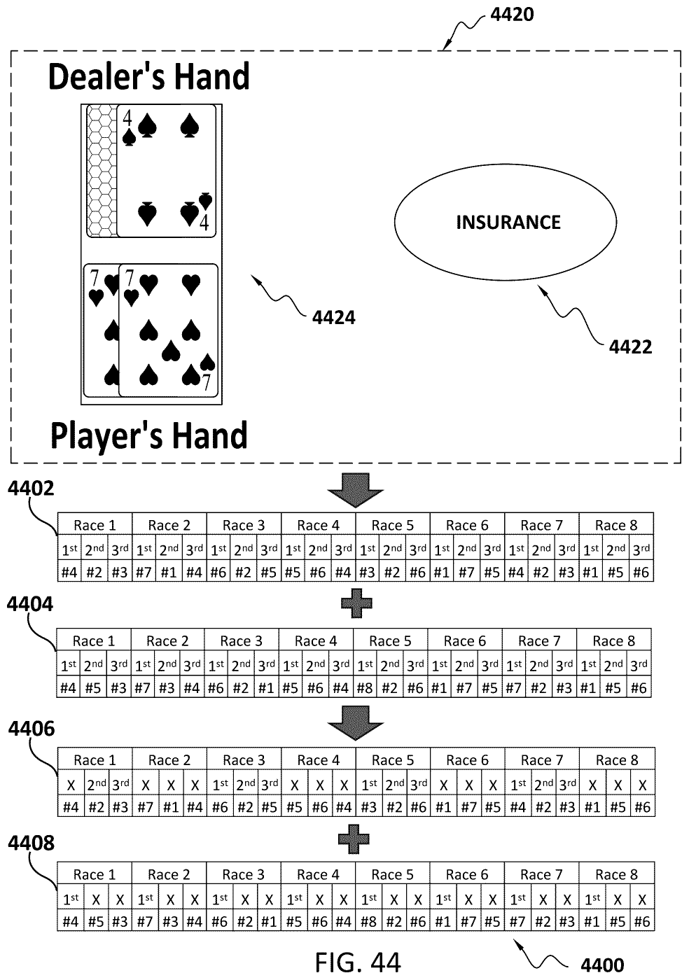

In the example of FIG. 44, players may be provided with the option to play with “insurance” and purchase additional wagers and/or scorecards. For example, purchasing insurance may provide a second scorecard which will be combined with an initial scorecard for comparing a resulting combination to a prediction result of the player. In another example, purchasing insurance may allow a player an additional wager and/or prediction, such that a prediction result may be based on a combination of two predicted final rankings.

In FIG. 44, a secondary game 4420 of blackjack is provided where the player places a bet 4424 on an initial hand in the secondary game 4420 of blackjack with a corresponding first predicted final ranking 4402 in the underlying primary game 4400. The player may purchase insurance 4422 and enable a second wager and corresponding second predicted final ranking 4404 in the underlying primary game 4400. Each predicted final outcome and/or predicted final ranking 4402, 4404 may be compared to actual results of the events for determining a first prediction result 4406 corresponding to the first predicted final ranking 4402 and a second prediction result 4408 corresponding to the second predicted final ranking 4404, where an “X” is provided to indicate an incorrect prediction.

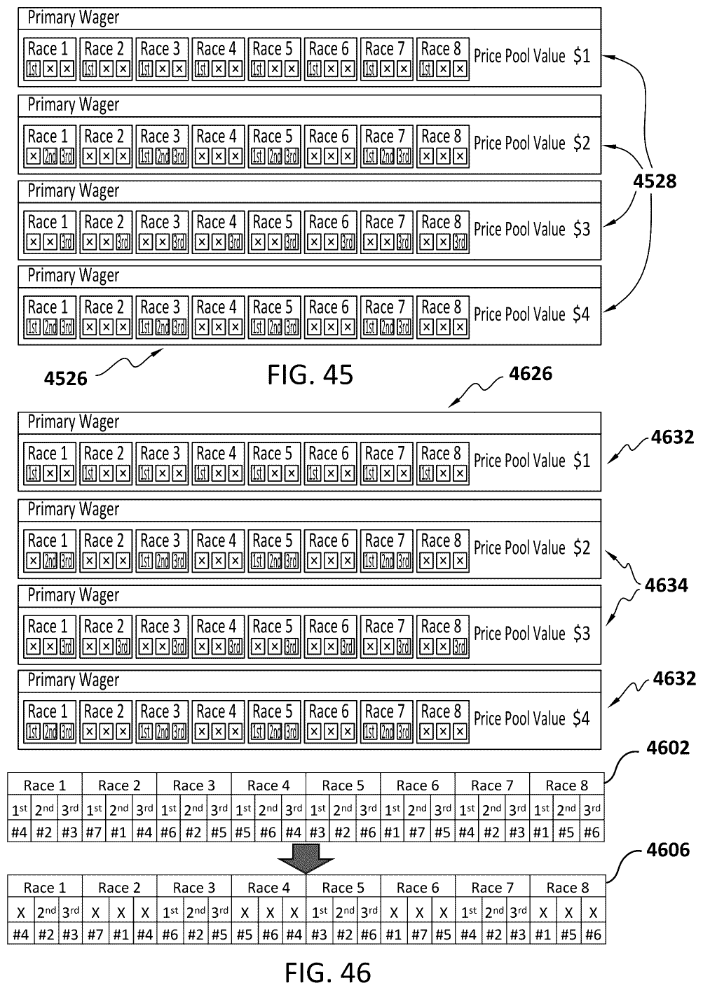

As illustrated in FIG. 45, based on a combination of the first prediction result 4406 and the second prediction result 4408, a wager result for the primary game 4400 may be determined from a pay table 4526 including a plurality of scorecards 4528 corresponding to various combinations of correct and incorrect predictions from the first prediction result 4406 and the second prediction result 4408. As such, a reward or payout may be determined based on whether a scorecard 4528 matches the first prediction result 4406 and the second prediction result 4408 of each predicted final outcome and/or predicted final ranking 4402, 4404.

Each possible scorecard 4528 may be associated with a different award level, and a reward value may be determined from the award level corresponding to the scorecard only when the selected scorecard 4528 matches the prediction result 4406, 4408 of the predicted final outcome and/or predicted final ranking 4402, 4404. In embodiments, the determination of the reward value may be based on the award level, an amount wagered by the player, and/or a wager pool value. The amount wagered by the player may be included in the gameplay request. In like manner, the wager pool value may be governed by a totalizer or other control device.

As seen in the illustrated example of FIG. 44, the first prediction result 4406 corresponding to the first predicted final ranking 4402 alone results in providing the player with a reward value or payout corresponding to the second scorecard with a prize pool value of $2, in view of the first prediction result 4402 matching the second scorecard in the pay table 4526. However, with a purchase of insurance, a combination of the first prediction result 4406 and the second prediction result 4408 result in a winning pattern 3916 or final result of a result index. Now, in this example, the combination of the player's first prediction result 4406 and second prediction result 4408 matches the first, second and fourth scorecards 4528, resulting in a payout of $7.

In varying embodiments, purchasing insurance may allow the player to make multiple predictions for the same wager, e.g., the same set of events, essentially providing the player with two or more prediction opportunities for the same events. Additional insurance options may include an offer to a player to pay extra to ignore a losing wager or prediction result, and/or to have the lowest of a series of wagers or prediction results tossed out (e.g., forfeited), and/or the like.

In some embodiments, purchasing insurance may enable additional scorecards or otherwise modify a pay table 4526. For example, as shown in FIG. 46, a primary game 4600 may be configured to use a pay table 4626 with only the first and fourth scorecards 4632 enabled. Purchasing insurance 4422 in the secondary game 4420 may be configured to enable additional scorecards 4634 for determining a reward value, such as, in this example, by enabling the second and third scorecards 4634.

Applying the example of FIG. 44 to this variation, the player places a bet 4424 on an initial hand in the secondary game 4420 of blackjack with a corresponding predicted final ranking 4602 in the underlying primary game 4600. The predicted final outcome and/or predicted final ranking 4602 may be compared to actual results of the events for determining a prediction result 4606 corresponding to the predicted final ranking 4602, where an “X” is provided to indicate an incorrect prediction.

As seen in the illustrated example of FIG. 46, the prediction result 4606 corresponding to the predicted final ranking 4602 alone results in a loss when evaluated against the first and fourth scorecards 4632 of the pay table 4626. However, with a purchase of insurance 4422 in the secondary game 4420, additional scorecards 4634 are enabled for evaluating a reward for the player's wager. Now, in the example according to FIG. 46, the player receives a payout corresponding to the second scorecard from the additional scorecards 4634 with a prize pool value of $2, in view of the prediction result 4606 matching the second scorecard in the pay table 4626.

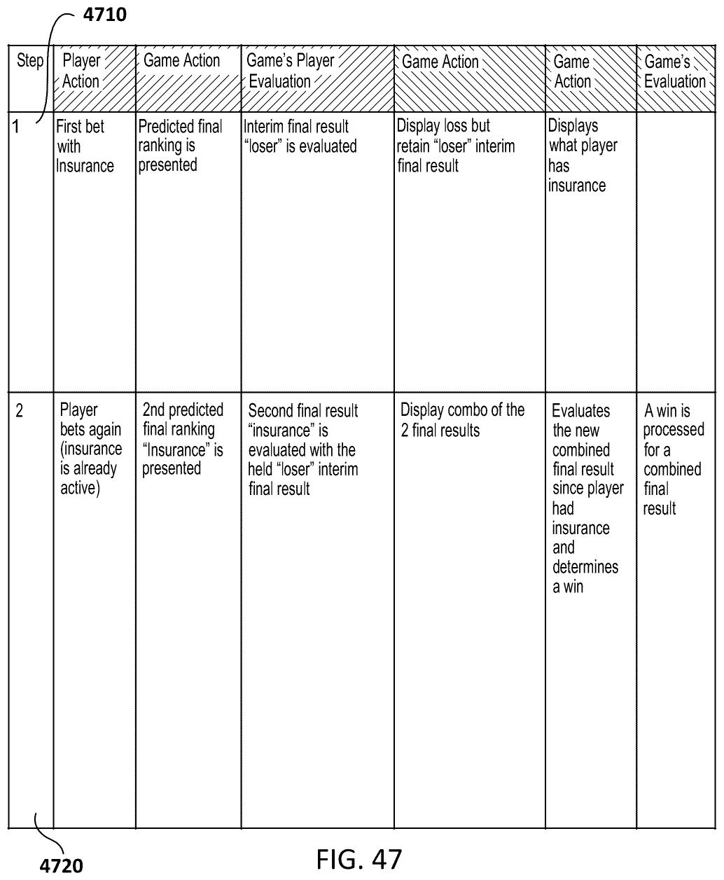

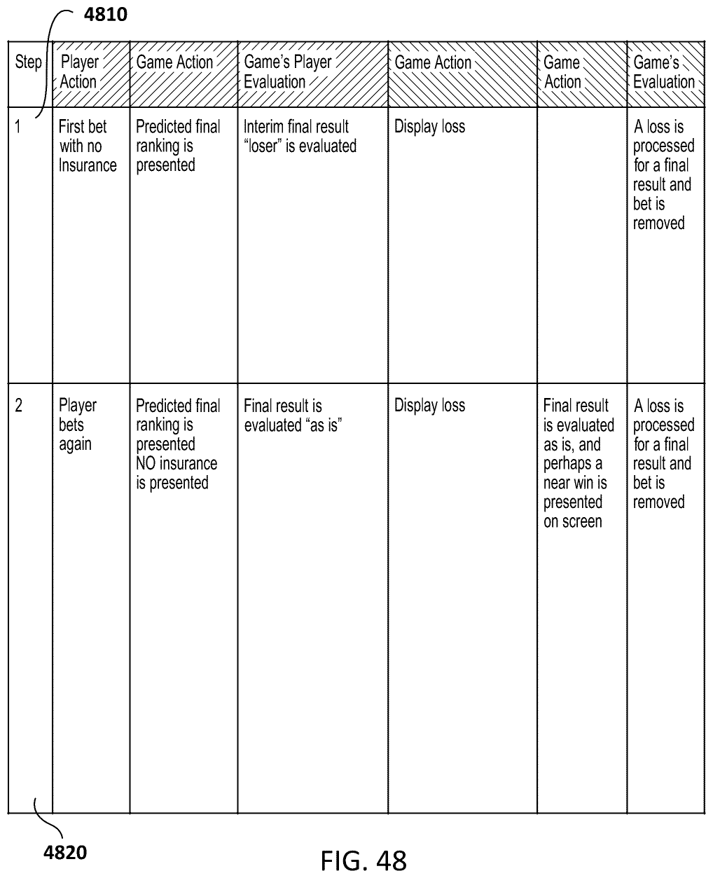

The illustrated embodiments of FIG. 47 and FIG. 48 depict an example of a method of providing insurance in a primary game of HHR, such as for a primary game of HHR underlying a secondary game. In a first step 4710 according to FIG. 47, a player places a bet with insurance and a predicted final ranking is presented in the primary game. The predicted final ranking is evaluated and an interim prediction result formed by correct and incorrect predictions from the predicted final ranking is determined to be a loser, such that a loss is displayed but the interim prediction result is retained in the primary game. In a second step 4720, the player bets again and another predicted final ranking is presented in the primary game as provided by the player, such that the final result of this second predicted final ranking and the interim final result are evaluated together and, in the illustrated example, a win is processed for the combination.

FIG. 48 illustrates an example where a player is not a winner, as in FIG. 47, but without insurance. In a first step 4810 according to FIG. 48, a player places a bet without insurance and a predicted final ranking is presented in the primary game. The predicted final ranking is evaluated and an interim prediction result formed by correct and incorrect predictions from the predicted final ranking is determined to be a loser, such that a loss is displayed and the initial bet is removed. In a second step 4820, the player bets again and another predicted final ranking is presented in the primary game as provided by the player, such that the multiple final results of the predicted final rankings are evaluated independently and, in the illustrated example, a loss is processed for each individual final result.

While illustrated in FIGS. 18A-18E and 44-48 and discussed above with reference to some specific examples of a secondary game having more than one decision, iterative decision, mid-game decision, and/or wager, the current disclosure is not limited to these examples. Instead, the use of more than one final result in a 3D-like arrangement (e.g., where the results stack), in a combined final result, or the like may be configured to provide a player with multiple bet options in a secondary game. In a secondary game according to the current application, a player may select bet options corresponding to the secondary game that are configured to correspond with changes to the final results and/or scorecards and/or pay table of the primary game. For example, where the secondary game is blackjack, the player may be provided an initial hand and, based on the initial hand, the player may select one or more bet options, e.g., a decision between “Stand”, “Split”, or “Hit” according to traditional blackjack.

The options “Stand”, “Split”, or “Hit” of the secondary game may be correlated to one or more options in the underlying primary game. For example, corresponding options in an underlying primary game of HHR may be configured as “Buy additional wager or insurance”=“Split” and “Don't buy additional wager or insurance”=“Stand” or “Hit”. Notably, more than one option in one of the primary or secondary game can be configured to correlate to the same option in the other of the primary or secondary game, or the options can be correlated in a one-to-one manner. When purchased, a wildcard spot may be marked on one or more of the player's final results, an additional final result may be combined with an initial final result to determine a combination final result, one or more scorecards may be enabled/disabled, etc. For example, the player may purchase insurance corresponding to a wildcard spot, and/or the player may purchase insurance in the form of an additional wager with a final result that is combined with a final result of an initial wager as in FIG. 47, and/or another form of insurance may be provided as discussed above.

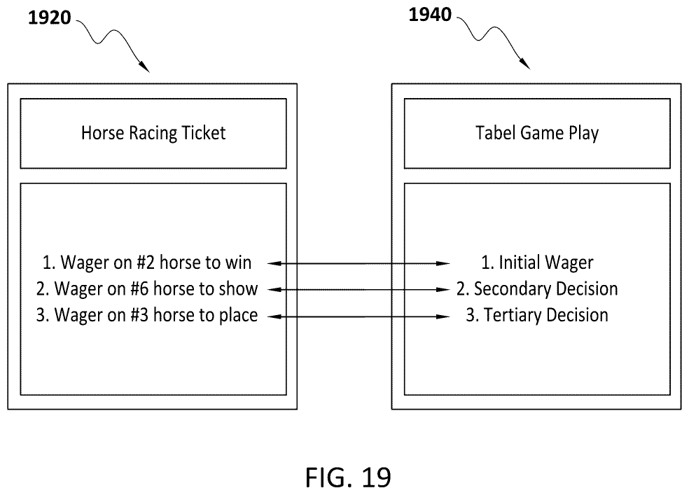

In certain aspects, an underlying primary game may be configured to allow multiple wagers in a single play, such that three or more wagers may be applied to the same event or set of events, as illustrated in FIG. 19 for a primary game of HHR. As seen in FIG. 19, rather than splitting up a single wager into multiple wagers, the primary game may allow a player to place multiple wagers or bets through decisions made in a secondary game. In many traditional table games, there are situations where players are provided the opportunity to make supplemental or mid-game decisions which include or require additional payment or investment, in the form of an additional or even side-bet or wager. Some, but not all, examples of these additional decisions include the choice of splitting in blackjack, odds wagers in craps, fold in 3-card poker, etc.

In contrast, existing implementations of casino games, such as based on HHR, require a singular wager style of gameplay. This limitation has generally led to a restriction in available game types based on HHR, meaning that HHR-based gaming is generally limited to slot machine style games that require only an initial wager and no secondary or supplemental decisions. Advantageous implementations according to the present disclosure may allow for multiple wagers on a single play or game of an underlying primary game, based on secondary or supplemental decisions made in a secondary game presented to a player.

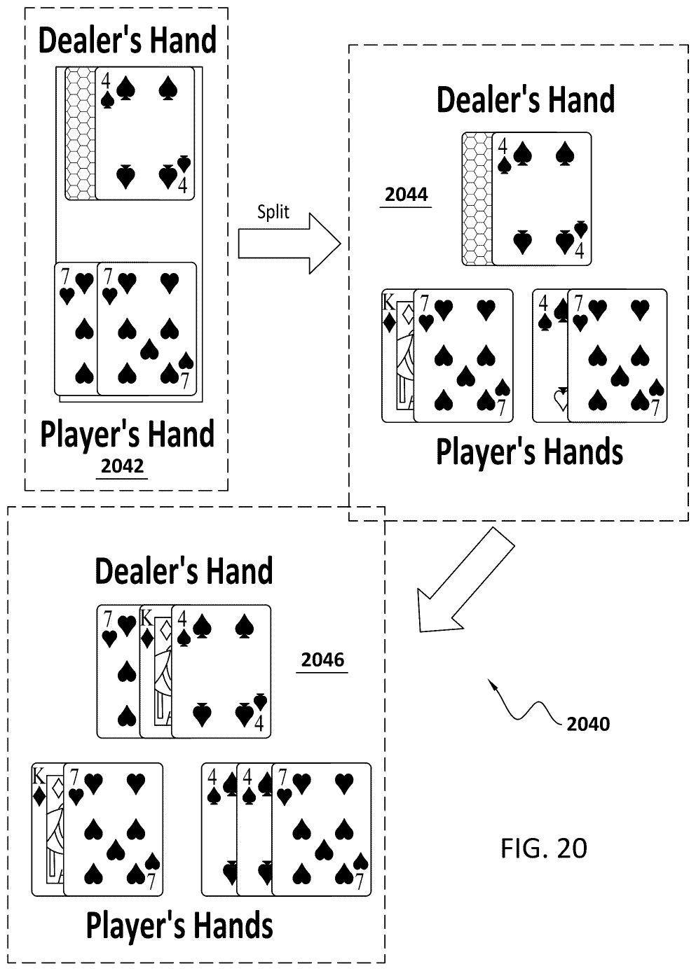

FIG. 20 illustrates an example of a secondary game 2040 of blackjack based on an underlying primary game of HHR, where the secondary game 2040 includes at least a secondary and tertiary decision in the form of a decision to split and a decision to double-down. In a first step 2042, an initial wager is made in the secondary game and the game presents the player with an initial hand for both the dealer and the player. As in traditional blackjack, the player is given the option to “Stand”, “Hit”, “Split” or “Double-Down” based on the cards dealt.

Should the player elect to stand or hit, a wager result is determined by the underlying primary game and the secondary game is configured to give a matching result, for example showing cards corresponding to a blackjack win for a win in the primary game or showing cards representing a blackjack loss for a loss in the primary game. Notably, the decisions to stand or hit do not involve an additional pay or bet, and so the result of the primary game may be reproduced in an essentially one-to-one manner, in addition to any bonus games or other adaptations as described with respect to further embodiments herein.

As seen in FIG. 20, the described embodiments are further adapted to allow secondary, tertiary or more decisions in the secondary game, with the decisions having a substantive effect in the primary game. Based on the initial wager and hand 2042, the player may make a decision to split their hand, resulting in an additional wager 2044 being made on a second player hand which includes an additional pay or wager value beyond the initial wager 2042. In the illustrated example, the player makes the decision to split two sevens from the player hand against the dealer's current hand of four. The player is dealt two additional cards and now has two hands 2044 and two wagers in the secondary game 2040, a king and a seven with a value of 17 and a four and a seven with a value of 11 against the same dealer hand of four.

Based on the two hands 2044, the player is again given the options of at least “Stand”, “Hit”, or “Double-Down” for each hand based on the cards dealt. In the illustrated example, the player makes a decision to stand on the left hand and double down on the right hand 2046, resulting in an additional wager 2046 being made on a second player hand which includes an additional pay or wager value beyond the initial wager 2042 and beyond the secondary wager 2044.

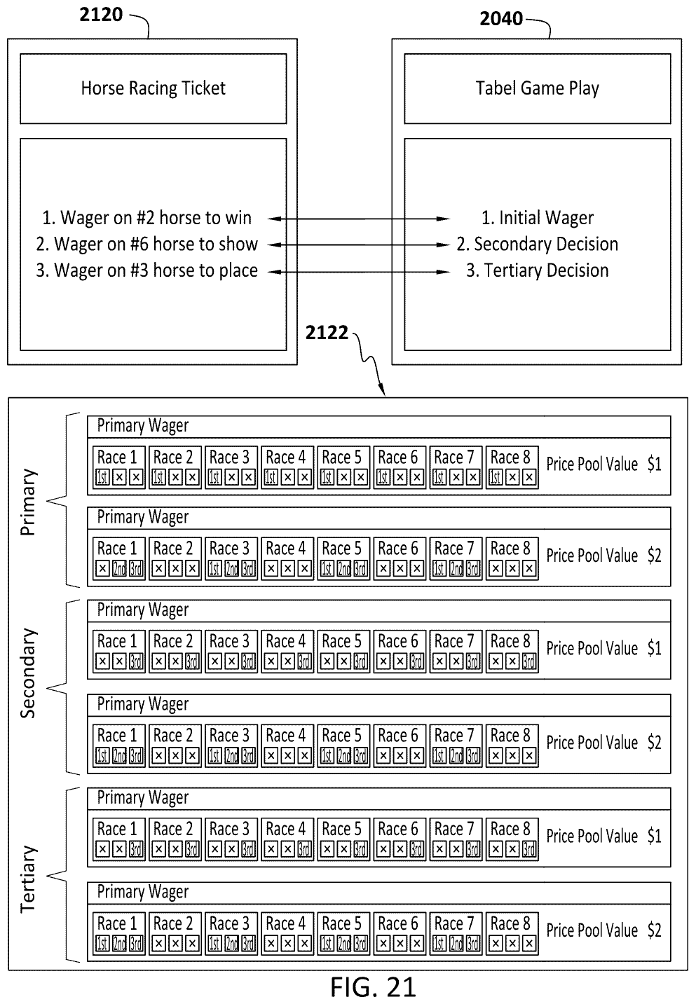

FIG. 21 illustrates how an underlying primary game 2120 of HHR is conducted for the secondary game 2040 of blackjack, with the initial wager in the secondary game corresponding to a wager on #2 horse to Win, the split decision corresponding to a wager on #6 horse to Show, and the double down decision corresponding to a wager on #3 horse to place. The wagers of the primary game 2120 may be made on the same event or set of events, with the pay table 2122 of the primary game 2120 including scorecards 2124 corresponding to each individual wager. Advantageously, the described embodiments allow for not only an initial wager decision but also secondary, tertiary and more decisions by a player made in a secondary table game to be simulated using an underlying primary game. As such, players are given increasing variability in available gameplay, while advantages in regulatory and processing requirements are realized and/or retained by the use of the underlying primary game.

The above examples are not limited to any certain wager options, such as those provided in traditional blackjack. Embodiments may be configured to allow additional bets or wagers, such as in the form of a side-bet, for example to allow players to wager for large jackpot prizes as a player pool size grew. Some examples of such a side bet may include a bet placed on the cards that will be dealt in blackjack, e.g., straight flush on the three first dealt cards of the game, but many variations are possible and may be applied according to the same principles discussed above.

The same principles from the above examples can be applied to any secondary game by associating relevant betting options with pay table/scorecard entries of the primary game. In this way, the player's actions in the secondary game have a direct effect on a result of the underlying primary game, while advantageously maintaining the primary game as the source of the wager and the wager result.

In some embodiments, the secondary game may correspond to a game having the possibility of multiple players, as in, for example, blackjack or another group-style table game. Such multiplayer or community casino games present a challenge for implementation with an underlying primary game based on HHR, such as due to the difficulty in allowing common conditions, for example a dealer's hand, to affect all players of a game, for example a blackjack table or game.

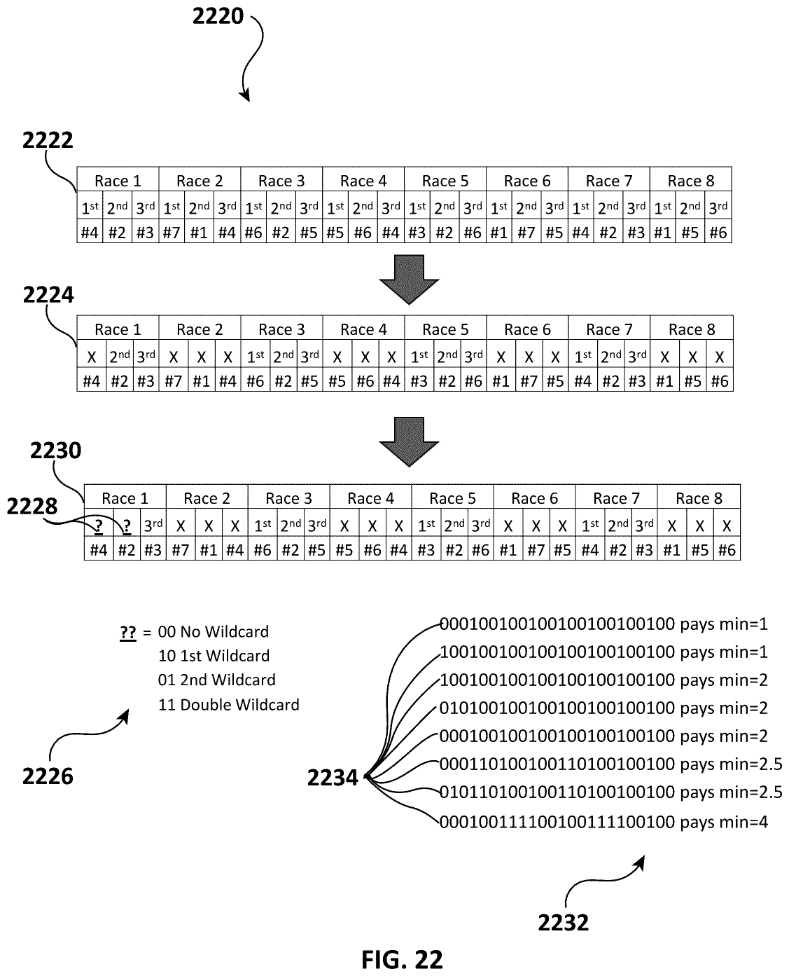

According to embodiments of the disclosure, a secondary game may be provided as a multiplayer table game or casino game with the use of an underlying primary game based on HHR. The embodiment of FIG. 22 illustrates an example of a secondary game of blackjack implemented based on an underlying HHR primary game 2220, where multiple players are affected by the same dealer hand in the secondary game by use of a community effect applied in the primary game. For providing a community effect, scorecards may be provided with a “key” to create a group or linked experience in the HHR primary game.

According to the embodiment of FIG. 22, an initial gameplay request may be provided by each player, as in other embodiments, and a predicted final outcome and/or predicted final ranking 2222 of participants for one or more identified events of the wager may be evaluated to determine a result of the wager for each player, e.g., whether the wager results in a win or a loss. The predicted final outcome and/or predicted final ranking 2222 may be compared to actual results of the events for determining a prediction result 2224, similar to the embodiment of FIG. 18A. However, in the multiplayer embodiment of FIG. 22, each player's prediction result may be modified with a community modifier 2226, such as in the form of one or more community wildcard spots 2228 or similar modifications. Based on the modified prediction result 2230, a wager result for the primary game is determined from a pay table 2232 including a plurality of scorecards 2234 corresponding to various combinations of correct and incorrect predictions from the prediction result.

Each possible scorecard 2234 may be associated with a different award level, and a reward value may be determined from the award level corresponding to the scorecard only when the selected scorecard 2234 matches the modified prediction result 2230 of the predicted final outcome and/or predicted final ranking 2222. In embodiments, the determination of the reward value may be based on the award level (including minimum award and/or dynamic award), an amount wagered by the player, and/or a wager pool value. The amount wagered by the player may be included in the gameplay request. In like manner, the wager pool value may be governed by a totalizer or other control device.

In the embodiment of FIG. 22, the community modifier 2226 is selected from a group of possible modifiers and applied to every player's prediction results 2224. For example, the community modifier 2226 may be selected as the result of a random number generator, may be selected based on conditions of the game or the player pool, and the like. In one aspect, the community modifier 2226 may be applied to the modified prediction results 2230 such that the modified wildcard spots 2228 form a “key” on the scorecards 2234. As shown in the illustration of FIG. 22, the first two spots 2228 of each player's modified prediction result 2230 are based on the community wildcard 2226. Scorecard 2234 awards may then be configured based on this structure to add a community effect that applies to all players, e.g., scorecard=11*********** all players lose due to dealer blackjack. A secondary game may then be displayed for the players based on the result of the primary game 2220, the secondary game having a result corresponding to the result of the primary game 2220, for example a winning hand in blackjack or the like as discussed in various embodiments herein.

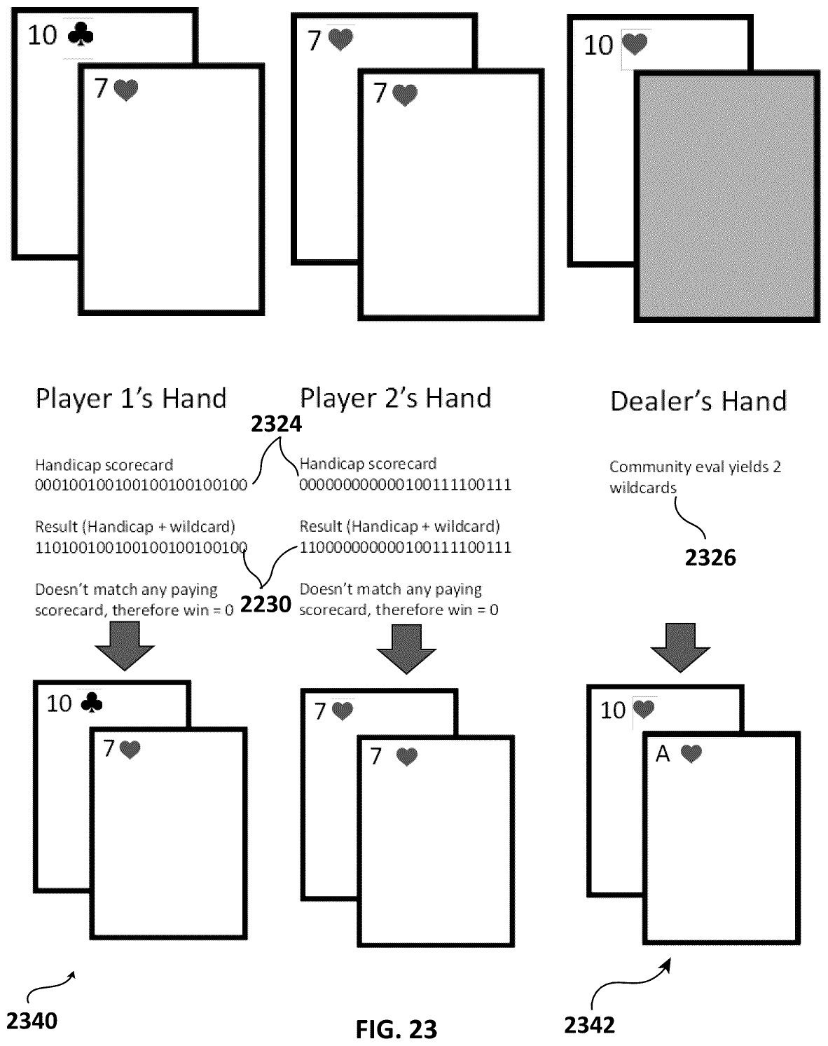

FIG. 23 illustrates an example of a secondary game 2340 of blackjack based on an underlying primary game of HHR using a community modifier according to FIG. 22. In FIG. 23, a player's prediction result 2324 from the HHR primary game 2220 is provided and the primary game 2220 determines or selects a community modifier 2326 of a “Double Wildcard”, yielding a modified prediction result 2330. In this case, the double wildcard is correlated to a dealer's blackjack 2342, meaning that all players are dealt a loss based on the community modifier 2326.

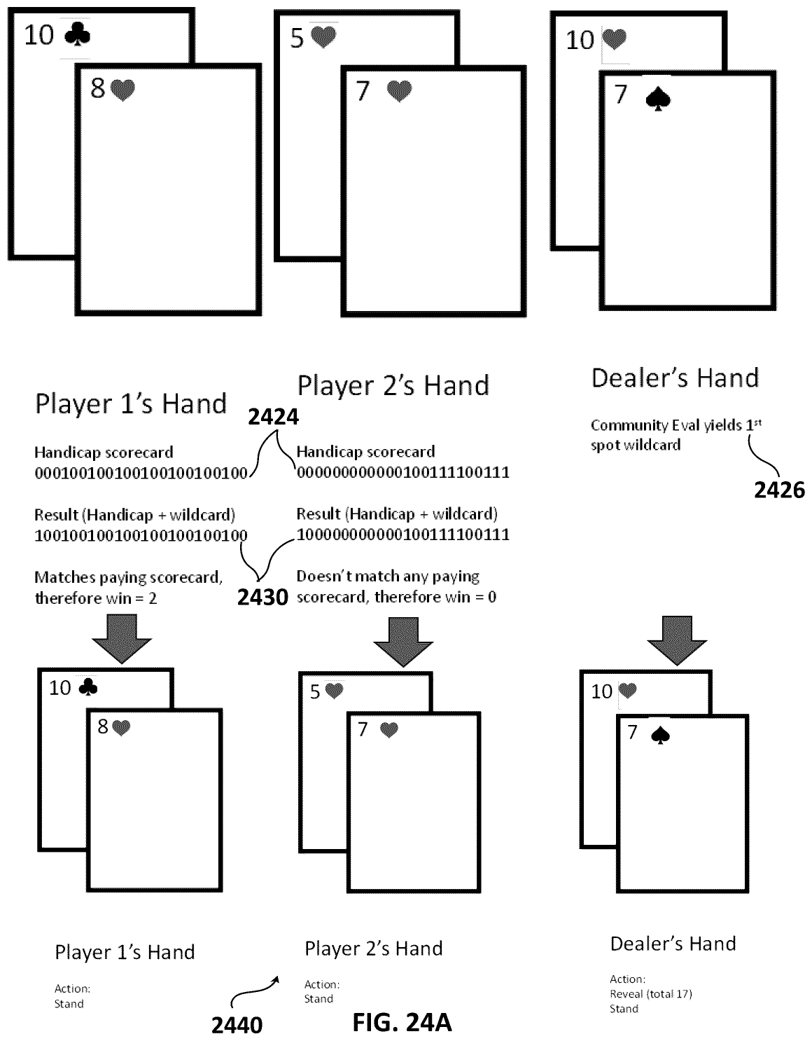

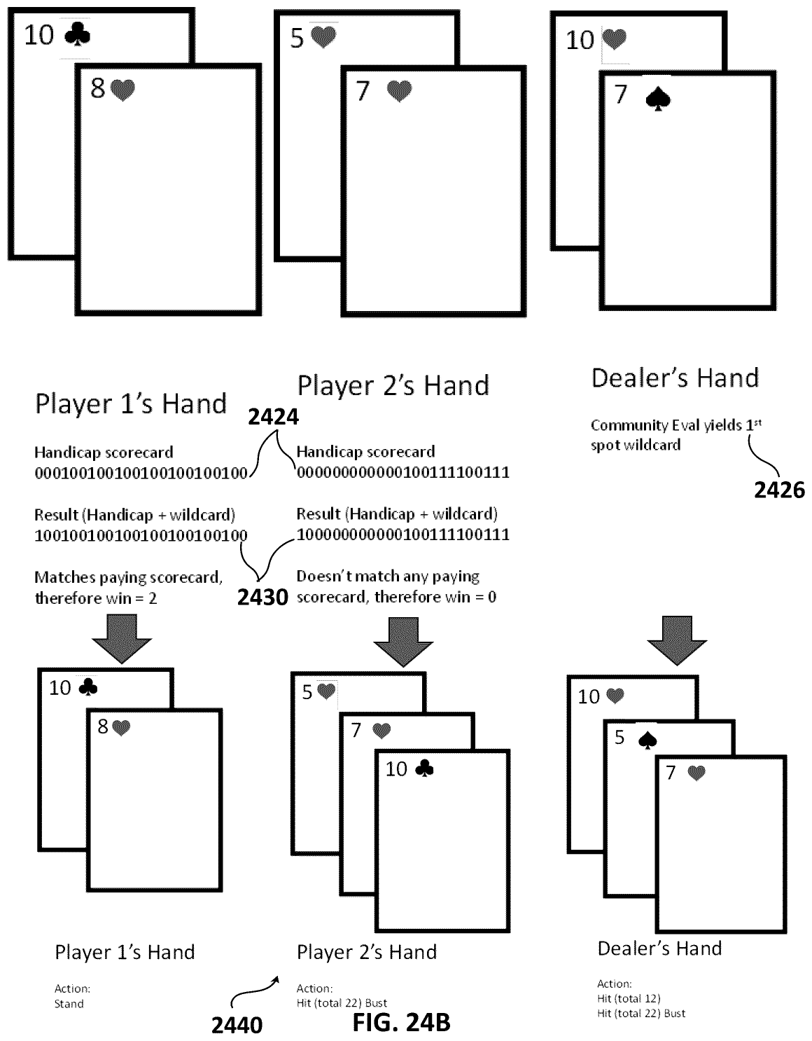

In the secondary game 2440 according to FIGS. 24A and 24B, a community modifier 2426 in the form of a 1^{st} spot wildcard is selected. In FIGS. 24A and 24B, a player's prediction result 2424 from the HHR primary game 2220 is provided and the primary game 2220 determines or selects the community modifier 2426 of a “1^{st} Wildcard”, yielding a modified prediction result 2430. In this case, based on the 1^{st} wildcard, player 1 has won due to a match with a scorecard 2234 while player 2 has lost due to a lack of a match. Visually, cards are dealt in the secondary game 2440 such that the result of the primary game 2220 is shown in the secondary game 2440, with a player 1 win and a player 2 loss. In FIG. 24A, player 2 stands and the dealer is given a card to result in a player 1 win and a player 2 loss, while in FIG. 24B player 2 hits and results in a bust, meaning a player 1 win and a player 2 loss. In both cases of FIGS. 24A and 24B, should player 1 hit the secondary game may provide a three and force a stand on 21, meaning a player 1 win and a player 2 loss in the secondary game corresponding to the result of the underlying primary game.

The description of a wildcard is only one possibility for a change or community modifier option for an underlying primary game, and various configurations are possible. For example, embodiments may be configured to allow all players in a multiplayer table game to encounter shared conditions by configuring scorecards, by allowing only certain scorecards, or by varying other conditions of the underlying primary game.

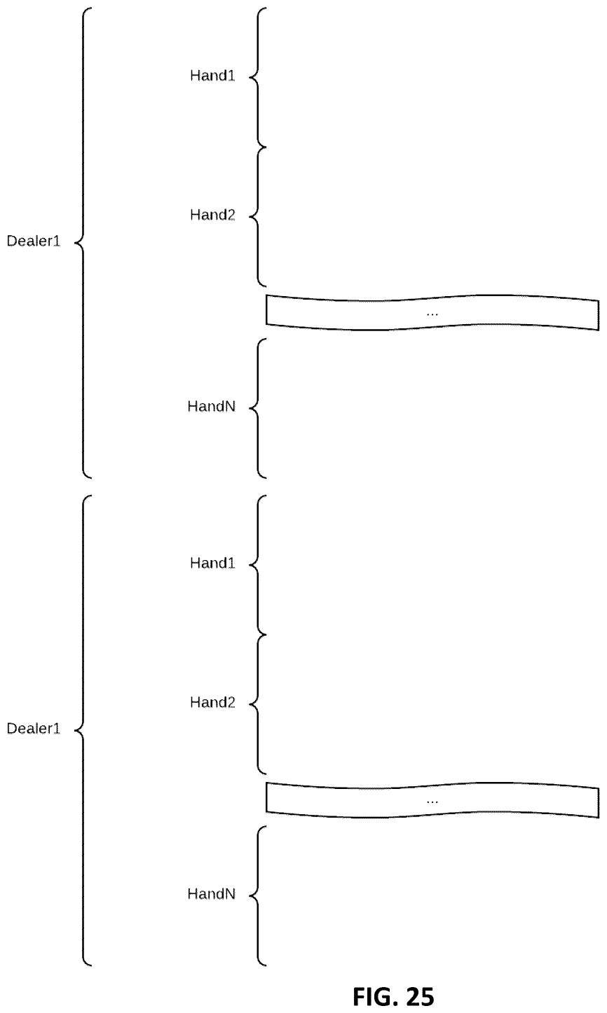

In an embodiment according to FIG. 25, a secondary game may be provided as a multiplayer table game or casino game with the use of an underlying primary game based on HHR. The embodiment of FIG. 25 illustrates an example of a secondary game of blackjack implemented based on an underlying HHR primary game, where multiple players are affected by the same dealer hand in the secondary game by use of a grouping effect applied in the primary game.

For providing a grouping effect, dealer cards are selected in the secondary game corresponding to a deck of events or sets of events in the primary game, for example a race or a set of races for HHR, and/or a scorecard or scorecards of the primary game. This allows for a multiplayer game, for example where all players face the same dealer hand in the secondary game of blackjack. Entries in the deck of races may associate with a specific player's hand, e.g., based on automatic handicapping odds, such that approximate odds of a winning hand may be similar to that in live blackjack.

For more than one player, the deck may be divided into equal sections, such that each player's hand is associated with the specific sections assigned to the player. The sections may be based on consecutive or non-consecutive attributes, or another suitable parameter. In a similar manner, player decisions may be taken into account in the embodiment of FIG. 25, such as by providing a player with the choice of purchasing an additional game which pulls from a subsection of the race set deck for options such as doubling down or splitting in blackjack.

In an alternative embodiment according to FIG. 25, rather than having the underlying deck of events or set of events in the primary game being selected via a software pseudo random number generator, the secondary game may provide an initial card draw and the primary game may utilize the results of this natural (based on the physical probability of a deck of cards) random number generator to select a deck of events or sets of events in the primary game and/or a scorecard corresponding to the card draw. In effect, this allows for this embodiment to be implemented with a “forward” or “backward” association between the cards in the secondary game of blackjack and the deck of events or sets of events in the primary game and/or the scorecard of the primary game.

Although discussed as a “card draw” it should be noted that a card draw may be simulated by a computing device or system, may be provided as a physical card draw, and/or may be simulated by another system or hardware component. In some examples, a random number generator may be provided for conducting the card draw, such as comprised in software executable by a processor of a gaming machine or gaming system. In certain embodiments, a non-software random number generator may be provided, for example comprising one or more of a physical dice roll, a physical ball draw, a physical spinning wheel or reel, a physical roulette wheel, a physical card draw from a physical deck of shuffled cards, an analogue random number generator, or another similar device or system.

In one embodiment of a primary game having multiple players, competition between the players may be facilitated by competition between interim awards for the players' final results, such that only the player that meets the winning criteria, or scorecard, first would win. Determination of which player meets the winning criteria, or scorecard, first may be based on an evaluation of time and/or evaluation of a number of predictions required to meet the winning criteria of the corresponding scorecard. For example, a primary game of HHR may be provided having six players where a variety of interim awards are achieved by the players. However, rather than giving every player a prize for any matching scorecard, only the first player to achieve the interim award and/or the player to achieve the interim award in the lowest number of predictions receives the corresponding payout. As such, in the example of six players, one player has the interim award completed in less predictions than the other players, so that player is awarded the win while the other players are not, even if they also match the scorecard corresponding to the interim award (but in more predictions).

In varying examples of a primary game having multiple players, competition between the players may be facilitated by competition for interim awards of the scorecards available for the players' final results, such that the player that meets the winning criteria, or scorecard, first would receive a larger payout than other players (e.g., other players receive less). As above, determination of which player meets the winning criteria, or scorecard, first may be based on an evaluation of time and/or evaluation of a number of predictions required to meet the winning criteria of the corresponding scorecard. In some embodiments, an interim payout or award corresponding with a particular scorecard may diminish as time or a number of predictions required to match the scorecard increases. The payout may diminish in a static or dynamic manner, such as by predetermined values or percentages, etc. In some examples, competition between players and/or the house may be used so that only the highest value result among the players and/or the house receives a payout.

Competition between interim patterns as described above may be used to facilitate the use of a secondary game with an underlying primary game. For example, by adapting the payouts or awards provided in the underlying primary game to correspond with competition between multiple players in the secondary game.

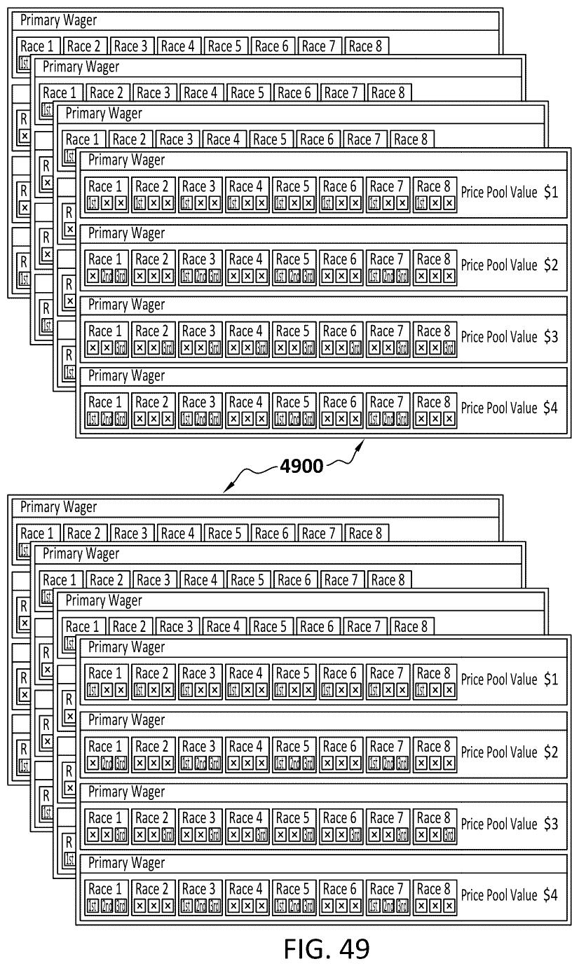

In another example, instead of offering a single wager option in the underlying primary game, a wager made in the underlying primary game may be evaluated by scorecard packs containing multiple scorecards. In this way, mid-game wager options of the secondary game may be represented by a selection of a scorecard from the respective pack. FIG. 49 illustrates an example of scorecard packs 4900, including scorecards one to n. The decks may be built and stored each time a game is made available. A player would play using one or more scorecard at a time through their respective pack, not necessarily in sequential or any other specific order, as they make secondary decisions that correlate to the secondary game.

Embodiments of a primary game using scorecard packs according to FIG. 49 may also be employed to facilitate multi-player games. To allow for multi-player games the system would prepare a group scorecard packs to be used in a session of the table game. For example, a 7-person blackjack implementation would have seven player packs and one dealer pack. Each time the game is made available the decks may be built and stored. For each game, the system may be configured to assess a number of players and select the scorecard packs to be given out based on this assessment, one to each player or a subset of the available packs if not all seats at the table are in play.

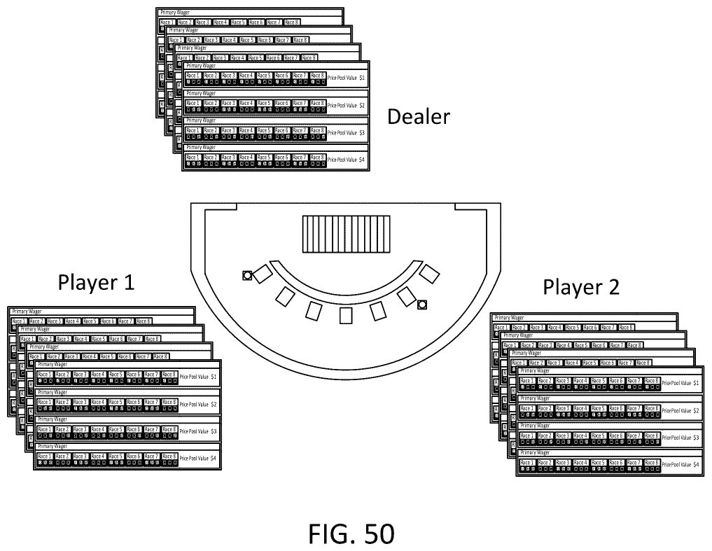

FIG. 50 illustrates an example of a primary game of HHR with scorecard packs underlying a secondary game of blackjack, where a 7-person table is provided with only two seats in play. In the illustrated embodiment, secondary decisions in the secondary game of blackjack are represented in the primary game as decisions to forfeit one or more scorecards and purchase or select one or more new scorecards from within the respective scorecard pack. Not all scorecards in a player's respective scorecard pack are necessarily available for the player to purchase and a scorecard's availability may be a function of the dealer's scorecard set or other determining factors. If the player decides to forfeit their scorecard and purchase or select a new one they will be selecting a different scorecard within their scorecard pack, which scorecard is used is determined by the player's secondary decision as correlates to the table game. Advantageously, this configuration allows an underlying primary game of HHR to replicate or correspond with a secondary game having mid-game decisions or other variable characteristics that are extremely difficult to replicate, such as allowing players in blackjack to surrender as well as allowing for poor choices such as doubling down on 20 in blackjack or other features/decisions in other table games.

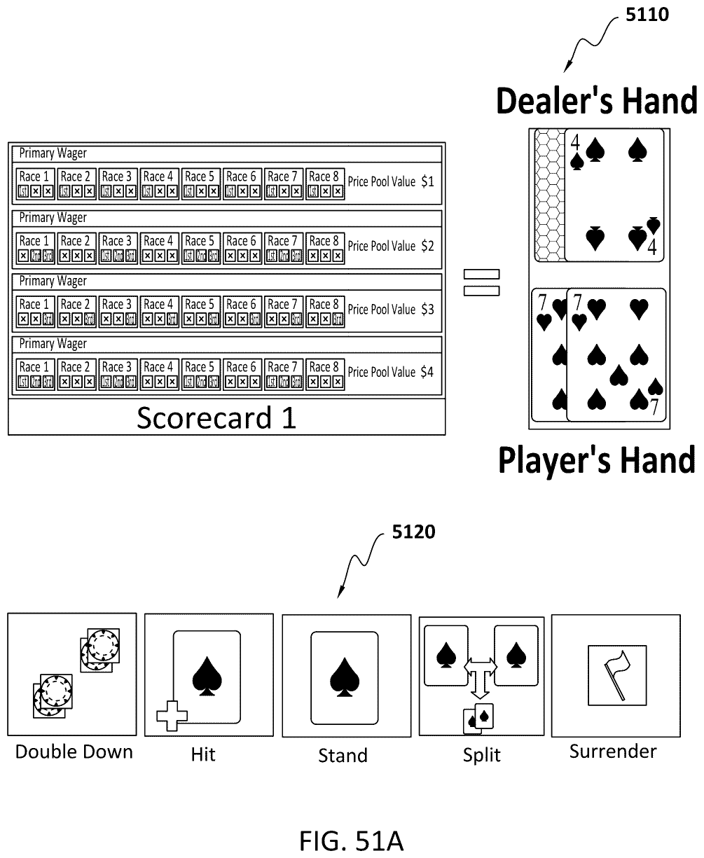

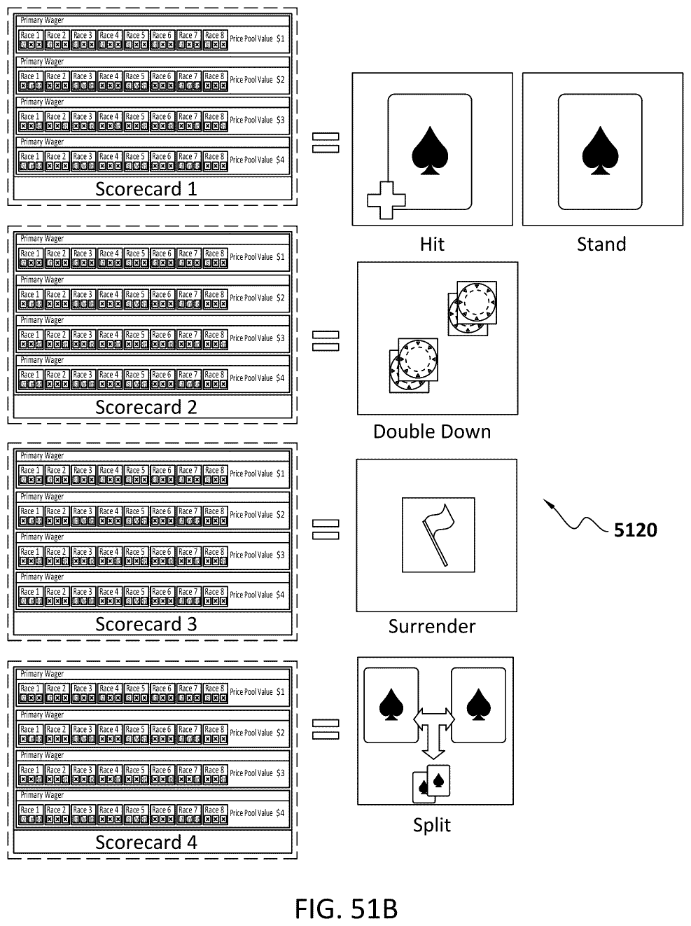

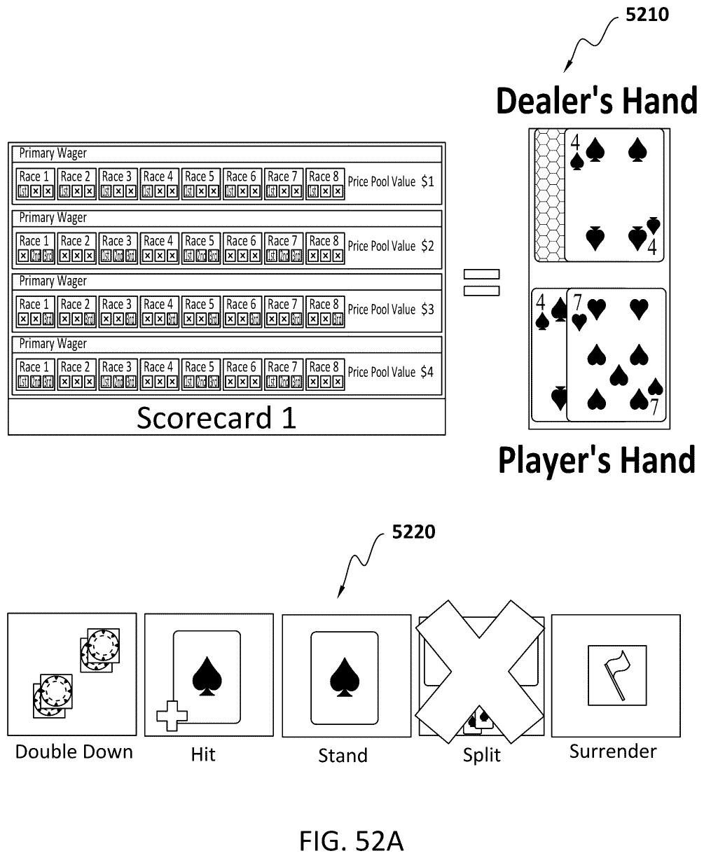

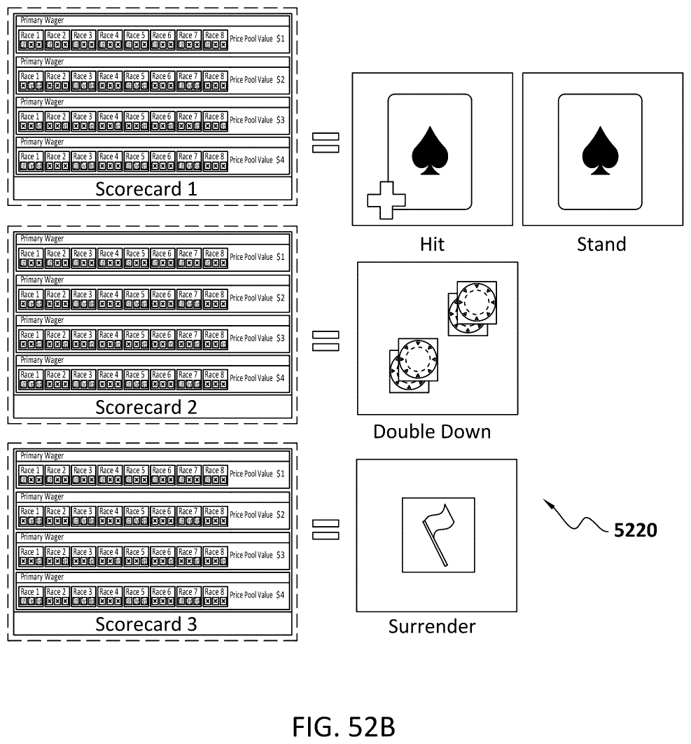

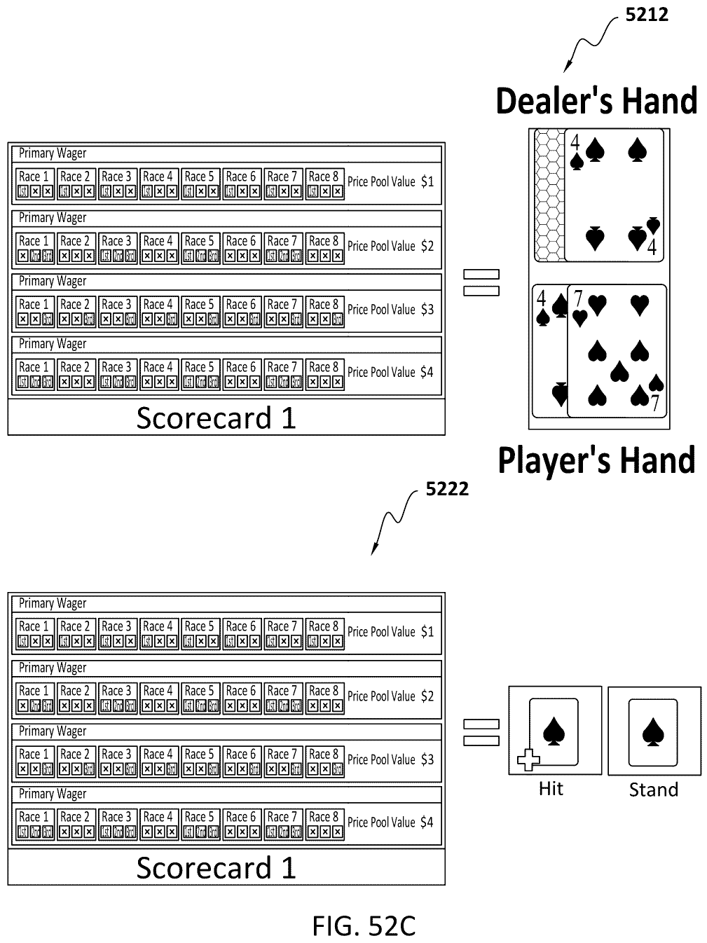

A better understanding of the embodiment of FIG. 50 may be obtained by reference to FIGS. 51A-52C, which represent the actions of the two players in play. FIGS. 51A and 51B illustrate the actions of a first player according to FIG. 50. An initial hand 5110 for a first player in the secondary game of blackjack is shown in FIG. 51A, with scorecard 1 from the first player's scorecard pack representing the initial hand 5110 in the underlying primary game. The first player is provided with a list of available mid-game decisions 5120, shown in FIG. 51A.

For example, for a secondary game of blackjack, the first player receives an initial hand and may select whether to “hit” and receive an additional scorecard, “stay” and proceed with the initial hand as dealt, or “surrender” and receive half of their wagered amount while the house retains the other half. For certain hands, the player may elect to “split” or “double-down”. A “split” may be offered when a player's initial two-card hand includes two cards of the same value, such as the two sevens of the initial hand of FIG. 51A. It gives the player the option of splitting the cards into two separate hands, then receiving an additional card for each hand from the dealer. To split in blackjack, the player must generally place an additional bet on the newly created hand that is equal to the original bet they placed at the start of the game. To “double-down”means the player doubles their bet in the middle of the game and receives only one more card.

According to the embodiment of FIG. 51A, each mid-game decision 5120 may correspond with a different scorecard from the first player's scorecard pack as illustrated in FIG. 51B. In the example of FIGS. 51A and 51B, the first player elects to “surrender” in the secondary game, resulting in or corresponding to a forfeit of scorecard 1 and a purchase or selection of scorecard 3 in the primary game. As there are no more secondary decisions available for the first player, scorecard 3 is evaluated for awards in the primary game and the first player is paid the primary game award amount as the entertaining display of the blackjack secondary game concludes.

FIGS. 52A, 52B and 52C illustrate the actions of a second player according to FIG. 50. An initial hand 5210 for a second player in the secondary game of blackjack is shown in FIG. 52A, with scorecard 1 from the second player's scorecard pack representing the initial hand 5210 in the underlying primary game. The second player is provided with a list of available mid-game decisions 5220 which, in this case, differ from those of the first player due to differences in the second player's initial hand. More specifically, the second player does not have available an option to split, as the second player's initial hand 5210 does not include two cards of the same value.

According to the embodiment of FIG. 52A, each mid-game decision 5220 may correspond with a different scorecard from the second player's scorecard pack as illustrated in FIG. 52B. In the example of FIGS. 52A and 52B, the second player elects to “hit” in the secondary game, resulting in or corresponding to retaining scorecard 1 in the primary game. The second player's hand 5212 is updated as shown in FIG. 52C and the player's options 5222 in the secondary game are now limited to “hit” or “stand”. In this case, the second player elects to “stand” in the secondary game, corresponding to retaining scorecard 1 in the underlying primary game. As there are no more secondary decisions available for the second player, scorecard 1 is evaluated for awards in the primary game and the second player is paid the primary game award amount as the entertaining display of the blackjack secondary game concludes.

In some embodiments, to allow for dealer or table wins, scorecards in the scorecard packs of the primary game may include “key” parts, spots or patterns to allow for all winners or all losers corresponding to a dealer bust or a dealer blackjack result in the secondary game. These “key” parts, spots or patterns may be the same across all scorecards, although variations are possible.

Notably, it is not necessary that the scorecards representing secondary decisions match across different players or scorecard packs. For example, player n's scorecard 2 may correspond to a splitting decision in blackjack while player n+1's scorecard 2 may correspond to a double down decision in blackjack.

The use of scorecard packs with scorecards corresponding to secondary decisions in the secondary game advantageously allow a final result of an underlying primary game to correspond more closely with the variability of secondary games, such as table games and the like, particularly where the secondary games offer complicated secondary decisions. The configuration of the gaming system using scorecard packs to correspond with secondary decisions of secondary games allows for a simple correlation between the primary game and the secondary game, reducing processing requirements of the system while improving gameplay in a manner that increases player engagement and enjoyment.

In varying embodiments, instead of offering a single wager option in the underlying primary game, a wager made in the underlying primary game may be evaluated by event packs containing multiple events for evaluating wagers in the primary game. In such an example, rather than providing the players with scorecard packs, each player may receive an event pack including a plurality of events on which a wager in the primary game may be based. For example, for a primary game of HHR, each player may receive a pack of horse races on which they may place a wager and a predicted final ranking. As such, each wager with one of the events from the event pack may correspond to secondary decisions in the secondary game.

Notably, the disclosed embodiments, while being applicable for adapting a primary game underlying a secondary game wherein the secondary game comprises a traditional table game, are not restricted to application with existing traditional games. For example, additional and new variations on existing table games may be used as a secondary game.

In certain aspects, an award value of a secondary game may be adjusted to allow for larger payouts, to address a difference between a static payout value of a secondary game and a varying pool size or the like of a primary game, or to solve poor player decisions. These adjustments may be realized through the use of a secondary attribute in the secondary game. Such a secondary attribute maybe particularly advantageous in small payout games that include wager options, such as blackjack and baccarat.

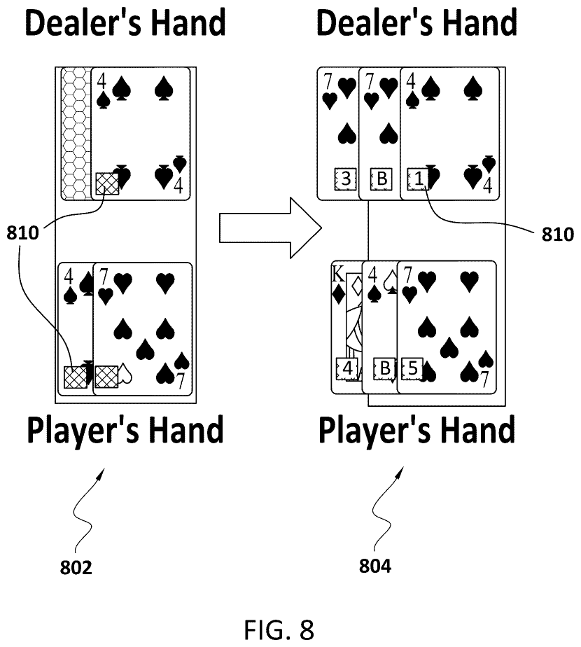

FIG. 8 illustrates a game 800 of blackjack where a secondary attribute 810 has been added to each card of the deck. The secondary attribute 810 according to the embodiment of FIG. 8 corresponds to a “scratcher” subsection that is revealed at the end of the game. According to varying embodiments, secondary attribute 810 may simply indicate whether a bonus game is won, may provide a multiplier value for the wager of the secondary game, or otherwise communicate a wager adjustment that allows the awards of the secondary game to correspond to the awards of the primary game, whether or not the awards of the secondary game are static or flexible.

In the game of FIG. 8, an initial hand 802 of playing cards has provided the player with a four and a seven, for a total value of eleven, while the dealer has a four and the values of the secondary attributes 810 remain obscured or hidden. In this embodiment, the secondary attributes 810 correspond to a plurality of values, where two or more values corresponding to “B” triggers a bonus game.

With a final hand 804 of playing cards in the example of FIG. 8, the player decides to “hit” and receives a king, resulting in a value of twenty-one while the dealer's hand has a value of eighteen. The player's hand corresponds to a two-to-one payout, meaning a bet of five credits would correspond to an award of ten credits (five credit wager plus five credit win). However, the wager result of the underlying primary game may be based on a parimutuel pool that can vary in size, such that the award value from the primary game is different from the award value of the secondary game 800. To address this difference, the secondary attributes 810 are used to reveal a “B” value on the seven of hearts and the four of spades, resulting in two values corresponding to “B” and triggering a bonus game in view of the match.

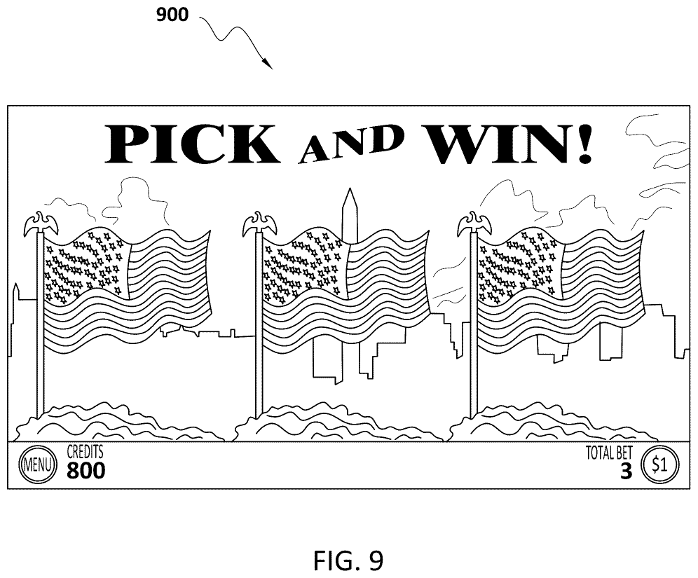

As the payout award of the secondary game 800 is based on the underlying wager in the primary game, the secondary game 800 may be modified to address any discrepancies between the value of the static award table of the secondary game and the pari-mutuel payout of the primary game by providing a bonus game having a flexible award table. The bonus game may comprise any additional game, such as a further blackjack game or a new game, configured to provide a bonus award equal to the difference between the static award and the award of the primary game. In the illustrated example of FIG. 9, a picking game 900 may be provided as a bonus game, where the player picks a part of an entertaining display to reveal a bonus award value or multiplier.

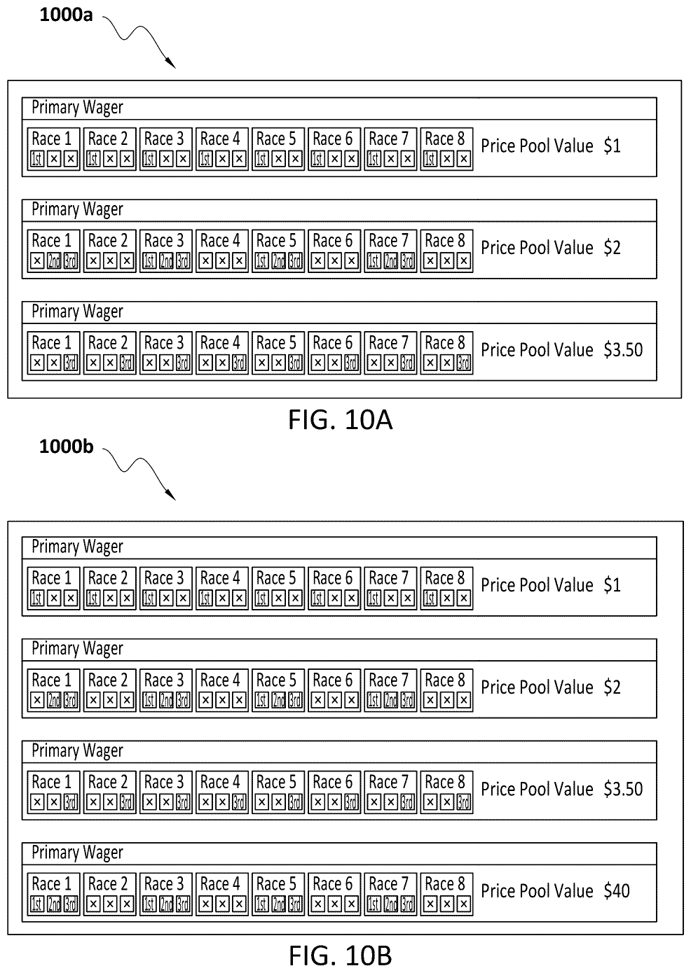

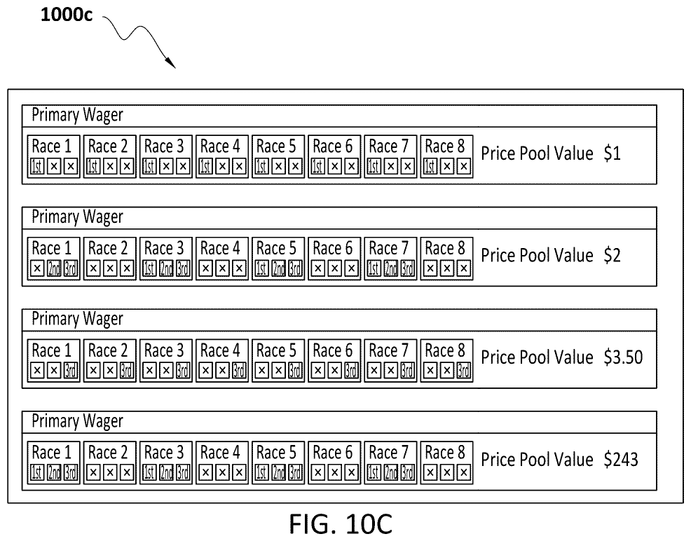

For the secondary game of blackjack, generally the possible awards for a win include a push for ties, two-to-one for wins, and two and a half to one for player blackjack, which could be made to correspond with scorecards of an underlying primary game based on HHR, as shown in the scorecard list 1000a of FIG. 10A. However, as HHR may be based on a parimutuel pool or another varied award table, scorecards may be included where the prize pool value does not correspond to a possible award of the secondary game, such as with the scorecard list 1000b of FIG. 10B. In such cases, the secondary attribute 810 according to FIG. 8 accommodates these larger or varied prize pool values to be reflected in the secondary game 800 by combining the award of the secondary game 800, such as a static or lower award, with a multiplier or bonus game award.

These adjustments can advantageously allow for adjustments in the primary game, such as where a large increase in the pool size can be allocated to the scorecard award values, such as in the scorecard list 1000c of FIG. 10C with a largest prize pool value of $243, which is not an issue to display to the player because of the bonus or multiplier being available to adjust the award for the secondary game.

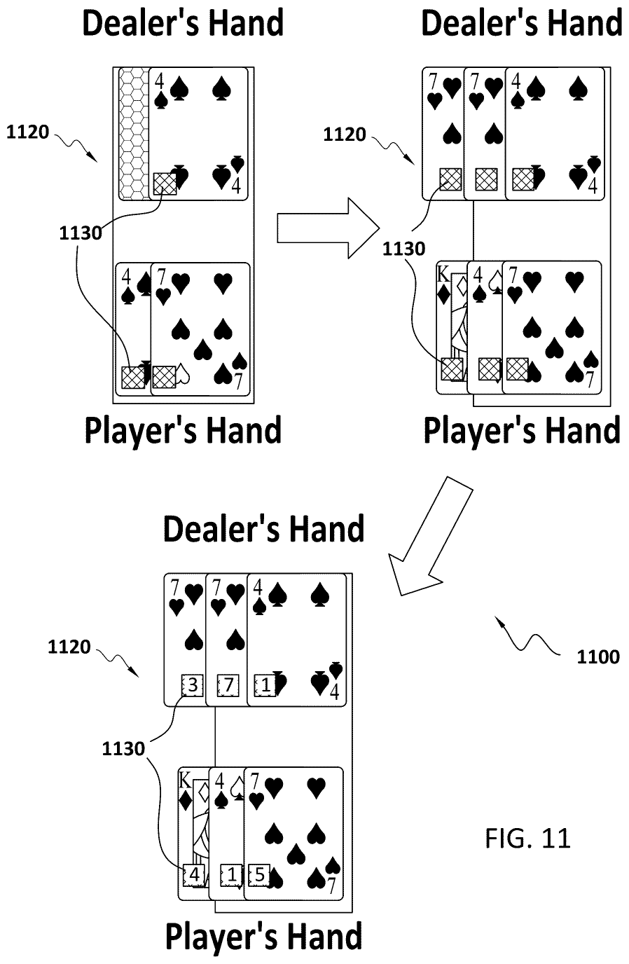

In a similar way, secondary attributes may be provided to account for poor gameplay decisions made by a player in the secondary game, as depicted in FIG. 11. For the game of FIG. 11, the player has won the second scorecard of the primary game according to FIG. 10A-10C with a value of $2 on a $0.50 wager. So, in this case, the secondary game 1100 is configured to provide the player with a winning award of $2. To do so, the secondary game 1100 provides the player an initial hand 1110 with a value of eleven, in the form of a four of spades and seven of hearts, while the dealer holds only a value of four. The best decision for a blackjack player in this circumstance is to “double-down”, meaning the player doubles their bet in the middle of the game and receives only one more card, and the secondary game 1100 is configured to provide a winning result to such a “double-down” bet in order to realize the payout award of $2.

However, the player is allowed to play the secondary game, rather than only observing, meaning that the player can make poor decisions and elect not to “double-down”. With a final hand 1120 of playing cards in the example of FIG. 11, the player decides to “hit” and receives a king, resulting in a value of twenty-one while the dealer's hand has a value of eighteen. The player's hand corresponds to a two-to-one payout, meaning a bet of $0.50 would correspond to an award of $1 which is less than the $2 as in the underlying primary game win. To address this difference, the secondary attributes 1130 are used to reveal values where matching values pay, such that the $1 on the four of spades cards match and the player is awarded an additional $1 for a total win of $2 that matches the underlying primary game. Of course, any variation of a bonus value, a bonus game, a bonus multiplier or the like may be employed, such that the secondary attribute can be used to adjust a secondary game award to match a primary game award value.

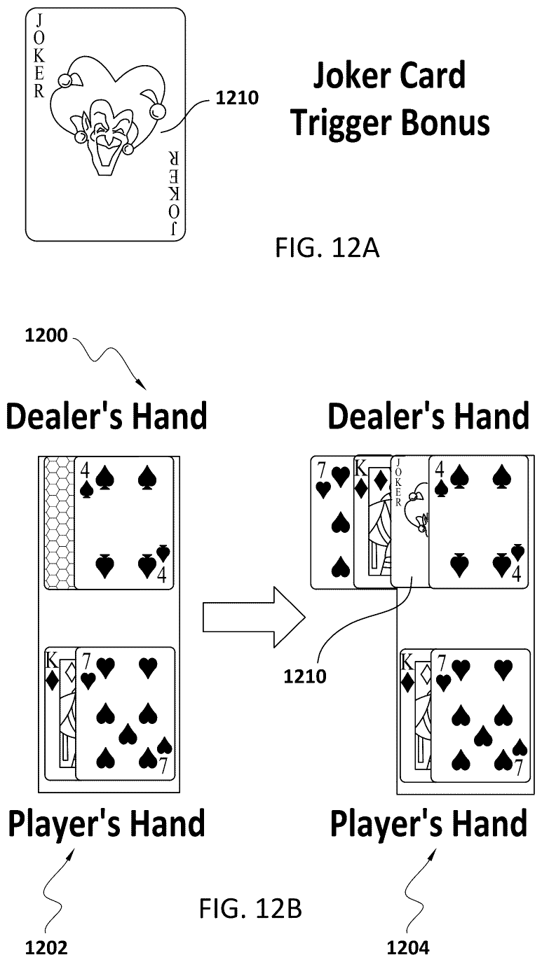

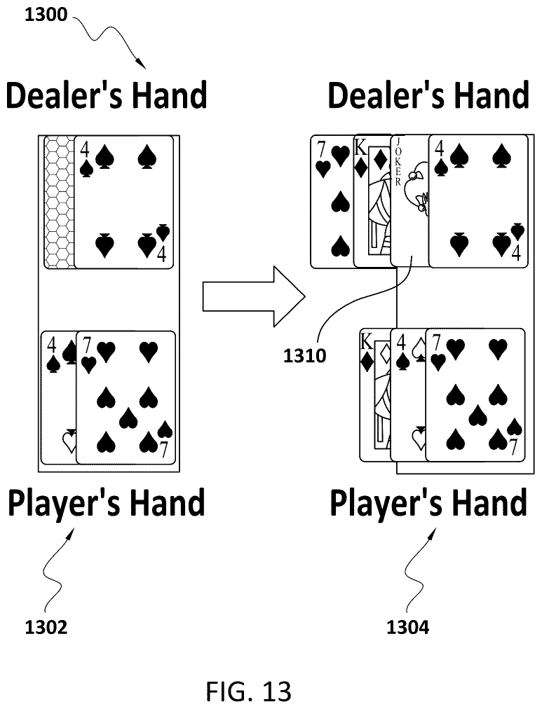

In another embodiment, the secondary game may be adjusted to include a secondary attribute in the form of an additional card in the deck. In the embodiment of FIGS. 12A-12B, the secondary attribute is a joker card 1210. FIG. 12B illustrates a game 1200 of blackjack where a secondary attribute has been added to the deck in the form of a joker card 1210 that may not affect the value of a hand but that triggers a bonus game. According to varying embodiments, secondary attribute may simply indicate whether a bonus game is won, may provide a multiplier value for the wager of the secondary game, or otherwise communicate a wager adjustment that allows the awards of the secondary game to correspond to the awards of the primary game, whether or not the awards of the secondary game are static or flexible.

In the game of FIG. 12B, an initial hand 1202 of playing cards has provided the player with a king and a seven, for a total value of seventeen, while the dealer has a four. With a final hand 1204 of playing cards in the example of FIG. 12B, the player decides to “stay”, resulting in a value of seventeen while the dealer's hand has a value of twenty-one but also includes a joker card 1210. The player has lost the hand, however, the wager result of the underlying primary game in this case is a win. To address this difference, the joker card 1210 has been revealed to trigger a bonus game.

As the payout award of the secondary game 1200 is based on the underlying wager in the primary game, the secondary game 1200 may be modified to address any discrepancies between the value of the static award table of the secondary game and the pari-mutuel payout of the primary game by providing a bonus game having a flexible award table. The bonus game may comprise any additional game, such as a further blackjack game or a new game, configured to provide a bonus award equal to the difference between the static award or loss of the secondary game and the award of the primary game. In the illustrated example of FIG. 9, a picking game 900 may be provided as a bonus game, where the player picks a part of an entertaining display to reveal a bonus award value or multiplier.

As discussed previously, for the secondary game of blackjack the possible awards for a win include a push for ties, two-to-one for wins, and two and a half to one for player blackjack, which could be made to correspond with scorecards of an underlying primary game based on HHR, as shown in the scorecard list 1000a of FIG. 10A. However, as HHR may be based on a parimutuel pool or another varied award table, scorecards may be included where the prize pool value does not correspond to a possible award of the secondary game, such as with the scorecard list 1000b of FIG. 10B. In such cases, the secondary attribute 1210 according to FIGS. 12A-12B accommodates these larger or varied prize pool values to be reflected in the secondary game 1200 by combining the award of the secondary game 1200, such as a static or lower award, with a multiplier or bonus game award.

These adjustments can advantageously allow for adjustments in the primary game, such as where a large increase in the pool size can be allocated to the scorecard award values, such as in the scorecard list 100c of FIG. 10C with a largest prize pool value of $243, which is not an issue to display to the player because of the bonus or multiplier being available to adjust the award for the secondary game.

In a similar way, secondary attributes may be provided to account for poor gameplay decisions made by a player in the secondary game, as depicted in FIG. 13. For the game of FIG. 13, the player has won the second scorecard of the primary game according to FIG. 10A-10C with a value of $2 on a $0.50 wager. So, in this case, the secondary game 1300 is configured to provide the player with a winning award of $2. To do so, the secondary game 1300 provides the player an initial hand 1302 with a value of eleven, in the form of a four of spades and seven of hearts, while the dealer holds only a value of four. The best decision for a blackjack player in this circumstance is to “double-down”, meaning the player doubles their bet in the middle of the game and receives only one more card, and the secondary game 1300 is configured to provide a winning result to such a “double-down” bet in order to realize the payout award of $2.

However, the player is allowed to play the secondary game, rather than only observing, meaning that the player can make poor decisions and elect not to “double-down”. With a final hand 1304 of playing cards in the example of FIG. 13, the player decides to “hit” and receives a king, resulting in a value of twenty-one while the dealer's hand also has a value of twenty-one. The resulting tie corresponds to a “push” payout, meaning a bet of $0.50 would correspond to an award of $0.50 which is less than the $2 as in the underlying primary game win. To address this difference, a joker card 1310 was used to trigger a bonus game to award the additional $1.50 for a total win of $2 corresponding to the underlying primary game. Of course, any variation of a bonus value, a bonus game, a bonus multiplier or the like may be employed, such that the secondary attribute can be used to adjust a secondary game award to match a primary game award value.

By breaking the reward value of the wager into more than one secondary game, a correspondence between the payout of the wager and the simulated payouts may be provided. For example, where a player's wager was successful based on the predicted final outcome and/or predicted ranking of the participants in the one or more events a secondary game of blackjack may be provided so that the simulated result of the secondary game cumulatively corresponds to the wager result. Due to the static nature of awards in table games, such as blackjack, an added flexible award table may be used to handle an effect of variation in player pool size on an underlying pari-mutuel payout characteristic of HHR games. The awards of the extra game may be progressive values, static or a mix of progressive and static. In certain embodiments, the awards may all be static but the number of awards available may be varied to correlate the payouts of the secondary games and the primary game. The secondary game thereby provides an advantageous variability and entertainment for the player, while maintaining a simplified and streamlined underlying gaming mechanism based on one or more selected events.

In an embodiment, a secondary game of blackjack may be provided having a static award table while the primary game includes a pari-mutuel payout structure that varies based on player pool size, etc. As the payout award of the secondary game is based on the underlying wager in the primary game, the secondary game may be modified to address any discrepancies between the value of the static award table of the secondary game and the pari-mutuel payout of the primary game by including a bonus game having a flexible award table. The bonus game may comprise any additional game, such as a further roulette game or a new game, configured to provide a bonus award equal to the difference between the static award and the award of the primary game.

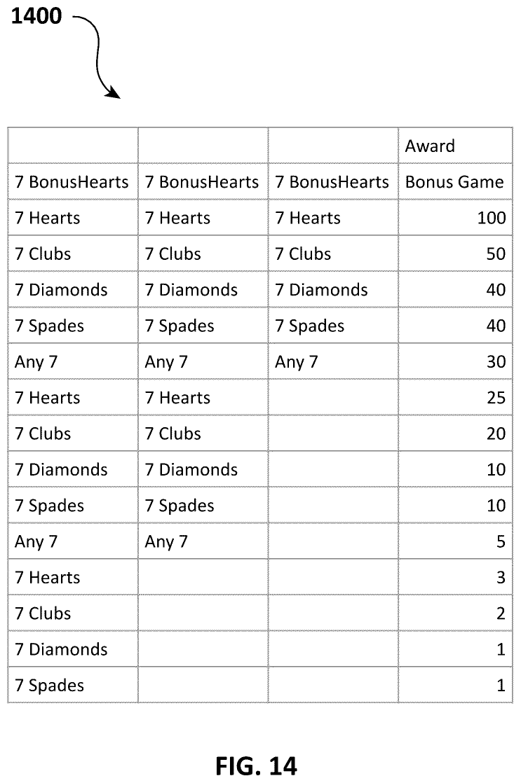

In one example, the bonus game may be provided as an additional Lucky 7 style side bet extra game 1400 offered to players before the initial deal of cards is made, according to FIG. 14. The extra game 1400 may be presented before the initial deal of cards is made and may pay based on how many sevens are visible in the betting players hand and in the dealers hand on the initial deal. Additional hits during the blackjack game may not add to the number of sevens. Additional expansion of the available paylines can be made possible by including suits and/or creating new suits, for example the bonus-hearts suit of FIG. 14.

It should be noted that the use of the number seven may be adjusted to include any other card value, or even a secondary attribute according to other embodiments described herein.

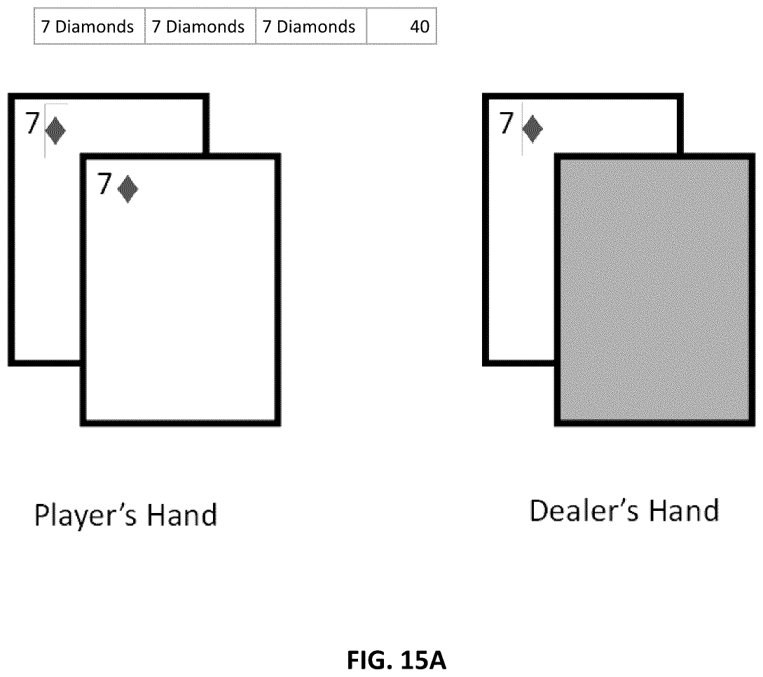

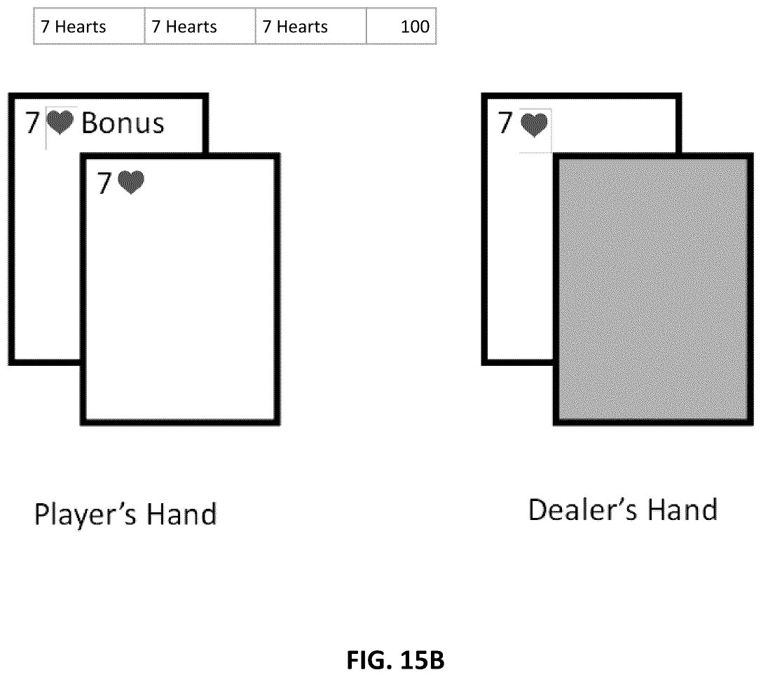

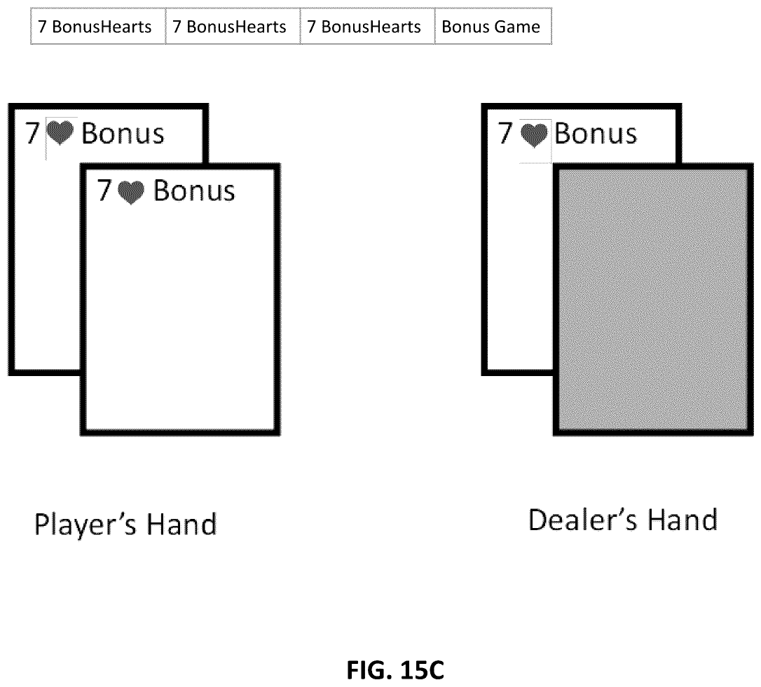

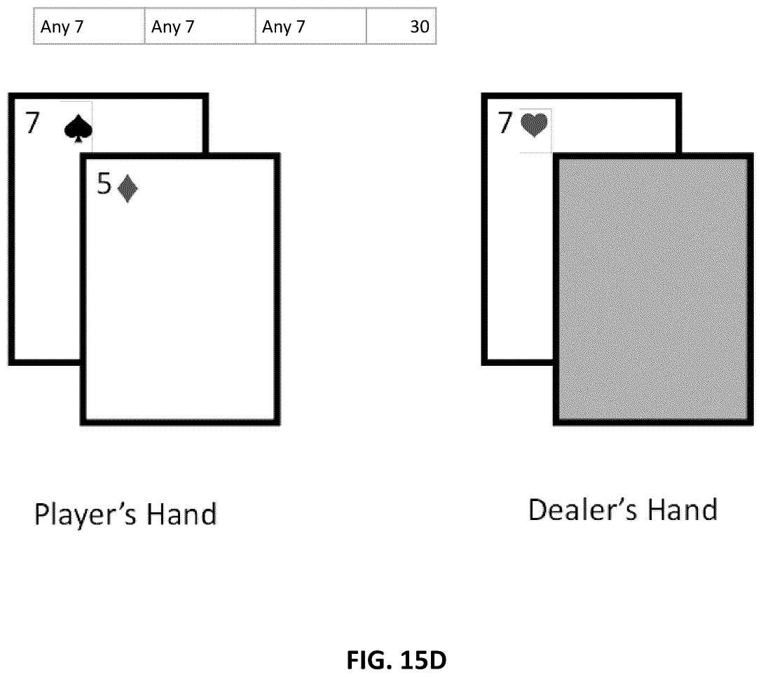

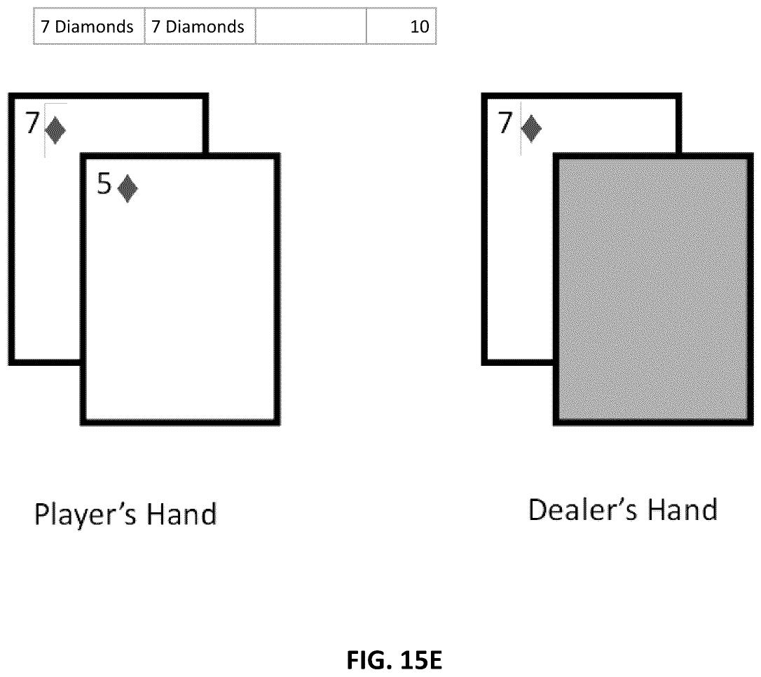

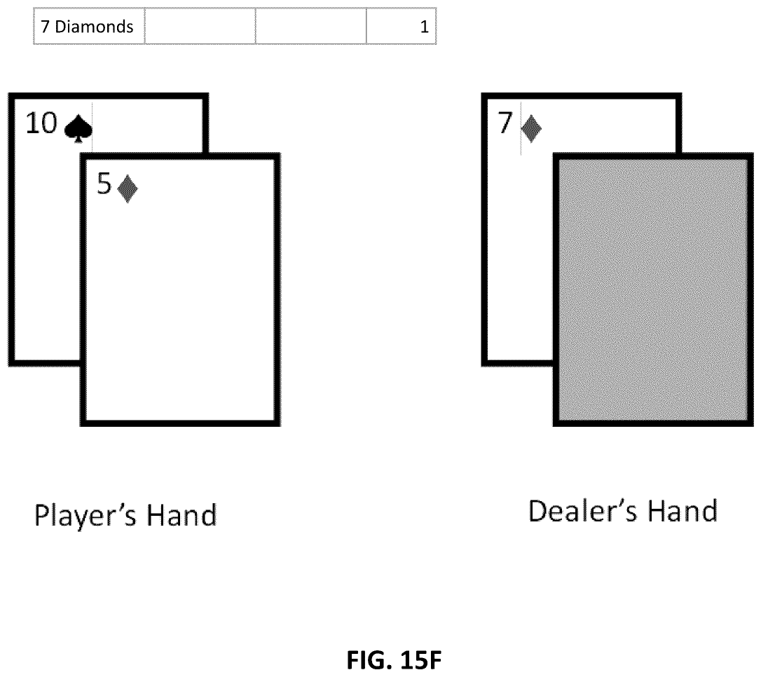

According to the illustrated example of FIG. 14, the extra game 1400 includes a flexible award table that can have prize awards that may be static value awards, progressive value awards, bonus game triggering awards, and/or some combination of static value awards, progressive value awards, and bonus game triggering awards. In like manner, the number of awards available may be static or may be progressively varied based on the value of the parimutuel pool in the underlying primary game. FIGS. 15A-15F depict examples of winning hands and corresponding paylines according to the extra game 1400 of FIG. 14.

The bonus game may comprise any additional game, such as a further blackjack game or a new game, configured to provide a bonus award equal to the difference between the static award or loss of the secondary game and the award of the primary game. In the illustrated example of FIG. 9, a picking game 900 may be provided as a bonus game, where the player picks a part of an entertaining display to reveal a bonus award value or multiplier.

As with previous embodiments, the win value of the extra game 1400 would be configured to correspond with the scorecards or award value of the underlying primary game. In this manner, the wager result of the secondary game, including the blackjack game and the bonus Lucky 7 style game 1400, may correspond to the wager result or scorecard of the primary game, such as an HHR game, which may be shown in another window, part of the entertaining display, or only used in a game engine. This is realized even though the secondary game of blackjack generally requires static award values and the primary game may include parimutuel awards that vary based on player counts and the like, due to the Lucky 7 style game 1400 providing the difference between the award values.

It should be noted that various modifications and alternative arrangements of the extra game 1400 are possible without departing from the principles of the illustrated embodiment. For example, the table layout, card values, payouts, or other attributes may be adjusted, or another game may be provided in place of a Lucky 7 style game 1400.

Similarly, in an alternative embodiment, the Lucky 7 style game 1400 may be played concurrently with the secondary game. In this example, a single wager made in a primary game may correspond to a package of blackjack hands and corresponding wagers for a secondary game of blackjack, for example five games, ten games, or any other number of games. Each blackjack game may then provide a wager result, such as with static award values, while the Lucky 7 style game 1400 is progressively updated for example by matching with only the initial card of the dealer in each game or another arrangement. Of course, the cumulative results of the secondary game including the blackjack game and the Lucky 7 style game 1400 are controlled to correspond to the result of the primary game.

The Lucky 7 style game 1400 being presented as an extension of the secondary game increases player engagement and enjoyment, by providing the player with increasingly varied and exciting gameplay based on a primary game wager, such as HHR. Advantageously, the use of the secondary game including a bonus game as described allows the player to enjoy playing a secondary game even where the awards corresponding to the secondary game are static, such as with a table game or more specifically in the example of FIGS. 15A-15F a blackjack game, and the awards for the primary game are parimutuel or otherwise varied.

In another embodiment, a secondary game of blackjack may be provided having a static award table while the primary game includes a pari-mutuel payout structure that varies based on player pool size, etc. As the payout award of the secondary game is based on the underlying wager in the primary game, the secondary game may be modified to address any discrepancies between the value of the static award table of the secondary game and the pari-mutuel payout of the primary game by including an additional poker hand award table and corresponding side bet. These additional award presentations provide players with an additional way to win a larger prize than is traditionally won during a game of blackjack.

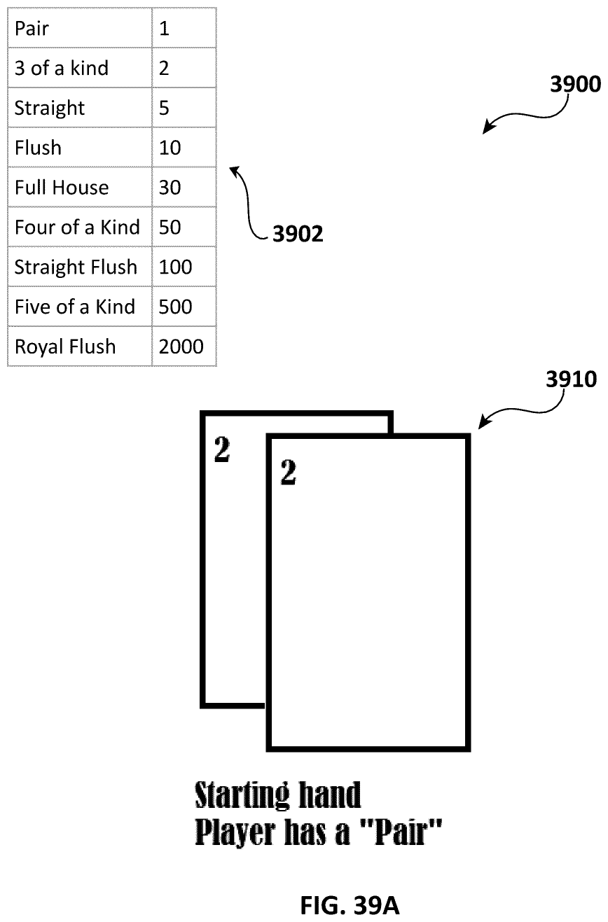

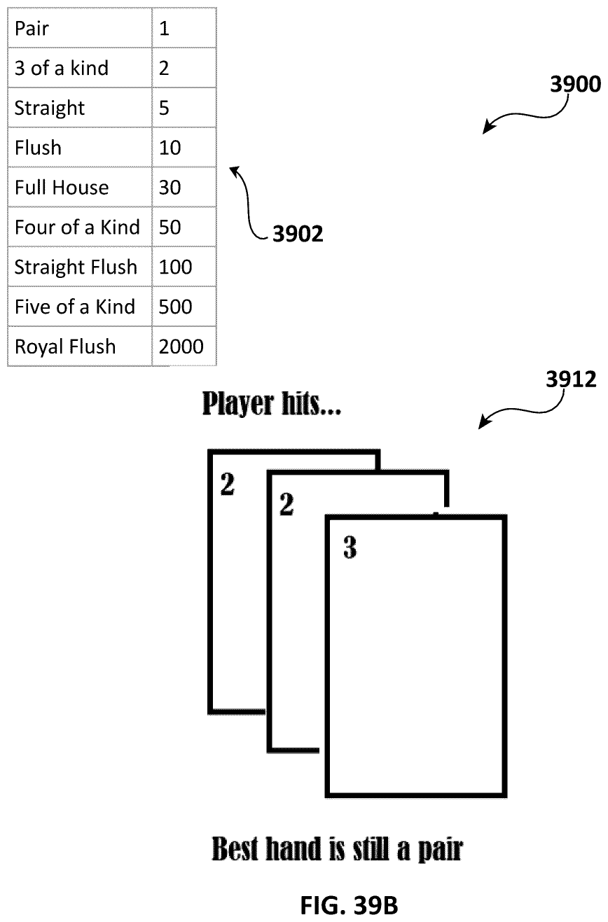

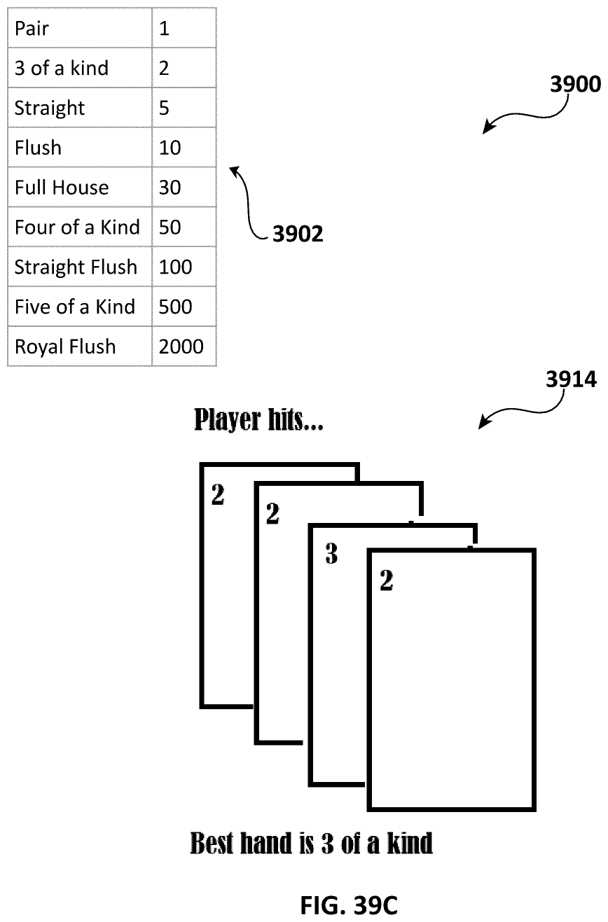

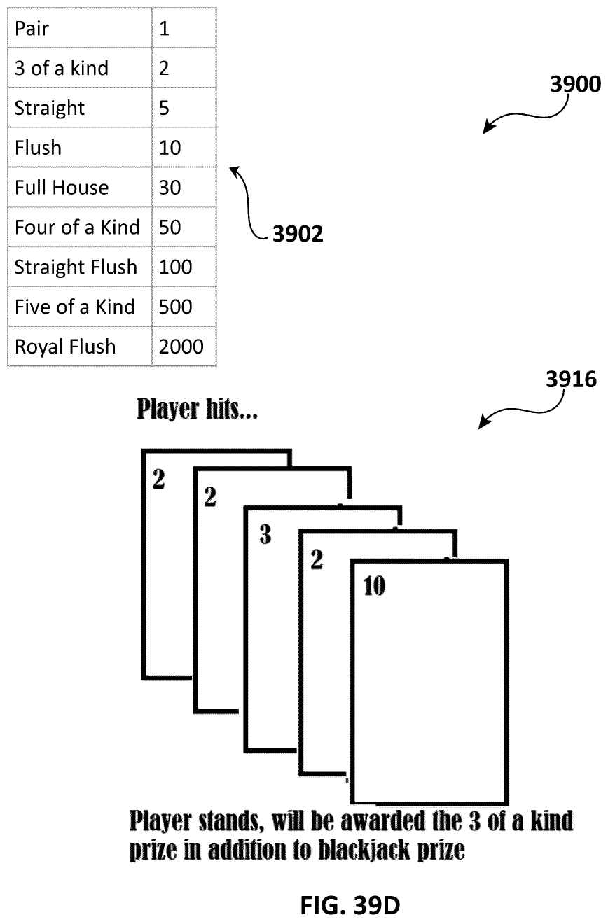

In the illustrated example of FIG. 39A, an additional poker hand award table 3902 is available to players prior to an initial deal of player cards in a secondary game of blackjack 3900 and a final presentation of a card flip is configured to allow for bonus triggers. Notably, the additional poker hand table 3902 is applicable starting with two cards in the initial deal of cards to the player's hand 3910. According to the initial hand 3910 shown in FIG. 39A, the player has a “Pair” based on the pair of twos in the initial hand 3910 and may already qualify for the corresponding award in the additional poker hand award table 3902.

As a player keeps playing and hitting during the secondary game of blackjack 3900, their cards will be constantly reevaluated with respect to the additional poker hand table 3902 to determine the best poker hand that could be formed from their cards. As such, additional hits during the secondary game of blackjack may add to the award value for the wager of the secondary game 3900. Additional expansion of the award table 3902 can be made possible by including suits and/or creating new secondary attributes for the cards.

FIG. 39B, FIG. 39C and FIG. 39D illustrate the continuation of the secondary game 3900 according to FIG. 39A. In FIG. 39B the player hits and receives an additional card to their hand 3912, the additional card being a three such that the best hand is still a pair. In FIG. 39C, the player hits again and receives an additional card to their hand 3914. In this case the additional card is another two, meaning that the best poker hand from the additional poker hand table 3902 for the player's hand 3914 is now three of a kind. According to FIG. 39D, the player again elects to hit and receives another card. Here, the player's final hand 3916 qualifies for the three of a kind prize from the additional poker hand table 3902 in addition to the blackjack prize. In this case, the player elects to stand in the secondary game 3900 of blackjack based on the player's hand 3916 totaling nineteen, and the secondary game 3900 ends with the player receiving both the three of a kind prize from the additional poker hand table 3902 in addition to the blackjack prize, the total value corresponding to a value of a wager in an underlying primary game, such as an HHR wager.

It should be noted that the use of the additional poker hand table 3902 may be adjusted to include any other card values, or even a secondary attribute according to other embodiments described herein. As such, the additional poker hand table may be replaced with another secondary award table based on another characteristic, feature, and/or result of the secondary game. The secondary game may therefore include a flexible award table that can have prize awards that may be static value awards, progressive value awards, bonus game triggering awards, and/or some combination of static value awards, progressive value awards, and bonus game triggering awards. In like manner, the number of awards available may be static or may be progressively varied based on the value of the parimutuel pool in the underlying primary game. The awards may be provided as credits or another value, as multiplier values, bonus triggers, etc.

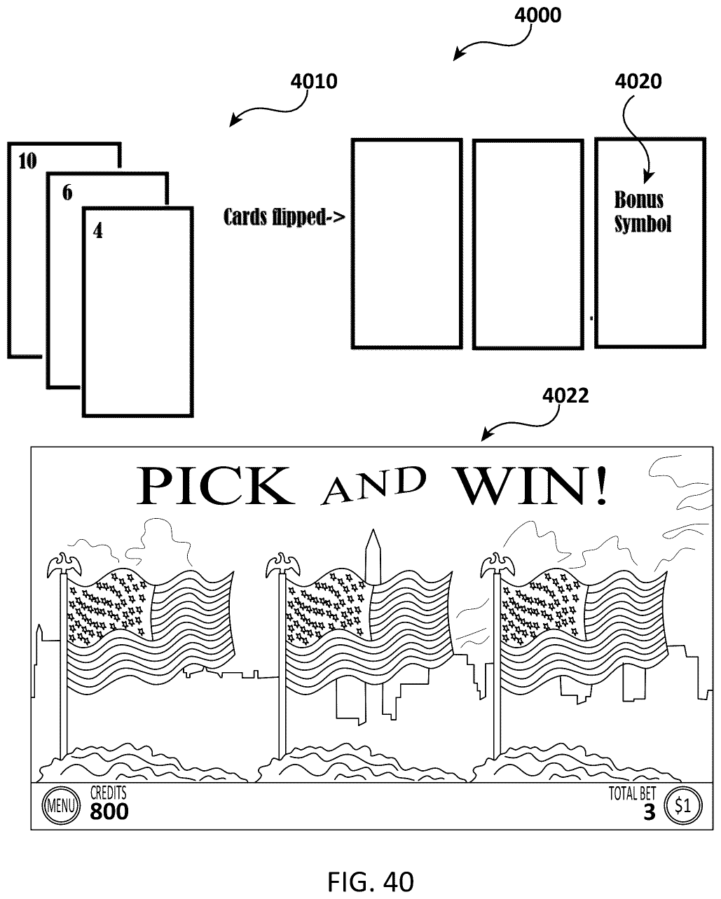

In an embodiment according to FIG. 40, in combination with or separate from the embodiment of FIG. 39A-39D, when a secondary game of blackjack 4000 ends without a win or a value of a win of the secondary game still needs to be increased to reach a value of a wager in an underlying primary game, the cards of the player's hand 4010 may be flipped over to their opposite sides to reveal the presence or absence of a secondary attribute 4020. For example, if at least one cards contains a “Bonus” symbol then a bonus game 4022 will be awarded. The bonus game may comprise any additional game, such as a further blackjack game or a new game, configured to provide a bonus award equal to the difference between the award of the secondary game and the award of the underlying primary game. In the illustrated example of FIG. 40, a picking game may be provided as a bonus game 4022, where the player picks a part of an entertaining display to reveal a bonus award value or multiplier.

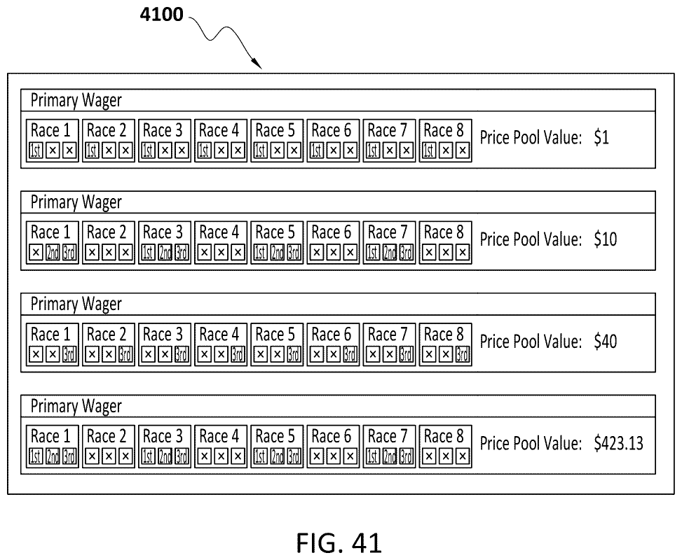

As with previous embodiments, the win value of the bonus game 4022 would be configured to correspond with the scorecards 4100 or award value of the underlying primary game, as shown in FIG. 41. In this manner, the wager result of the secondary game, including the blackjack game and the additional poker hand table, may correspond to the wager result or scorecard 4100 of the primary game, such as an HHR game, which may be shown in another window, part of the entertaining display, or only used in a game engine. This is realized even though the secondary game of blackjack generally requires static award values and the primary game may include parimutuel awards that vary based on player counts and the like, due to the additional award table and/or bonus game providing the difference between the award values.

The additional poker hand award table or bonus game being presented as an extension of the secondary game increases player engagement and enjoyment, by providing the player with increasingly varied and exciting gameplay based on a primary game wager, such as HHR. Advantageously, the use of the secondary game including an additional poker hand award table or bonus game as described allows the player to enjoy playing a secondary game even where the awards corresponding to the secondary game do not directly correspond with the value of the underlying primary game, such as with a table game or more specifically in the example of FIGS. 39A-39D a blackjack game, and the awards for the primary game are parimutuel or otherwise varied.

In certain embodiments, a secondary game and an underlying primary game may be configured to allow multiple players to play in a corresponding or related manner.

### C. Baccarat

In another aspect according to the embodiment of FIG. 4C, the gaming machine may employ a multitude of award sets and/or events, where player input in the secondary game 420 determines which of the multitude of award sets and/or events to use for gameplay. Each of the multitude of award sets may correspond to different payouts, betting options, locations, odds, or other wager characteristics. Likewise, each of the events may correspond to different event conditions or characteristics, such as racetracks, competitors, trainers, field size, weather, date, etc. For example, in the game of Baccarat the player has three betting options: player win, tie, and banker win, which may each be correlated with an award set. Accordingly, a bet placed on player win may correspond to a payout where pick six pays 550 with field sizes of 6-10, a bet placed on a tie may correspond to a payout where pick 7 pays 950 with field sizes of 7-10, and a bet placed on the banker may correspond to a payout where pick 6 pays 500 with field sizes of 6-9. In varying embodiments, the player may be allowed to wager at more than one of the multitude of award sets, such as placing a bet on both a player win and a tie.

The use of a multitude of award sets advantageously provides a methodology for realizing complex betting characteristics of table games using an HHR primary game. As many casino table games allow players to choose from a variety of bets with independent or comingled award structures while HHR games are generally predicated on a singular award set, the embodiments of the current disclosure expand the available gameplay options for HHR in an entertaining and stimulating manner, such that the entertaining gameplay of table games may be provided in a secondary game corresponding to an underlying HHR primary game.

In a varying example of the method of FIG. 4A, each pay table/scorecard entry of the primary game is associated with a bet option of the secondary game of baccarat. For example, using baccarat as a secondary game, the betting options may be provided as:

```
<scorecard value=“0011000001110101001000” winner=“”>
  <winIndexes>
    <banker id=“1”/>
    <bankerTie id=“2”/>
    <tie id=“3” />
    <player id=“4” />
    <playerTie id=“2” />
  </winIndexes>
</scorecard>
```

As such, if a player was to select betting options for both a banker win and a tie, the resulting pay table could be visualized as:

```
<scorecard value=“0011000001110101001000” winner=“Banker ”>
  <winIndexes>
    <banker id=“1”/>
  </winIndexes>
</scorecard>
<scorecard value=“1011000001110101001000” winner=“Tie ”>
  <winIndexes>
    <bankerTie id=“2”/>
    <tie id=“3” />
  </winIndexes>
</scorecard>
```

In this way, the player's actions in the secondary game have a direct effect on a result of the underlying primary game, while advantageously maintaining the primary game as the source of the wager and the wager result.

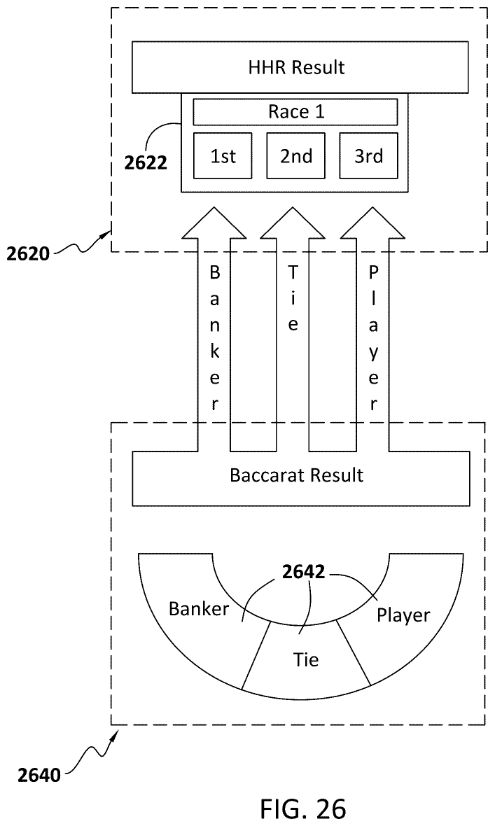

In another aspect, embodiments may be provided where specific spots on each scorecard of an HHR primary game 2620 may correspond to a particular result of a table game. A secondary game of baccarat 2640 may be considered an illustrative example according to FIG. 26. In the game of baccarat, the player has three betting options 2642: player win, tie, and banker win, which may each be correlated with specific spots of a scorecard 2622 in an underlying HHR primary game 2620.

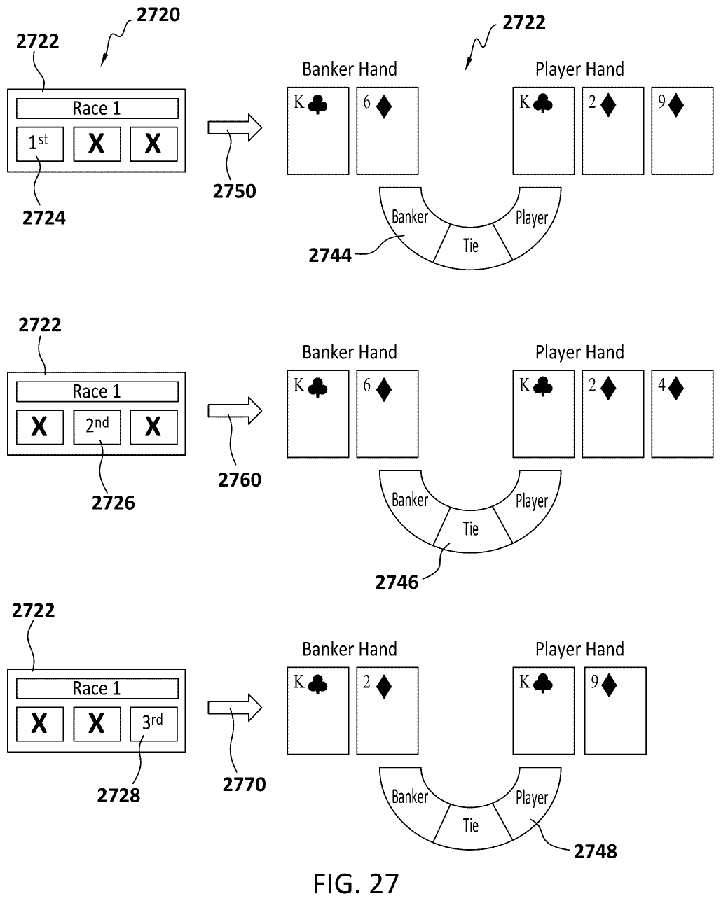

As shown in the specific examples of FIG. 27, each possible result of the secondary game 2740 of baccarat may be associated with a scorecard result of the HHR primary game 2720. As such, in the case 2750 of correct selection of the first-place finisher 2724 in the scorecard 2722 of the primary game, an associated banker win 2744 may result in the secondary game 2740 of baccarat. In the case 2760 of correct selection of the second-place finisher 2726 in the scorecard 2722 of the primary game, an associated tie 2746 may result in the secondary game 2740 of baccarat. In the case 2770 of correct selection of the third-place finisher 2728 in the scorecard 2722 of the primary game, an associated player win 2748 may result in the secondary game 2740 of baccarat. Accordingly, the result displayed in the secondary game 2740 of baccarat may be based on the scorecard result of the primary game, where specific spots on the scorecard are translated into table game results for a secondary game, such as a secondary game of baccarat.

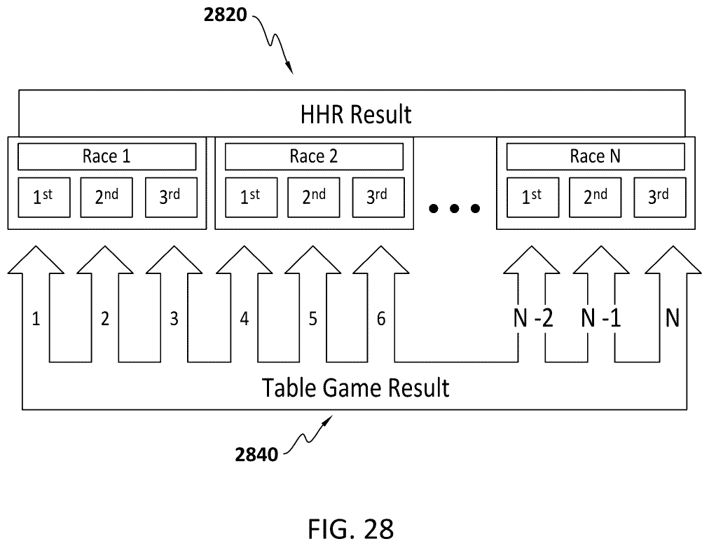

In varying embodiments, a relationship between a scorecard of a primary game 2820 and possible results in a secondary game 2840 may be provided in a one-to-one relationship, as shown in FIG. 28. For example, for a scorecard with a first, second, and third place finisher possible for each race, each race may be associated with a game of baccarat or additional side-bets may be added corresponding to additional races. In further examples, the secondary game may be provided as a table game having more than three possible outcomes, such that a number of races or events used in an underlying primary game may be correlated with the possible results in a secondary game.

For example, applying the above embodiment to a secondary game of roulette, a first race may be associated with a color of a final position of a roulette ball (e.g., 1^{st} race position=black, 2^{nd} race position=red, 3rd race position=green), a second race may be associated with an even/odd condition of the final position of the roulette ball (e.g., 1^{st} race position=even, 2^{nd} race position=odd, 3^{rd} race position=green), and additional races may be associated with additional results of the roulette game (e.g., 1 to 18/19 to 36, 7/8 position, 1^{st} 12/2^{nd} 12/3^{rd} 12, 9/10/11 position, etc.).

### D. Craps

For a secondary game of craps, the gaming machine may present the player with a pair of dice and a plurality of betting options based on the predicted result of a roll of the dice. Craps players may make line bets and the payout odds for each type of bet may be based on its probability.

In an embodiment of the current disclosure where craps is provided as a secondary game, the player may place a bet through an input device of the gaming machine. The processor may then identify the payout odds of the player's bet and auto-fill a predicted final outcome and/or predicted ranking of one or more selected events in order to match the payout odds of the player's bet and the odds of a successful wager in the predicted final outcome and/or predicted final ranking. The predicted final outcome and/or predicted final ranking may then be compared to the actual final outcome and/or final ranking and a wager result derived therefrom. The craps game may then be led to a wager outcome matching the wager result.

For the craps game, a bet odds table may be provided as follows:

| | True | Odds | House | Single or | | |
|---|---|---|---|---|---|---|
| Bet | Odds | Paid | Edge | Multi Roll | Win | Lose |
| Pass/Come | 251:244 | 1:1 | 1.41% | Multi | Come out roll: | Come out roll: |
| | | | | | 7, 11. | 2, 3, 12. |
| | | | | | Once the point | Once the point |
| | | | | | is established: | is established: 7 |
| | | | | | the point | |
| | | | | | number (one of: | |
| | | | | | 4, 5, 6, 8, 9, 10) | |
| Don't Pass/ | 976:949 | 1:1 | 1.36% | Multi | Come out roll: | Come out roll: |
| Don't Come (Bar- | | | | | 2, 3 | 7, 11. |
| 12 or Bar-2) | | | | | Tie: 12 | Once the point |
| | | | | | (depending on | is established: |
| | | | | | Bar) | the point |
| | | | | | Once the point | number (one of: |
| | | | | | is established: 7 | 4, 5, 6, 8, 9, 10) |
| Pass Odds/ | Same as | 2:1 on 4, 10; | 0% | Multi | Once the point | Once the point |
| Come Odds | paid | 3:2 on 5, 9; | | | is established: | is established: 7 |
| | | 6:5 on 6, 8 | | | the point | |
| | | | | | number (one of: | |
| | | | | | 4, 5, 6, 8, 9, 10) | |
| Don't Pass Odds/ | Same as | 1:2 against | 0% | Multi | Once the point | Once the point |
| Don't Come Odds | paid | 4, 10; | | | is established: 7 | is established: |
| | | 2:3 against | | | | the point |
| | | 5, 9; | | | | number (one of: |
| | | 5:6 against | | | | 4, 5, 6, 8, 9, 10) |
| | | 6, 8 | | | | |
| Yo (11) | 17:1 | 15:1 | 11.11% | Single | 11 | Any other number |
| 3 | 17:1 | 15:1 | 11.11% | Single | 3 | Any other number |
| 2 | 35:1 | 30:1 | 13.89% | Single | 2 | Any other number |
| 12 | 35:1 | 30:1 | 13.89% | Single | 12 | Any other number |
| Hi-Lo (2 or 12) | 17:1 | 15:1 | 11.11% | Single | 2 or 12 | Any other number |
| Craps (2, 3, or 12) | 8:1 | 7:1 | 11.11% | Single | 2, 3, 12 | Any other number |
| C & E (the | 5:1 | 3:1 on | 11.11% | Single | 2, 3, 11, 12 | Any other number |
| combined bet) | | 2, 3, 12; | | | | |
| | | 7:1 on 11 | | | | |
| Any 7 | 5:1 | 4:1 | 16.67% | Single | 7 | Any other number |
| Field | 5:4 | 1:1 on | 5.56% | Single | 2, 3, 4, 9, 10, 11, 12 | Any other number |
| | | 3, 4, 9, 10, 11; | (2.78% if 12 | | | |
| | | 2:1 on 2, 12 | pays 3:1) | | | |
| Horn (the | 5:1 | 27:4 on | 12.5% | Single | 2, 3, 11, 12 | Any other number |
| combined bet) | | 2, 12; | | | | |
| | | 3:1 on 3, 11 | | | | |
| Whirl/World (the | 2:1 | 26:5 on | 13.33% | Single | 2, 3, 7, 11, 12 | Any other number |
| combined bet) | | 2, 12; | | | | |
| | | 11:5 on | | | | |
| | | 3, 11; | | | | |
| | | 0:1 (push) | | | | |
| | | on 7 | | | | |
| Hard 4/Hard 10 | 8:1 | 7:1 | 11.11% | Multi | 4/10 as a pair | 7, 4/10 as a |
| | | | | | (2-2/5-5) | non-pair (1- |
| | | | | | | 3/4-6) |
| Hard 6/Hard 8 | 10:1 | 9:1 | 9.09% | Multi | 6/8 as a pair (3- | 7, 6/8 as a |
| | | | | | 3/4-4) | non-pair (1-5, |
| | | | | | | 2-4/2-6, 3-5) |
| Big 6/Big 8 | 6:5 | 1:1 | 9.09% | Multi | 6/8 | 7 |
| Place 4/Place 10 | 2:1 | 9:5 | 6.67% | Multi | 4/10 | 7 |
| Place 5/Place 9 | 3:2 | 7:5 | 4% | Multi | 5/9 | 7 |
| Place 6/Place 8 | 6:5 | 7:6 | 1.52% | Multi | 6/8 | 7 |
| Buy 4/Buy 10 | 2:1 | 2:1 −5% of | 4.76% | Multi | 4/10 | 7 |
| | | intended | (1.67% if | | | |
| | | bet | commission | | | |
| | | | taken only | | | |
| | | | on win) | | | |
| Buy 5/Buy 9 | 3:2 | 3:2 −5% of | 4.76% | Multi | 5/9 | 7 |
| | | intended | (1.96% if | | | |
| | | bet | commission | | | |
| | | | taken only | | | |
| | | | on win) | | | |
| Buy 6/Buy 8 | 6:5 | 6:5 −5% of | 4.76% | Multi | 6/8 | 7 |
| | | intended | (2.22% if | | | |
| | | bet | commission | | | |
| | | | taken only | | | |
| | | | on win) | | | |
| Lay 4/Lay 10 | 1:2 | 1:2 −5% of | 2.44% | Multi | 7 | 4/10 |
| | | intended | (1.67% if | | | |
| | | win | commission | | | |
| | | | taken only | | | |
| | | | on win) | | | |
| Lay 5/Lay 9 | 2:3 | 2:3 −5% of | 3.23% | Multi | 7 | 5/9 |
| | | intended | (2% if | | | |
| | | win | commission | | | |
| | | | taken only | | | |
| | | | on win) | | | |
| Lay 6/Lay 8 | 5:6 | 5:6 −5% | 4.00% | Multi | 7 | 6/8 |
| | | intended | (2.27% if | | | |
| | | win | commission | | | |
| | | | taken only | | | |
| | | | on win) | | | |

### E. Keno

For a secondary game of keno, the gaming machine may present the player with a card including a plurality of numbered spots (commonly eighty spots) and an award table based on the predicted result of a ball call. Keno players select a predetermined number of spots and receive a payout based on how many of the selected spots match the ball call, commonly referred to as “hits”. The payout odds may be based on the probability of a certain number of hits, reflecting the number of spots, the predetermined number of selected spots, and/or the number of balls called.

In an embodiment of the current disclosure where keno is provided as a secondary game, the player may place a bet through an input device of the gaming machine. The processor may then identify the payout odds of the player's bet and auto-fill a predicted final outcome and/or predicted ranking of one or more selected events in order to match the payout odds of the player's bet and the odds of a successful wager in the predicted final outcome and/or predicted final ranking. The predicted final outcome and/or predicted final ranking may then be compared to the actual final outcome and/or final ranking and a wager result derived therefrom. The keno game may then be led to a wager outcome matching the wager result, such as by controlling the ball call of the game.

The secondary game may correspond to an auto-select or auto-fill option, wherein the processor automatically creates a predicted final outcome and/or predicted final ranking based on the players selected betting option, action and/or predictions in the secondary game. In certain examples, the processor may be configured to match odds or other parameters of predicted results of the secondary game to automatic selection of a predicted final outcome and/or predicted final ranking for participants in the one or more selected events having the same or similar odds of occurring. As such, the player may be able to play a secondary game in a manner that is reflected in a corresponding wager, such as by having the same odds or possible payout.

A predetermined data filter according to the current disclosure may be arranged for selecting one or more events according to the specific odds, possible odds, and the like for a corresponding secondary game. Starting from raw HHR data, or other event data, a series of filters may be applied in a predetermined sequence to efficiently create sets of event data for a given secondary game or related odds, probabilities, and possible actions or strategies. In certain embodiments, the odds associated with the secondary game may be responsive to player input.

Some game types may have a set payout structure, such that a direct correspondence between the payout of the wager and a simulated payout of the secondary game may not exist. By breaking the reward value of the wager into more than one secondary game, a correspondence between the payout of the wager and the simulated payouts may be provided.

For example, where a player's wager was successful based on the predicted final outcome and/or predicted ranking of the participants in the one or more events a secondary game of keno may be provided and the player may be permitted to select a predetermined number of spots, whether simultaneously or iteratively, so that the simulated result of the secondary game cumulatively corresponds to the wager result. Due to the static nature of awards in table games, such as keno, an added flexible award table may be used to handle an effect of variation in player pool size on an underlying pari-mutuel payout characteristic of HHR games. The awards of the extra game may be progressive values, static or a mix of progressive and static. In certain embodiments, the awards may all be static but the number of awards available may be varied to correlate the payouts of the secondary games and the primary game. The secondary game thereby provides an advantageous variability and entertainment for the player, while maintaining a simplified and streamlined underlying gaming mechanism based on one or more selected events.

In an embodiment, a secondary game of keno may be provided having a static award table while the primary game includes a pari-mutuel payout structure that varies based on player pool size, etc. As the payout award of the secondary game is based on the underlying wager in the primary game, the secondary game may be modified to address any discrepancies between the value of the static award table of the secondary game and the pari-mutuel payout of the primary game by including a bonus game having a flexible award table. The bonus game may comprise any additional game, such as a further keno game or a new game, configured to provide a bonus award equal to the difference between the static award and the award of the primary game.

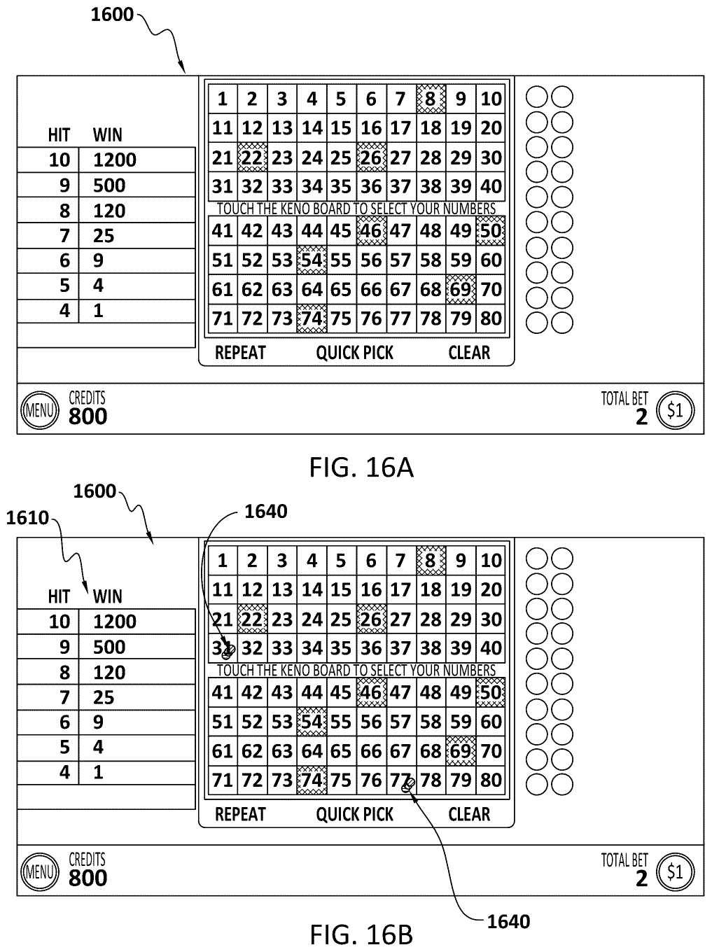

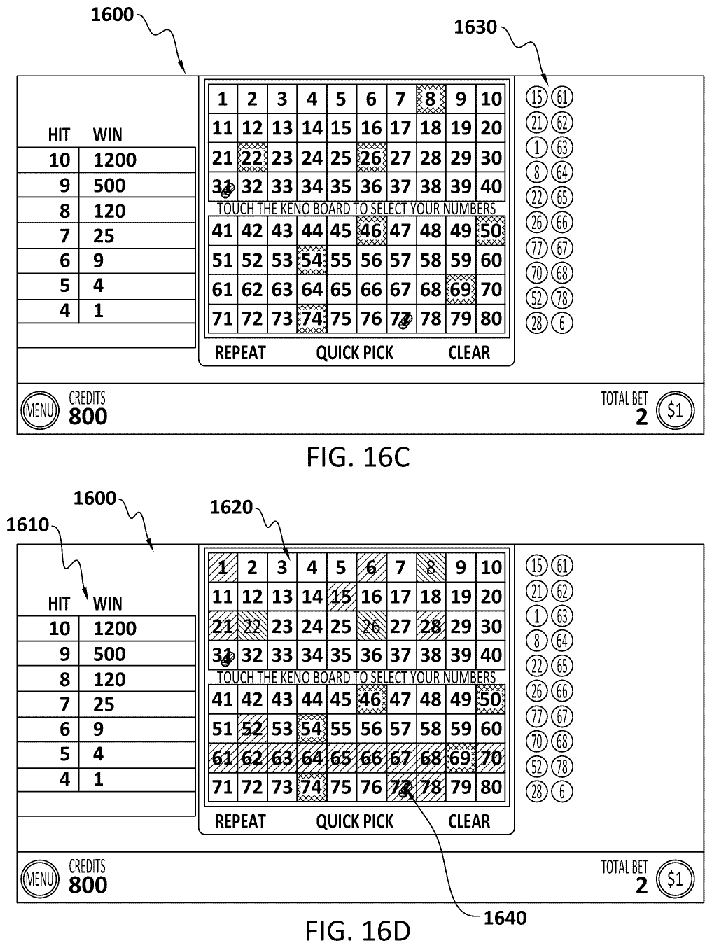

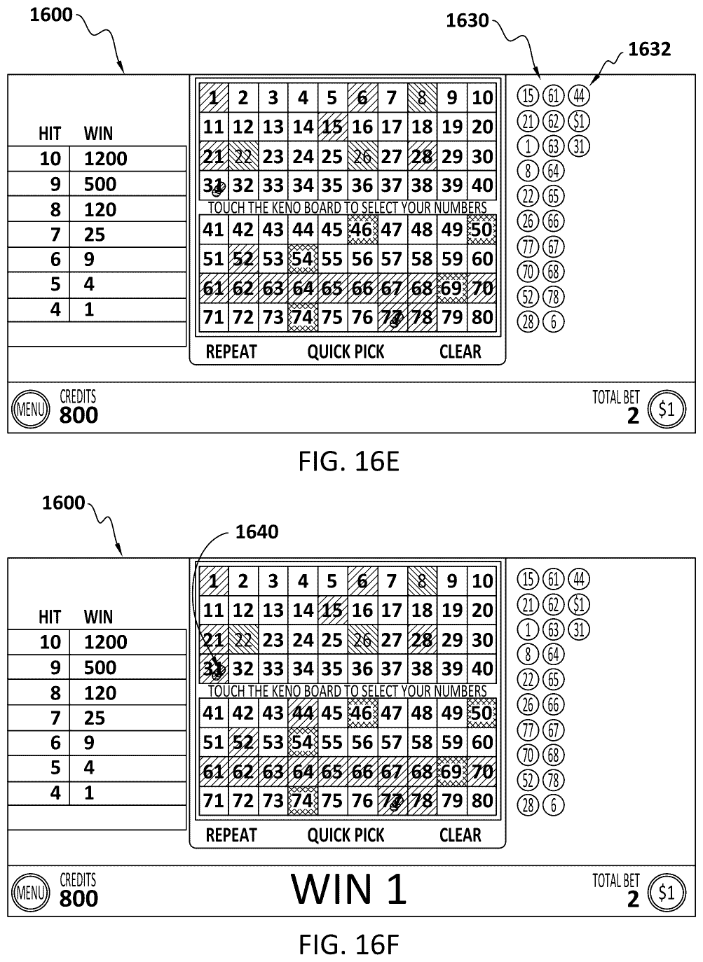

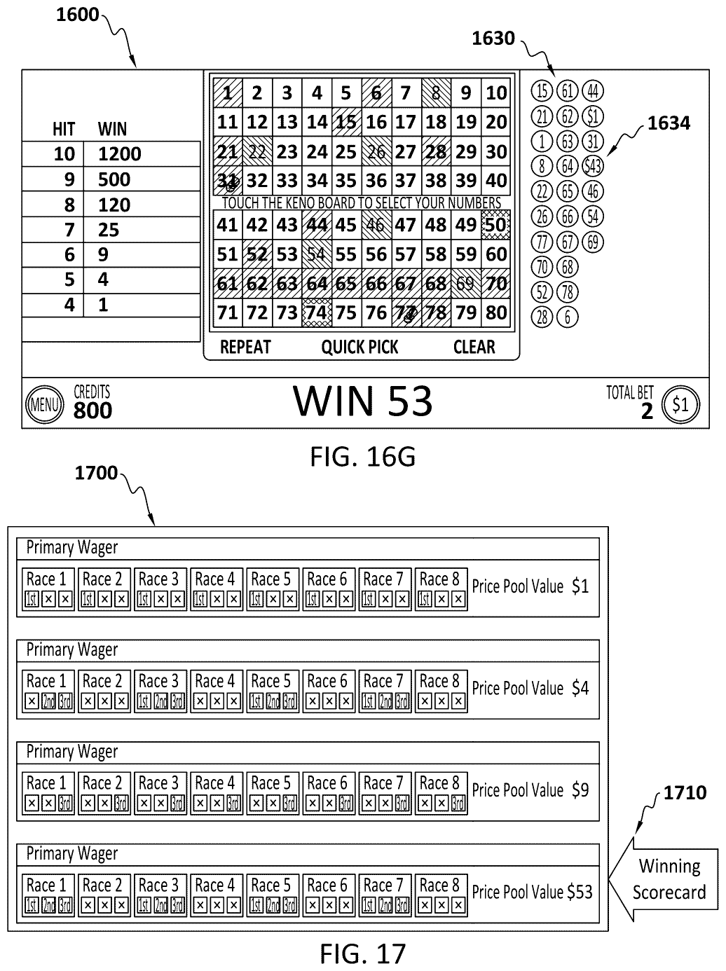

In an embodiment according to FIGS. 16A-17, rather than a bonus game that is separate or separate but related to or dependent on the secondary game, a bonus game or flexible award table may be directly integrated into the gameplay of the secondary game as a secondary aspect of the secondary game. In this way, as the payout award of the secondary game is based on the underlying wager in the primary game, the secondary game may be modified to address any discrepancies between the value of the static award table of the secondary game and the pari-mutuel payout of the primary game by including a bonus game having a flexible award table.

As shown in FIG. 16A, a keno game 1600 may be provided as a secondary game. In the secondary game 1600, a player may select a bet option corresponding to the secondary game. For example, where the secondary game is keno 1600, the player may select a plurality of spots or numbers based on their predictions of a corresponding ball call. The result of the secondary game 1600 may be associated with a corresponding pay table or scorecard list 1700 for the primary game, as shown in FIG. 17. For the illustrated embodiment of FIGS. 16A-16G, the winning scorecard 1710 of the primary game is shown in FIG. 17, with a prize pool value of $53 or 53 credits or another denomination of value.

As can be seen in FIG. 6A, the keno game 1600 includes a static pay table 1610 without a value matching the prize pool value of the winning scorecard 1710. To address this discrepancy, the keno game 1600 according to the disclosed embodiment of FIGS. 16A-16G includes secondary attributes for modifying the award value of the keno game 1600 to reflect the award value of the underlying primary game.

In the initial gameplay of FIG. 16A, the player has selected their marked spots, with values of 8, 22, 26, 46, 50, 54, 69, and 74 in the illustrated example. Next, a secondary attribute is added to spots in the game in the form of a stack of balls symbol 1640, as shown in FIG. 16B. The stack of balls symbol 1640 may be added to any number of spots and may be added randomly or in a predetermined fashion, and in certain embodiments may be placed by the player. When a spot corresponding to the location of a stack of balls symbol 1640 is a “hit” spot matching the ball call in the keno draw, the player gets extra balls in the keno draw. To allow for maximum flexibility, the extra balls may be provided as extra traditional hits on the keno board and/or credit values and/or bonus triggers. In the depicted embodiment of FIG. 16B, the stack of balls symbol 1640 is added to spots 31 and 77.

FIG. 16C shows the keno game 1600 after a ball call 1630 occurs, in this example twenty balls are included in an original ball call or draw. With the illustrated result, the hit spots may be marked on the keno card 1620 as shown in FIG. 16D. At this point, the result of the secondary game 1600 corresponds to a loss with no payout, based on there being only three matched spots or hits for the player, as there is no pay line in the pay table 1610 corresponding to three hits. However, spot 77 including the stack of balls symbol 1640 has matched the ball call, meaning that three extra balls 1632 are now drawn or otherwise added to the ball call 1630, which is illustrated in FIG. 16E.

As indicated previously, the extra balls 1632 may be provided as extra traditional hits on the keno board and/or credit values and/or bonus triggers, and in this case three extra balls 1632 are provided corresponding with a direct $1 credit and two more traditional hits at numbers 31 and 44. The additional spots are marked and the $1 credit shown in FIG. 16F, while the player's number of hits remains at three and do not result in an additional payout from the award table.

Notably, the number of extra balls provided by a hit on a stack of balls symbol 1640 may be configurable, and provided any number of extra balls as needed or desired to adjust the result of the secondary game to match the underlying primary game. For example, given that the number 31 including a stack of balls symbol 1640 is hit in FIG. 16F, in this case four extra balls 1634 are awarded according to FIG. 16G.

As above, the extra balls 1634 may be provided as extra traditional hits on the keno board and/or credit values and/or bonus triggers, and in this case four extra balls 1634 are provided corresponding with a direct $43 credit and three more traditional hits at numbers 46, 54 and 69. The additional spots are marked in FIG. 16G, with three more hits for the player resulting in a total of six hits and a payout from the award table of $9. Taken with the direct $1 credit and $43 credit from the extra balls, the total win for the keno game 1600 has a value of $53 credits, matching the winning scorecard 1710 of the underlying primary game according to FIG. 17.

In this way, the embodiment of FIGS. 16A-16G includes a flexible award directly in the secondary game 1600 using secondary attributes in the form of a stack of balls symbol 1640 and extra balls 1632, 1634. Accordingly, the wager result of the secondary game 1600 can be flexibly adjusted to correspond to a primary game wager result where the scorecard won in the primary game corresponds to a prize pool value of fifty-three credits, or any other value as may be required due to the variability of the prize value of the primary game and/or a mismatch between the payouts of the primary game and the secondary game. Of course, the bonus symbols and/or ball symbols, extra balls, etc. may be adjusted as needed to correspond to variations in the prize pool values, while the award system of the secondary game 1600 may appear to remain static. Other embodiments may be configured to include one or more of the same or different secondary attributes, such as in the form of a multiplier ball that multiplies a win value based on a corresponding value of the multiplier ball, a “wild” ball forming part of an initial ball call or an extra ball call that provides a free hit for the player, a direct credit bonus or bonus game being added to a spot on the keno card (such as in the form of a bonus symbol) for triggering a bonus credit or bonus game, or the like.

Several variations to the embodiment of FIGS. 16A-16G are contemplated, including colors assigned to the balls in the ball call corresponding to a bonus value, bonus game, or extra balls, adding a multiplier value directly to an original ball in the secondary game, and/or informing the player of a multiplier value for certain spots of the keno card before the game starts. In each case, the wager result of the secondary game is controlled to correspond to the wager result of the primary game, allowing the player to enjoy playing a secondary game even where the awards corresponding to the secondary game are static, such as with a table game or more specifically in the example of FIGS. 16A-16G a keno game, and the awards for the primary game are pari-mutuel or otherwise varied. These variations in the secondary game increase player engagement and enjoyment, by providing the player with increasingly varied and exciting gameplay based on a primary game wager, such as HHR.

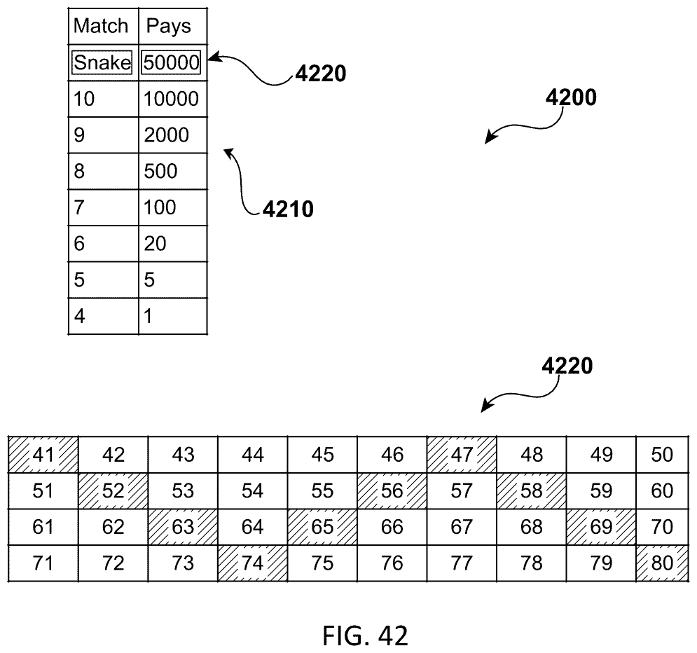

In an embodiment according to FIG. 42, a secondary game of keno is provided having an award table that adds one or more patterns to allow for more than standard match awards. For a standard game of keno, the player may be presented with a card including a plurality of numbered spots (commonly eighty spots) and an award table based on the predicted result of a ball call. Keno players select a predetermined number of spots and receive a payout based on how many of the selected spots match the ball call, commonly referred to as “hits”. The payout odds may be based on the probability of a certain number of hits, reflecting the number of spots, the predetermined number of selected spots, and/or the number of balls called. However, traditional award values for keno may not match award values of an underlying primary game, such as based on HHR.

In the embodiment of FIG. 42, keno is provided as a secondary game where a modified award table may be directly integrated into the gameplay of the secondary game, the modified award table allowing a secondary aspect of the secondary game to modify a payout award of the secondary game. As the payout award of the secondary game is based on the underlying wager in the primary game, the secondary game may be modified to address any discrepancies between the value of the traditional or conventional award table of the secondary game and the pari-mutuel payout of the primary game by including a modified award table.

As shown in FIG. 42, a keno game 4200 is provided as a secondary game including a pay table 4210 with an award value for a number of matches or hits between player predictions and a ball call. However, in contrast to conventional games of keno, the secondary game 4200 of FIG. 42 includes a modified pay table 4210 that allows for more than the standard match awards by adding secondary attributes or side bets in the form of patterns on the keno card, for modifying the award value of the keno game 4200 to reflect the award value of the underlying primary game.

For the illustrated embodiment of FIG. 42, the pay table 4210 includes an award corresponding to an additional pattern 4220 in the form of a “snake” pattern. As an additional pattern 4220, the snake pattern may correspond to a ball call including numbers 41, 52, 63, 74, 65, 56, 47, 58, 69, 80, as shown in FIG. 42, but any additional pattern may be used according to the preferred parameters or presentation. In the embodiment of FIG. 42, when the player's matches include the additional pattern 4220, a player may receive an award for both a number of matches achieved and/or an award for the additional pattern 4220.

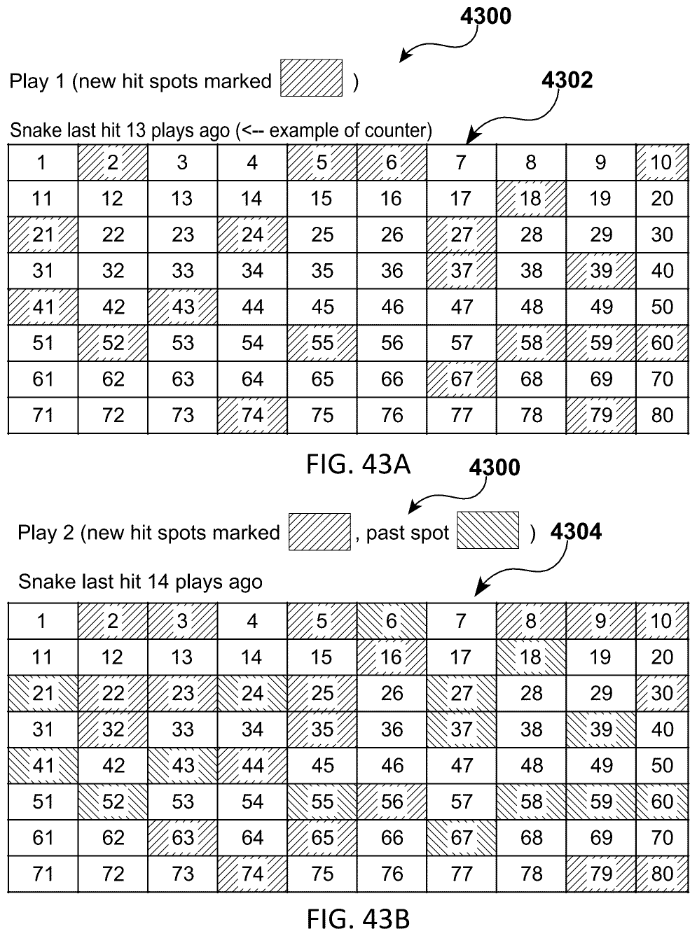

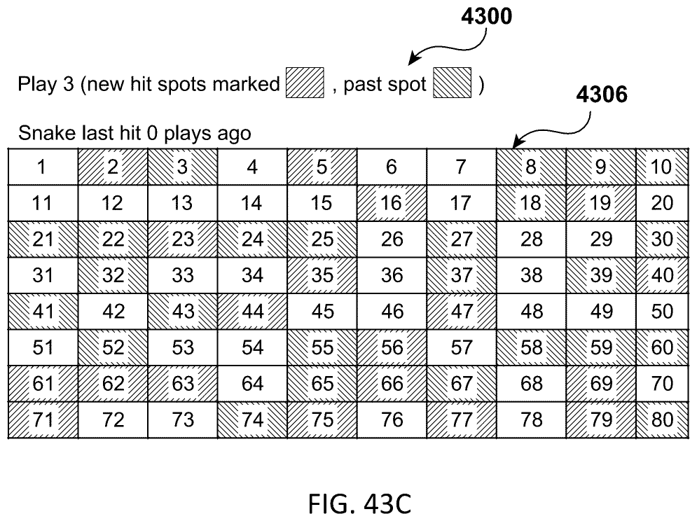

In a varying embodiment according to FIG. 43A, FIG. 43B and FIG. 43C, the additional pattern 4220 may be achieved in a cumulative manner over a plurality of plays or ball calls. This cumulative effect adds a layer of excitement and variability for players, as a pattern may appear close to hitting as a number of plays increases. For amplifying this effect, a counter may be added to the secondary game for communicating a number of plays since the pattern was last matched or hit.

Taking the additional pattern 4220 as a snake pattern according to FIG. 42, FIG. 43A shows a secondary game of keno 4300 where the snake pattern was last hit thirteen plays ago. This play or round 4302 of the secondary game 4300 proceeds according to the traditional style of keno, with the player selecting numbers for their wager and matches being marked where the selected numbers match a ball call provided for the game. However, when a subsequent play 4304 or round occurs as shown in FIG. 43B, the previous matches are tracked and added to the matches of the previous play 4302 and compared to the additional pattern 4220.

In the case of FIG. 43B, newly hit spots are marked in a hatching pattern while previously hit spots are marked in a different hatching pattern but, cumulatively, spots forty-seven and sixty-nine are missing from the additional pattern 4220. FIG. 43C shows an example of a play 4306 where a hit for the additional pattern 4220 is achieved, with newly hit spots marked in a hatching pattern while previously hit spots are marked in a different hatching pattern. Accordingly, the award for the snake pattern from the pay table 4210 is provided to the player together with or in place of any award achieved for a number of matches.

In this way, the embodiments of FIGS. 42-43C include a flexible award directly in the secondary game using secondary attributes in the form of additional keno patterns. Accordingly, the wager result of the secondary game can be flexibly adjusted to correspond to a primary game wager result where the scorecard won in the primary game corresponds to a prize pool value, or any other value as may be required due to the variability of the prize value of the primary game and/or a mismatch between the payouts of the primary game and the secondary game.

Of course, the patterns and/or award values, etc. may be adjusted as needed to correspond to variations in the prize pool values, while the award system for traditional matches in the secondary game may appear to remain static. Other embodiments may be configured to include one or more of the same or different secondary attributes, such as in the form of a patterns on the card, patterns in a ball call, patterns in the numbers matched, or another pattern for triggering a bonus credit or bonus game.

Several variations are contemplated, including colors assigned to the balls in the ball call corresponding to a bonus pattern of the like. In each case, the wager result of the secondary game is controlled to correspond to the wager result of the primary game, allowing the player to enjoy playing a secondary game even where the awards corresponding to the secondary game are static or traditional values that do not directly correspond to awards of an underlying primary game, such as with a table game like a keno game and a primary game with pari-mutuel or otherwise varied awards. These variations in the secondary game further increase player engagement and enjoyment, by providing the player with increasingly varied and exciting gameplay based on a primary game wager, such as an HHR wager.

### F. Poker

Some game types may have a set payout structure, such that a direct correspondence between the payout of the wager and a simulated payout of the secondary game may not exist. By breaking the reward value of the wager into more than one secondary game, a correspondence between the payout of the wager and the simulated payouts may be provided, as discussed in various embodiments of the current disclosure.

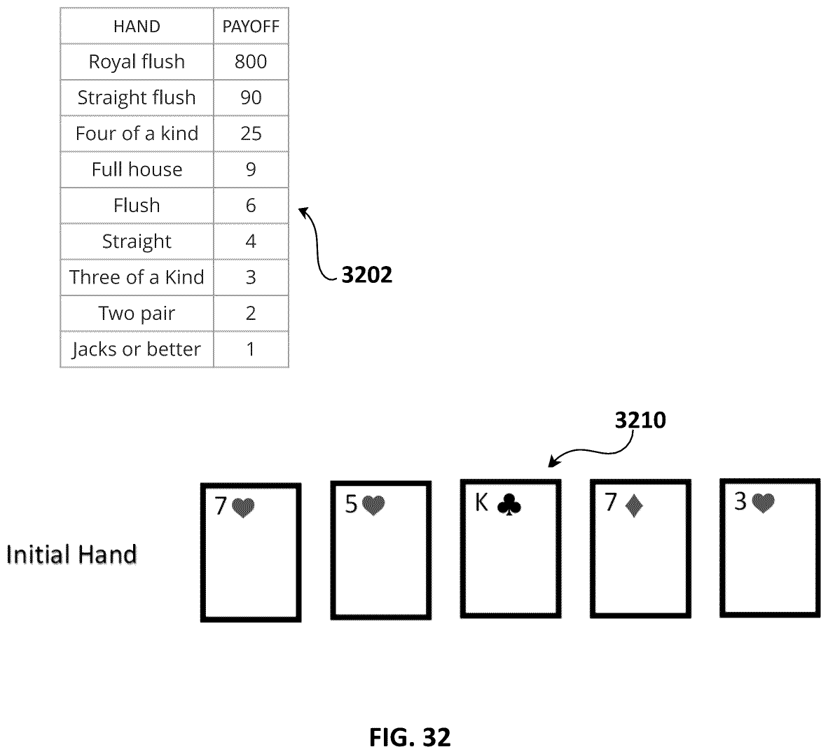

In a further aspect, a secondary game may be adapted to provide an increased set of outcomes to better accommodate different and/or varying pool sizes. For example, where a player's wager is based on the predicted final outcome and/or predicted ranking of the participants in the one or more events in an underlying primary game, a secondary game of poker may be provided in the form of a “Jack's or Better” game with a paytable 3202 as shown in FIG. 32. The player may be provided with an initial hand 3210 in the secondary game, such that there are 10 possible results of a hand.

Due to the static nature of awards in table games, such as Jack's or Better poker, an added flexible award table may be used to handle an effect of variation in player pool size on an underlying pari-mutuel payout characteristic of HHR games. The awards of the extra game may be progressive values, static or a mix of progressive and static. In certain embodiments, the awards may all be static but the number of awards available may be varied to correlate the payouts of the secondary games and the primary game. The secondary game thereby provides an advantageous variability and entertainment for the player, while maintaining a simplified and streamlined underlying gaming mechanism based on one or more selected events.

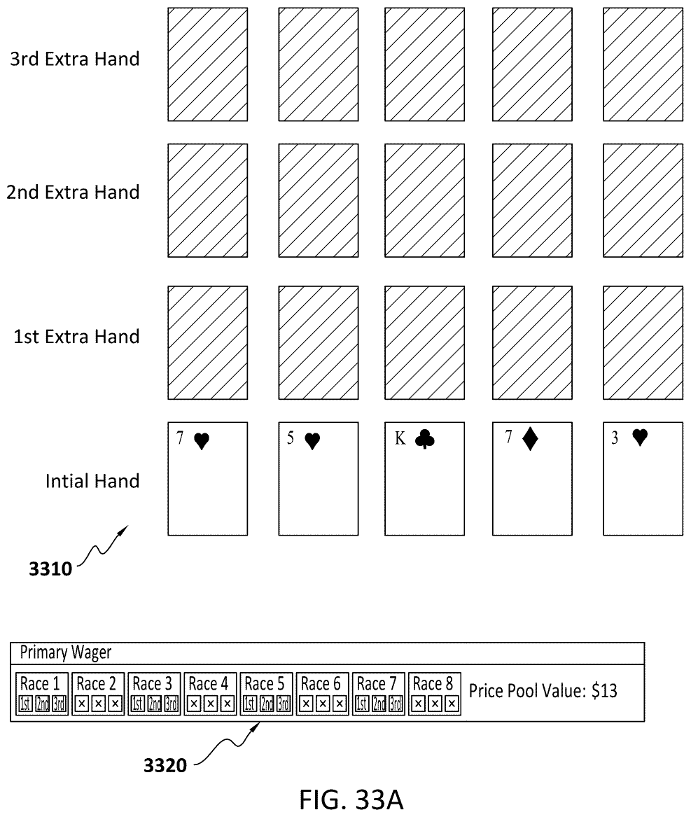

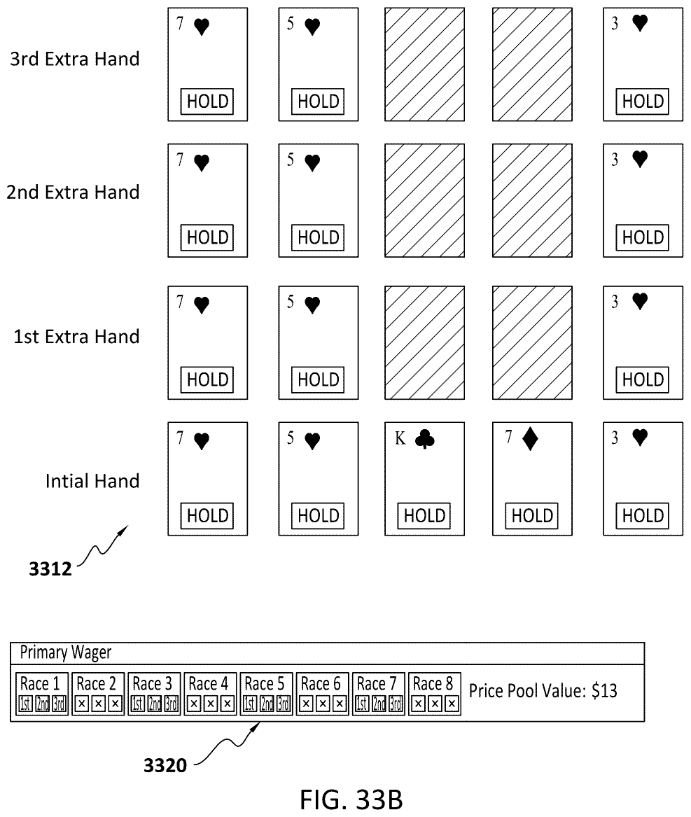

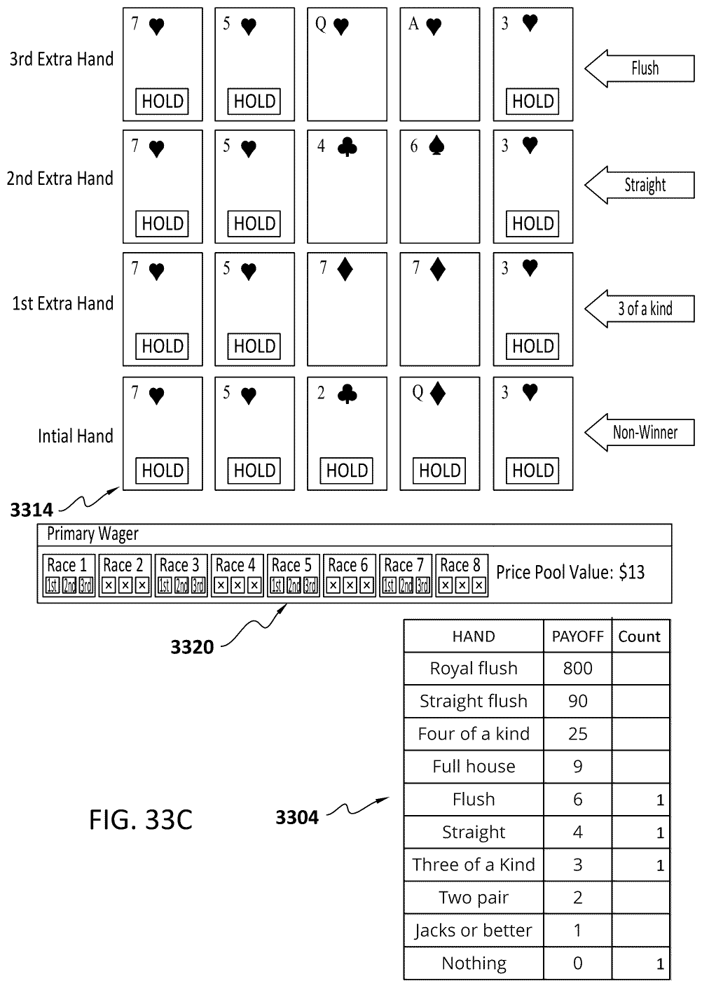

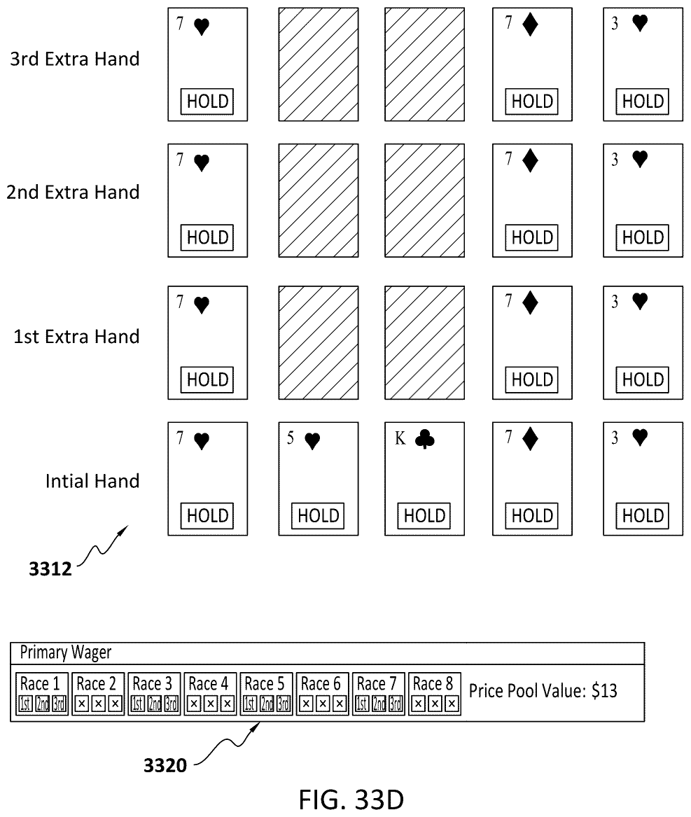

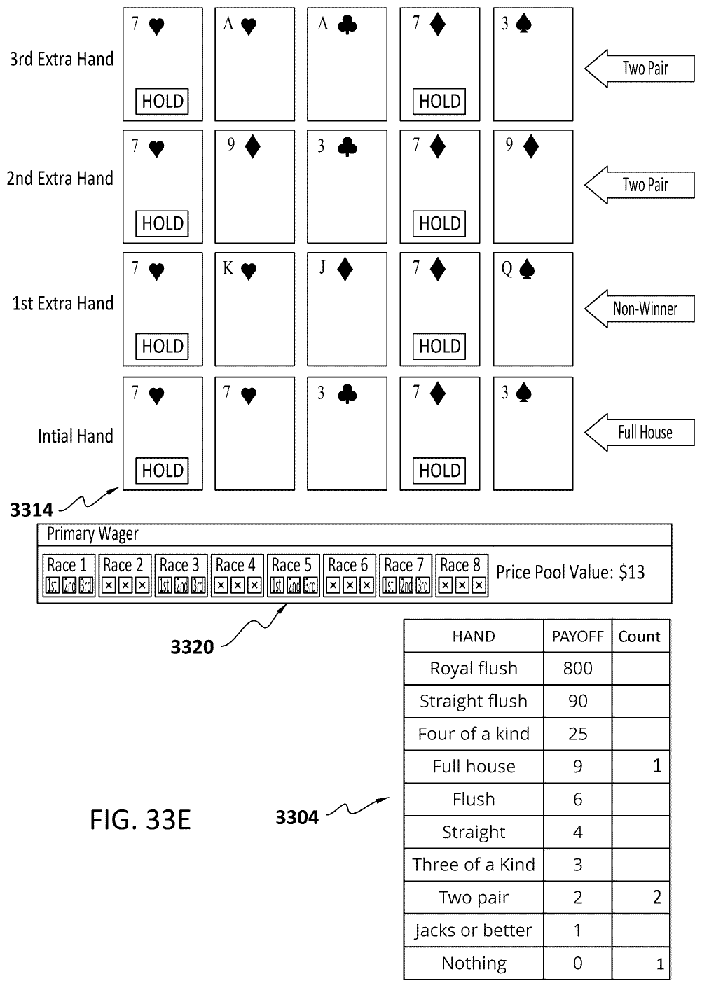

In the embodiment of FIG. 33A, the secondary game of Jack's or Better poker of FIG. 32 may be provided having a static award table 3202 as shown in FIG. 32 while the primary game includes a pari-mutuel payout structure that varies based on player pool size, etc. As the payout award of the secondary game is based on the underlying wager in the primary game, the secondary game may be modified to address any discrepancies between the value of the static award table of the secondary game and the pari-mutuel payout of the primary game by including an increased set of outcomes to better accommodate different pool sizes.

As shown in FIG. 33A, using the same paytable 3202 of FIG. 32, three extra hands are added to the Jack's or Better poker game, such that the secondary game now includes 277 possible unique payouts or outcomes. In varying embodiments, a number of possible payouts may also be increased by including combined awards between hands, such as adding that a result of a Four of a Kind result in three hands all of the same suit pays $200 instead of $25*3. Notably, other combinations or secondary attributes may be associated with varying awards and/or triggering a bonus game as discussed in the disclosure.

In the example of FIG. 33A, the player may be presented with an initial deal of the 1^{st} hand 3310 upon placing a wager, e.g., 1 credit or $1. The secondary game is based on a result of an underlying primary game, which in the current example has provided a win of $13 as seen in the scorecard 3320. In the secondary game, the player is next given the option to “HOLD” some, none or all of the initial hand, as shown in FIG. 33B. Any held card is also held for the extra hands. The example of FIG. 33B shows the 1^{st}, 2^{nd} and 5^{th} cards being held in each of the hands 3312. Based on the result of the primary game 3320, the secondary game may be configured to fill in the replacement cards 3314 such that the sum of the hand wins 3304 equals the primary game win 3320, as depicted in FIG. 33C.

FIG. 33D illustrates the flexibility of the embodiment of FIG. 33A, where in the example of FIG. 33D the player selects to hold the 1^{st} and 4^{th} cards in each of the hands 3312. Based on the result of the primary game 3320, the secondary game may still be configured to fill in the replacement cards 3314 such that the sum of the hand wins 3304 equals the primary game win 3320, as depicted in FIG. 33E.

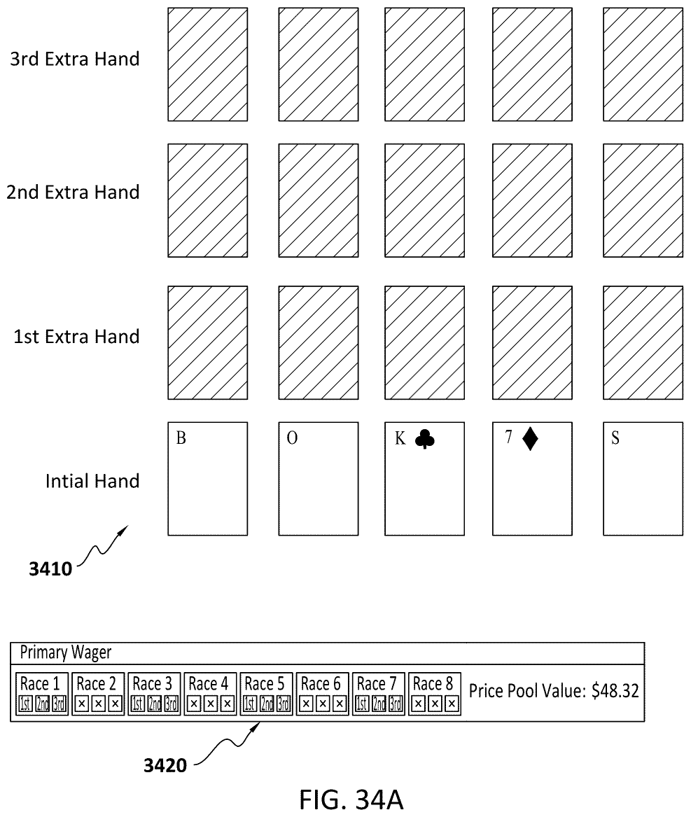

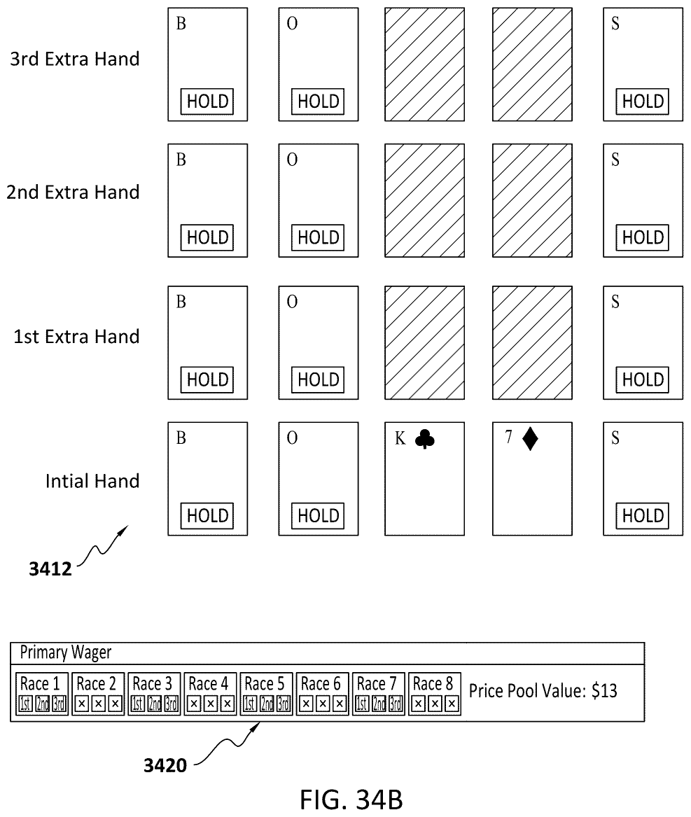

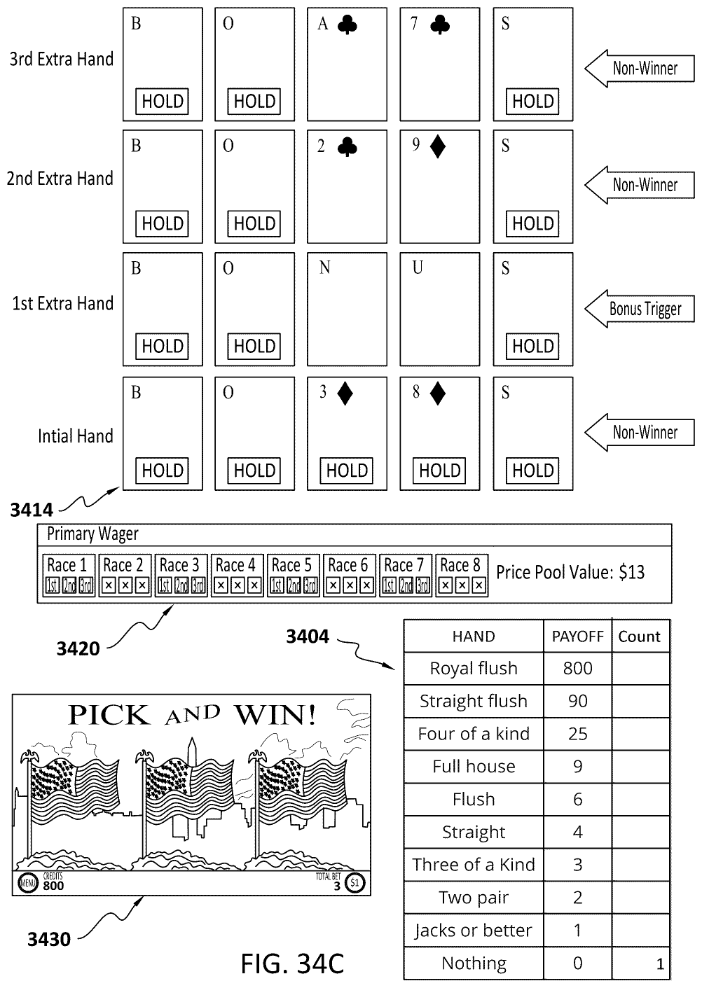

In the embodiment of FIG. 34A, the secondary game of Jack's or Better poker of FIG. 32 may be provided having a static award table 3202 as shown in FIG. 32 while the primary game includes a pari-mutuel payout structure that varies based on player pool size, etc. As the payout award of the secondary game is based on the underlying wager in the primary game, the secondary game may be modified to address any discrepancies between the value of the static award table of the secondary game and the pari-mutuel payout of the primary game by including an increased set of outcomes to better accommodate different pool sizes, where the set of outcoes includes a bonus game trigger.

As shown in FIG. 34A, a bonus trigger may be included in the secondary game in addition to the paytable 3202 of FIG. 32. In the illustrated example of FIG. 34A, the player may be presented with an initial deal of the 1^{st} hand 3410 upon placing a wager, e.g., 1 credit or $1. The secondary game is based on a result of an underlying primary game, which in the current example has provided a win of $48.32 as seen in the scorecard 3420. In the secondary game, the player is next given the option to “HOLD” some, none or all of the initial hand, as shown in FIG. 34B. Any held card is also held for the extra hands. The example of FIG. 34B shows the 1^{st}, 2^{nd} and 5^{th} cards being held in each of the hands 3412. Based on the result of the primary game 3420, the secondary game may be configured to fill in the replacement cards 3414 such that a bonus game 3430 is triggered in addition to the sum of any hand wins 3404, such that the bonus game win plus the sum of the hand wins 3404 equals the primary game win 3420, as depicted in FIG. 34C.

In this manner, the wager result of the secondary game, including the poker game and the bonus game, may correspond to the wager result or scorecard of the primary game, such as an HHR game, which may be shown in another window, part of the entertaining display, or only used in a game engine. This is realized even though the secondary game of Jack's or Better poker generally requires static award values and the primary game may include parimutuel awards that vary based on player counts and the like, due to the bonus game providing the difference between the award values.

It should be noted that various modifications and alternative arrangements of a bonus game and/or additional outcomes are possible without departing from the principles of the illustrated embodiment. For example, the paytable layout, number of hands, cards, or other attributes may be adjusted, or another game may be provided in place of a Jack's or Better style game.

The bonus style game presented as an extension of the secondary game increases player engagement and enjoyment, by providing the player with increasingly varied and exciting gameplay based on a primary game wager, such as HHR. Advantageously, the use of the secondary game including a bonus game as described allows the player to enjoy playing a secondary game even where the awards corresponding to the secondary game are static, such as with a table game or more specifically in the example of a Jack's or Better poker game, and the awards for the primary game are parimutuel or otherwise varied.

### G. Lottery Ball Draw

Notably, the disclosed embodiments, while being applicable for adapting a primary game underlying a secondary game wherein the secondary game comprises a traditional table game, are not restricted to application with existing traditional games. For example, additional and new variations on existing table games may be used as a secondary game.

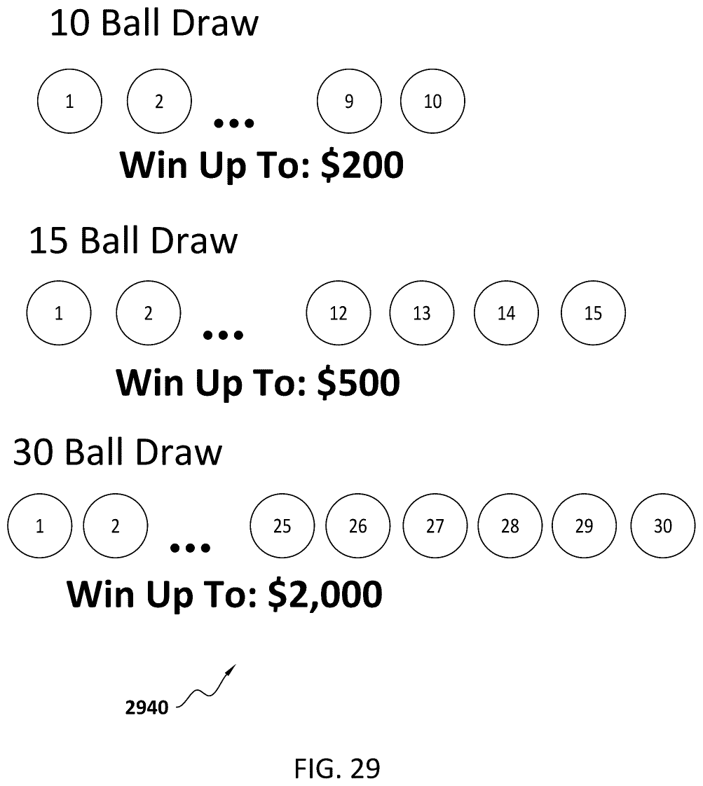

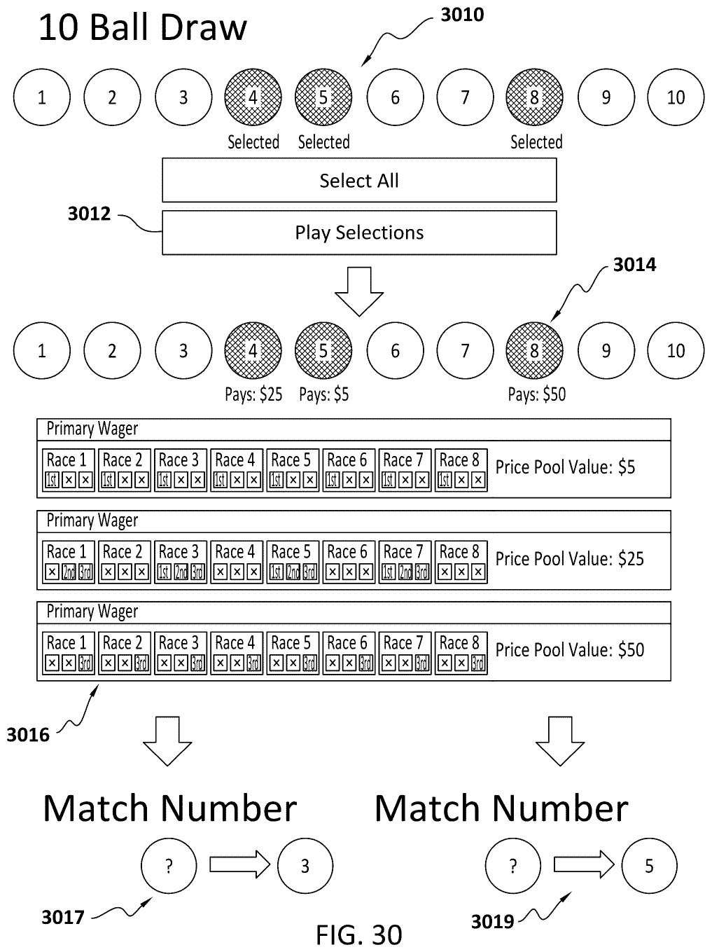

In one aspect, a secondary game may be provided as a lottery ball draw where the result of the secondary game is based on an underlying primary game, such as an HHR primary game. As shown in FIG. 29, a lottery ball draw may be provided as a secondary game 2940 where a player may initiate a wager including a selection of a ball draw, e.g., 10 Ball Draw, 15 Ball Draw, 30 Ball Draw.

Following selection of a ball draw, for example a ten-ball draw, the player is given the opportunity to pick match balls 3010 before proceeding to play the selection 3012. In the depicted example, the player selects the match balls 4, 5 and 8, and presses the “Play Selections” button to be shown the possible awards 3014. Associated results for the underlying primary game may be based on scorecards for an underlying primary game comprising an HHR game, as shown in the paytable 3016.

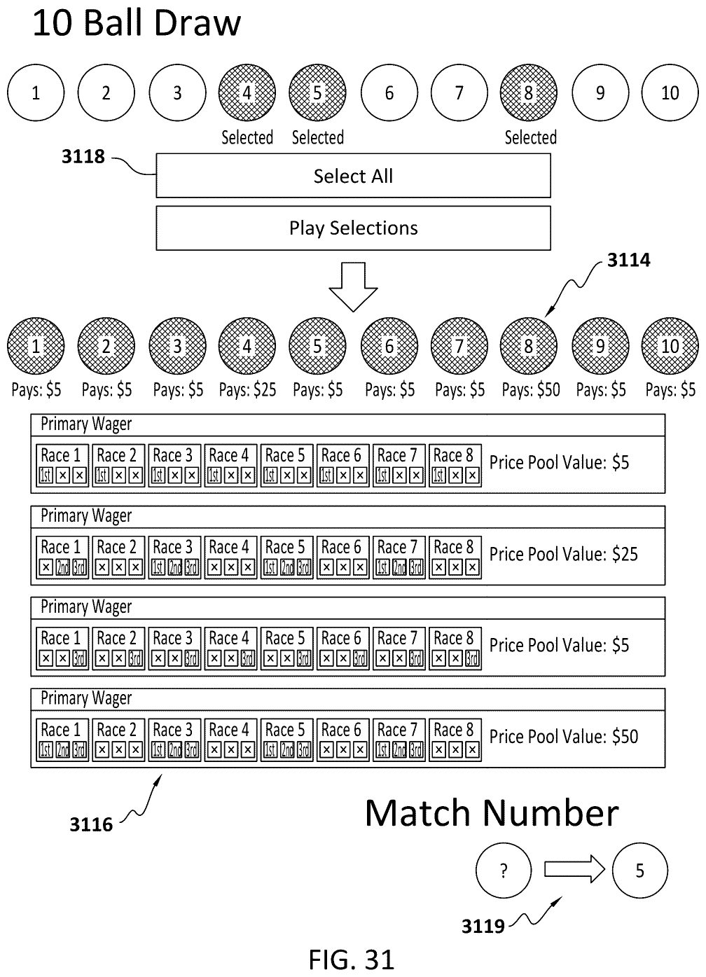

Based on the result of the primary game, a match number may be revealed showing a loss 3017 (e.g., a three where there is no match to the player's number and no award is paid) or a win 3019 (e.g., a five where the match to the selected 5 ball corresponds to a win of $5). In a further embodiment according to FIG. 31, a player may pick the “Select All” button 3118, guaranteeing a win 3114, where the associated primary game associates one or more scorecard for each award value in a paytable 3116. One unique feature of the embodiments is that the player is provided an option for a guaranteed win 3119, which has not been previously provided in an HHR game. These variations in the secondary game increase player engagement and enjoyment, by providing the player with increasingly varied and exciting gameplay based on a primary game wager, such as HHR.

Although discussed as a “ball draw” it should be noted that the ball draw may be simulated by a computing device or system, may be provided as a physical ball draw, and/or may be simulated by another system or hardware component. In some examples, a random number generator may be provided for conducting the ball draw, such as comprised in software executable by a processor of a gaming machine or gaming system. In certain embodiments, a non-software random number generator may be provided, for example comprising one or more of a physical dice roll, a physical ball draw, a physical spinning wheel or reel, a physical roulette wheel, a physical card draw from a physical deck of shuffled cards, an analogue random number generator, or another similar device or system.

Embodiments of the gaming system and the related methods according to the present disclosure may advantageously maximize gameplay at a gaming server by conducting gameplay in a secondary game of an entertaining display with input from the user and an underlying HHR game. The use of the HHR game may separate the result of the wager from an active presentation of the gameplay, enabling the gaming system to present a user with entertaining gameplay while streamlining the underlying wager. Further, regulatory constraints for operation of the gaming system are reduced, and locations suitable for providing a gaming system are increased without the associated costs and complexity of prior art systems.

As referenced in the examples of the current disclosure, a “game,” “active game,” “existing game,” and/or “new game” may be used to refer to a set of parameters governing results of a wager. A player or gameplay request entering or being assigned to a game generally refers to applying the wagering parameters associated with the game to a wager associated with the player or gameplay request.

By providing a gaming system and method for using the same according to the disclosed embodiments, the requirements of existing gaming systems including complex variations across varying regulatory regions are addressed. The gaming system embodiments provided herein advantageously allow a prospective player to play essentially any game based on an HHR game result, thereby increasing a player's enjoyment of the gaming machine generally, while meeting the regulatory requirements and retaining the advantages of HHR gaming.

While the invention has been illustrated and described in detail in the drawings and foregoing description, the same is to be considered as illustrative and not restrictive in character, it being understood that only the preferred embodiments have been shown and described and that all changes, equivalents, and modifications that come within the spirit of the inventions defined by following claims are desired to be protected.

It is to be understood that not necessarily all objects or advantages may be achieved under any embodiment of the disclosure. Those skilled in the art will recognize that the disclosed gaming system and related methods may be embodied or carried out in a manner that achieves or optimizes one advantage or group of advantages as taught without achieving other objects or advantages as taught or suggested.

The skilled artisan will recognize the interchangeability of various disclosed features. Besides the variations described, other known equivalents for various features can be mixed and matched by one of ordinary skill in this art to make or use a gaming system and related methods under principles of the present disclosure. The features described may be adapted to other types of systems, games and regulatory requirements.

Although this disclosure describes certain exemplary embodiments and examples of a gaming system and related methods, the present disclosure extends beyond the specifically disclosed embodiments to other alternative embodiments and/or uses of the disclosure and obvious modifications and equivalents thereof. It is intended that the present disclosure should not be limited by the particular disclosed embodiments described above.

The disclosure further relates to several embodiments as identified by the below numbered embodiments. The present invention is in no way limited to the embodiments described by way of example and represented in the embodiments, and the embodiments are provided only to demonstrate non-limiting examples of possible embodiments of the disclosure.

1-1. A gaming machine comprising:
a display device configured to display an output to a user;
an input device configured to accept a wager from the user for a primary game, the primary game being based on one or more historic events;
a processor coupled to a memory, the input device and the display device;
the gaming machine configured to:
provide a secondary game to the user;
receive an input from the user for the secondary game and convert the user input to the wager for the primary game;
determine a result of the wager for the primary game; and
provide an output of the secondary game to the user corresponding to the result of the wager.

1-2. The gaming machine of any one or a combination of two or more of embodiments 1-1 above and 1-3 to 1-10 below,
wherein the one or more selected events are historical horse races; and/or
wherein the secondary game is a table game, the table game comprising one or more of poker, baccarat, blackjack, craps, roulette, a big six wheel or wheel of fortune, pool, pachinko, chemin de fer, pai gow, a lottery, keno, or any other table game, or bingo; and/or
the input from the user for the secondary game comprises one or more of a “hit”, “stay”, “roll”, a predicted winning number, and a predicted winning entity.

1-3. The gaming machine of any one or a combination of two or more of embodiments 1-1 to 1-2 above and 1-4 to 1-10 below, wherein the primary game comprises selecting a predicted final outcome and/or predicted final ranking of one or more participants in one or more selected events.

1-4. The gaming machine of any one or a combination of two or more of embodiments 1-1 to 1-3 above and 1-5 to 1-10 below, wherein the gaming machine is configured to select the one or more selected events based on odds of available wagers for said one or more selected events.

1-5. The gaming machine of any one or a combination of two or more of embodiments 1-1 to 1-4 above and 1-6 to 1-10 below, wherein the input from the user for the secondary game corresponds to betting odds for the secondary game.

1-6. The gaming machine of any one or a combination of two or more of embodiments 1-1 to 1-5 above and 1-7 to 1-10 below, wherein converting the user input to the wager for the primary game comprises automatically selecting a predicted final outcome and/or predicted final ranking of one or more participants for one or more selected events having wager odds corresponding to the betting odds for the secondary game.

1-7. The gaming machine of any one or a combination of two or more of embodiments 1-1 to 1-6 above and 1-8 to 1-10 below, wherein the gaming machine is further configured to provide a plurality of secondary games to the user, the outputs of the secondary games cumulatively corresponding to the result of the wager.

1-8. The gaming machine of any one or a combination of two or more of embodiments 1-1 to 1-7 above and 1-9 to 1-10 below, wherein the gaming machine is configured to select the one or more selected events based on the input from the user for the secondary game.

1-9. The gaming machine of any one or a combination of two or more of embodiments 1-1 to 1-8 above and 1-10 below, wherein the input from the user for the secondary game corresponds to betting options for the secondary game.

1-10. The gaming machine of any one or a combination of two or more of embodiments 1-1 to 1-9 above, wherein converting the user input to the wager for the primary game comprises automatically selecting a scorecard for the primary game based on the betting options selected for the secondary game.

1-11. A method for conducting games, comprising:
providing a primary game at a gaming machine;
providing a secondary game to a user at the gaming machine;
receiving an input from the user for the secondary game and converting the user input to a wager for the primary game;
determining a result of the wager for the primary game; and
providing an output of the secondary game to the user corresponding to the result of the wager.

1-12. The method of any one or a combination of two or more of embodiments 1-11 above and 1-13 to 1-20 below, wherein the one or more selected events are historical horse races; and/or
wherein the secondary game is a table game, the table game comprising one or more of poker, baccarat, blackjack, craps, roulette, a big six wheel or wheel of fortune, pool, pachinko, chemin de fer, pai gow, a lottery, keno, or any other table game, or bingo; and/or
the input from the user for the secondary game comprises one or more of a “hit”, “stay”, “roll”, a predicted winning number, and a predicted winning entity.

1-13. The method of any one or a combination of two or more of embodiments 1-11 to 1-12 above and 1-14 to 1-20 below, wherein the primary game comprises selecting a predicted final outcome and/or predicted final ranking of one or more participants in one or more selected events.

1-14. The method of any one or a combination of two or more of embodiments 1-11 to 1-13 above and 1-15 to 1-20 below, wherein the one or more selected events are selected based on odds of available wagers for said one or more selected events.

1-15. The method of any one or a combination of two or more of 1-11 to 1-14 above and 1-16 to 1-20 below, wherein the input from the user for the secondary game corresponds to betting odds for the secondary game.

1-16. The method of any one or a combination of two or more of embodiments 1-11 to 1-15 above and 1-17 to 1-20 below, wherein converting the user input to the wager for the primary game comprises automatically selecting a predicted final outcome and/or predicted final ranking of one or more participants for one or more selected events having wager odds corresponding to the betting odds for the secondary game.

1-17. The method of any one or a combination of two or more of embodiments 1-11 to 1-16 above and 1-18 to 1-20 below, further comprising providing a plurality of secondary games to the user, the outputs of the secondary games cumulatively corresponding to the result of the wager.

1-18. The method of any one or a combination of two or more of embodiments 1-11 to 1-17 above and 1-19 to 1-20 below, wherein the one or more selected events are selected based on the input from the user for the secondary game.

1-19. The method of any one or a combination of two or more of embodiments 1-11 to 1-18 above and 1-20 below, wherein the input from the user for the secondary game corresponds to betting options for the secondary game.

1-20. The method of any one or a combination of two or more of embodiments 1-11 to 1-19 above, wherein converting the user input to the wager for the primary game comprises automatically selecting a scorecard for the primary game based on the betting options selected for the secondary game.

1-21. A gaming machine comprising:
a display device configured to display an output to a user;
an input device configured to accept a wager from the user for a primary game, the primary game being based on one or more historic events;
a processor coupled to a memory, the input device and the display device;
the gaming machine configured to:
provide a secondary game to the user, the secondary game comprising a table game;
determine a result of the wager for the primary game; and
provide an output of the secondary game to the user corresponding to the result of the wager.

1-22. The gaming machine of any one or a combination of two or more of embodiments 1-21 above and 1-23 to 1-30 below, wherein the primary game comprises selecting a predicted final outcome and/or predicted final ranking of one or more participants in one or more selected events.

1-23. The gaming machine of any one or a combination of two or more of embodiments 1-21 to 1-22 above and 1-24 to 1-30 below, wherein the one or more selected events are historical horse races; and/or
wherein the secondary game comprises one or more of poker, baccarat, blackjack, craps, roulette, a big six wheel or wheel of fortune, pool, pachinko, chemin de fer, pai gow, a lottery, keno, or any other table game, or bingo.

1-24. The gaming machine of any one or a combination of two or more of embodiments 1-21 to 1-23 above and 1-25 to 1-30 below, wherein the gaming machine is configured to select the one or more selected events based on odds of available wagers for said one or more selected events.

1-25. The gaming machine of any one or a combination of two or more of embodiments 1-21 to 1-24 above and 1-26 to 1-30 below, wherein the gaming machine is configured to receive an input from the user for the secondary game.

1-26. The gaming machine of any one or a combination of two or more of embodiments 1-21 to 1-25 above and 1-27 to 1-30 below, wherein the user input to the secondary game corresponds to a predetermined entertaining display having a result matching the result of the wager for the primary game.

1-27. The gaming machine of any one or a combination of two or more of embodiments 1-21 to 1-26 above and 1-28 to 1-30 below, wherein the gaming machine is further configured to provide a plurality of secondary games to the user, the outputs of the secondary games cumulatively corresponding to the result of the wager.

1-28. The gaming machine of any one or a combination of two or more of embodiments 1-21 to 1-27 above and 1-29 to 1-30 below, wherein the predetermined entertaining display comprises a video or animation of the secondary game having the result matching the result of the wager for the primary game.

1-29. The gaming machine of any one or a combination of two or more of embodiments 1-21 to 1-28 above and 1-30, wherein the input from the user for the secondary game corresponds to betting options for the secondary game.

1-30. The gaming machine of any one or a combination of two or more of embodiments 1-21 to 1-29 above, wherein the user input for the secondary game initializes the wager for the primary game.

1-31. A method for conducting games, comprising:
providing a primary game at a gaming machine;
providing a secondary game to a user at the gaming machine;
determining a result of a wager for the primary game; and
providing an output of the secondary game to the user corresponding to the result of the wager.

1-32. The method of any one or a combination of two or more of embodiments 1-31 above and 1-33 to 1-41 below, wherein the primary game comprises selecting a predicted final outcome and/or predicted final ranking of one or more participants in one or more selected events.

1-33. The method of any one or a combination of two or more of embodiments 1-31 to 1-32 above and 1-34 to 1-41 below, wherein the one or more selected events are historical horse races; and/or
wherein the secondary game comprises one or more of poker, baccarat, blackjack, craps, roulette, a big six wheel or wheel of fortune, pool, pachinko, chemin de fer, pai gow, a lottery, keno, or any other table game, or bingo.

1-34. The method of any one or a combination of two or more of embodiments 1-31 to 1-33 above and 1-35 to 1-41 below, wherein the one or more selected events are selected based on odds of available wagers for said one or more selected events.

1-35. The method of any one or a combination of two or more of embodiments 1-31 to 1-34 above and 1-36 to 1-41 below, further comprising receiving an input from the user for the secondary game.

1-36. The method of any one or a combination of two or more of embodiments 1-31 to 1-35 above and 1-37 to 1-41 below, wherein the input for the secondary game corresponds to the output of the secondary game comprising a predetermined entertaining display having a result matching the result of the wager for the primary game.

1-37. The method of any one or a combination of two or more of embodiments 1-31 to 1-36 above and 1-38 to 1-41 below, further comprising providing a plurality of secondary games to the user, the outputs of the secondary games cumulatively corresponding to the result of the wager.

1-38. The method of any one or a combination of two or more of embodiments 1-31 to 1-37 above and 1-39 to 1-41 below, wherein the predetermined entertaining display comprises a video or animation of the secondary game having the result matching the result of the wager for the primary game.

1-39. The method of any one or a combination of two or more of embodiments 1-31 to 1-38 above and 1-40 to 1-41 below, wherein the input from the user for the secondary game corresponds to betting options for the secondary game.

1-40. The method of any one or a combination of two or more of embodiments 1-31 to 1-39 above and 1-41 below, wherein the user input for the secondary game initializes the wager for the primary game.

1-41. The method of any one or a combination of two or more of embodiments 1-31 to 1-40 above, further comprising providing an output of the primary game to the user, the output of the secondary game and the output of the primary game being displayed to the user simultaneously.

1-42. One or more hardware storage devices or one or more computer-readable mediums having instructions stored therein, which, when executed by one or more processors of a computer device, cause the one or more processors to perform the method according to any one or a combination of two or more of embodiments 1-11 to 1-20 and 1-31 to 1-41 above.

2-1. A gaming machine comprising:
a display device configured to display an output to a user;
an input device configured to accept a wager from the user for a primary game, the primary game being based on one or more historic events;
a processor coupled to a memory, the input device and the display device;
the gaming machine configured to:
   determine a result of the wager for the primary game;
   provide a secondary game to the user;
   receive an input from the user for the secondary game and convert an output of the secondary game to correspond with the wager for the primary game; and
   provide the output of the secondary game to the user corresponding to the result of the wager.

2-2. The gaming machine of any one or a combination of two or more of embodiments 2-1 above and 2-3 to 2-10 below,
wherein the one or more selected events are historical horse races; and/or
wherein the secondary game is a table game, the table game comprising one or more of poker, baccarat, blackjack, craps, roulette, a big six wheel or wheel of fortune, pool, pachinko, chemin de fer, pai gow, a lottery, keno, or any other table game, or bingo; and/or
the input from the user for the secondary game comprises one or more of a “hit”, “stay”, “roll”, a predicted winning number, and a predicted winning entity.

2-3. The gaming machine of any one or a combination of two or more of embodiments 2-1 to 2-2 above and 2-3 to 2-10 below, wherein the primary game comprises selecting a predicted final outcome and/or predicted final ranking of one or more participants in one or more selected events.

2-4. The gaming machine of any one or a combination of two or more of embodiments 2-1 to 2-3 above and 2-5 to 2-10 below, wherein the gaming machine is configured to select the one or more selected events based on odds of available wagers for said one or more selected events.

2-5. The gaming machine of any one or a combination of two or more of embodiments 2-1 to 2-4 above and 2-6 to 2-10 below, wherein the input from the user for the secondary game corresponds to playing the secondary game.

2-6. The gaming machine of any one or a combination of two or more of embodiments 2-1 to 2-5 above and 2-7 to 2-10 below, wherein converting an output of the secondary game to correspond with the wager for the primary game comprises automatically providing a bonus game to the player.

2-7. The gaming machine of any one or a combination of two or more of embodiments 2-1 to 2-6 above and 2-8 to 2-10 below, wherein the output of the secondary game includes a static award and a bonus award cumulatively corresponding to the result of the wager in the primary game.

2-8. The gaming machine of any one or a combination of two or more of embodiments 2-1 to 2-7 above and 2-9 to 2-10 below, wherein the gaming machine is configured to provide secondary attributes in the secondary game based on the input from the user for the secondary game, the secondary attributes corresponding to a bonus award wherein the output of the secondary game includes a static award and a bonus award cumulatively corresponding to the result of the wager in the primary game.

2-9. The gaming machine of any one or a combination of two or more of embodiments 2-1 to 2-8 above and 2-10 below, wherein the input from the user for the secondary game corresponds to betting options for the secondary game.

2-10. The gaming machine of any one or a combination of two or more of embodiments 2-1 to 2-9 above, wherein the bonus award comprises a static award and/or a flexible award.

2-11. A method for conducting games, comprising:
providing a primary game at a gaming machine;
determining a result of the wager for the primary game;
providing a secondary game to a user at the gaming machine;
receiving an input from the user for the secondary game and converting an output of the secondary game to correspond with the wager for the primary game; and
providing the output of the secondary game to the user corresponding to the result of the wager.

2-12. The method of any one or a combination of two or more of embodiments 2-11 above and 2-13 to 2-20 below, wherein the one or more selected events are historical horse races; and/or
wherein the secondary game is a table game, the table game comprising one or more of poker, baccarat, blackjack, craps, roulette, a big six wheel or wheel of fortune, pool, pachinko, chemin de fer, pai gow, a lottery, keno, or any other table game, or bingo; and/or
the input from the user for the secondary game comprises one or more of a “hit”, “stay”, “roll”, a predicted winning number, and a predicted winning entity.

2-13. The method of any one or a combination of two or more of embodiments 2-11 to 2-12 above and 2-14 to 2-20 below, wherein the primary game comprises selecting a predicted final outcome and/or predicted final ranking of one or more participants in one or more selected events.

2-14. The method of any one or a combination of two or more of embodiments 2-11 to 2-13 above and 2-15 to 2-20 below, wherein the one or more selected events are selected based on odds of available wagers for said one or more selected events.

2-15. The method of any one or a combination of two or more of embodiments 2-11 to 2-14 above and 2-16 to 2-20 below, wherein the input from the user for the secondary game corresponds to playing the secondary game.

2-16. The method of any one or a combination of two or more of embodiments 2-11 to 2-15 above and 2-17 to 2-20 below, wherein converting an output of the secondary game to correspond with the wager for the primary game comprises automatically providing a bonus game to the player.

2-17. The method of any one or a combination of two or more of embodiments 2-11 to 2-16 above and 2-18 to 2-20 below, wherein the output of the secondary game includes a static award and a bonus award cumulatively corresponding to the result of the wager in the primary game.

2-18. The method of any one or a combination of two or more of embodiments 2-11 to 2-17 above and 2-19 to 2-20 below, further comprising providing secondary attributes in the secondary game based on the input from the user for the secondary game, the secondary attributes corresponding to a bonus award wherein the output of the secondary game includes a static award and a bonus award cumulatively corresponding to the result of the wager in the primary game.

2-19. The method of any one or a combination of two or more of embodiments 2-11 to 2-18 above and 2-20 below, wherein the input from the user for the secondary game corresponds to betting options for the secondary game.

2-20. The method of any one or a combination of two or more of embodiments 2-11 to 2-19 above, wherein the bonus award comprises a static award and/or a flexible award.

2-21. A gaming machine comprising:
a display device configured to display an output to a user;
an input device configured to accept a wager from the user for a primary game, the primary game being based on one or more historic events;
a processor coupled to a memory, the input device and the display device;
the gaming machine configured to:
   provide a secondary game to the user, the secondary game comprising a table game;
   determine a result of the wager for the primary game; and
   provide an output of the secondary game to the user corresponding to the result of the wager.

2-22. The gaming machine of any one or a combination of two or more of embodiments 2-21 above and 2-23 to 2-30 below, wherein the primary game comprises selecting a predicted final outcome and/or predicted final ranking of one or more participants in one or more selected events.

2-23. The gaming machine of any one or a combination of two or more of embodiments 2-21 to 2-22 above and 2-24 to 2-30 below, wherein the one or more selected events are historical horse races; and/or
wherein the secondary game comprises one or more of poker, baccarat, blackjack, craps, roulette, a big six wheel or wheel of fortune, pool, pachinko, chemin de fer, pai gow, a lottery, keno, or any other table game, or bingo.

2-24. The gaming machine of any one or a combination of two or more of embodiments 2-21 to 2-23 above and 2-25 to 2-30 below, wherein the gaming machine is configured to select the one or more selected events based on odds of available wagers for said one or more selected events.

2-25. The gaming machine of any one or a combination of two or more of embodiments 2-21 to 2-24 above and 2-26 to 2-30 below, wherein the gaming machine is configured to receive an input from the user for the secondary game.

2-26. The gaming machine of any one or a combination of two or more of embodiments 2-21 to 2-25 above and 2-27 to 2-30 below, wherein the user input to the secondary game corresponds to a predetermined entertaining display having a result matching the result of the wager for the primary game.

2-27. The gaming machine of any one or a combination of two or more of embodiments 2-21 to 2-26 above and 2-28 to 2-30 below, wherein the gaming machine is further configured to provide a bonus game to the user as part of the secondary game, the output of the secondary game including a static award and a bonus award cumulatively corresponding to the result of the wager in the primary game.

2-28. The gaming machine of any one or a combination of two or more of embodiments 2-21 to 2-27 above and 2-29 to 2-30 below, wherein the gaming machine is configured to provide secondary attributes in the secondary game based on the input from the user for the secondary game, the secondary attributes corresponding to a bonus award wherein the output of the secondary game includes a static award and a bonus award cumulatively corresponding to the result of the wager in the primary game.

2-29. The gaming machine of any one or a combination of two or more of embodiments 2-21 to 2-28 above and 2-30, wherein the input from the user for the secondary game corresponds to betting options for the secondary game.

2-30. The gaming machine of any one or a combination of two or more of embodiments 2-21 to 2-29 above, wherein the bonus award comprises a static award and/or a flexible award.

2-31. A method for conducting games, comprising:
providing a primary game at a gaming machine;
determining a result of a wager for the primary game;
providing a secondary game to a user at the gaming machine; and
providing an output of the secondary game to the user corresponding to the result of the wager.

2-32. The method of any one or a combination of two or more of embodiments 2-31 above and 2-33 to 2-41 below, wherein the primary game comprises selecting a predicted final outcome and/or predicted final ranking of one or more participants in one or more selected events.

2-33. The method of any one or a combination of two or more of embodiments 2-31 to 2-32 above and 2-34 to 2-41 below, wherein the one or more selected events are historical horse races; and/or
wherein the secondary game comprises one or more of poker, baccarat, blackjack, craps, roulette, a big six wheel or wheel of fortune, pool, pachinko, chemin de fer, pai gow, a lottery, keno, or any other table game, or bingo.

2-34. The method of any one or a combination of two or more of embodiments 2-31 to 2-33 above and 2-35 to 2-41 below, wherein the one or more selected events are selected based on odds of available wagers for said one or more selected events.

2-35. The method of any one or a combination of two or more of embodiments 2-31 to 2-34 above and 2-36 to 2-41 below, further comprising receiving an input from the user for the secondary game.

2-36. The method of any one or a combination of two or more of embodiments 2-31 to 2-35 above and 2-37 to 2-41 below, wherein the input for the secondary game corresponds to the output of the secondary game comprising a predetermined entertaining display having a result matching the result of the wager for the primary game.

2-37. The method of any one or a combination of two or more of embodiments 2-31 to 2-36 above and 2-38 to 2-41 below, wherein the gaming machine is further configured to provide a bonus game to the user as part of the secondary game, the output of the secondary game including a static award and a bonus award cumulatively corresponding to the result of the wager in the primary game.

2-38. The method of any one or a combination of two or more of embodiments 2-31 to 2-37 above and 2-39 to 2-41 below, wherein the gaming machine is configured to provide secondary attributes in the secondary game based on the input from the user for the secondary game, the secondary attributes corresponding to a bonus award wherein the output of the secondary game includes a static award and a bonus award cumulatively corresponding to the result of the wager in the primary game.

2-39. The method of any one or a combination of two or more of embodiments 2-31 to 2-38 above and 2-40 to 2-41 below, wherein the input from the user for the secondary game corresponds to betting options for the secondary game.

2-40. The method of any one or a combination of two or more of embodiments 2-31 to 2-39 above and 2-41 below, wherein the bonus award comprises a static award and/or a flexible award.

2-41. The method of any one or a combination of two or more of embodiments 2-31 to 2-40 above, further comprising providing an output of the primary game to the user, the output of the secondary game and the output of the primary game being displayed to the user simultaneously.

2-42. One or more hardware storage devices or one or more computer-readable mediums having instructions stored therein, which, when executed by one or more processors of a computer device, cause the one or more processors to perform the method according to any one or a combination of two or more of embodiments 2-11 to 2-20 and 2-31 to 2-41 above.

3-1. A gaming machine comprising:
a display device configured to display an output to a user;
an input device configured to accept an initial wager from the user for a primary game, the primary game being based on one or more historic events;
a processor coupled to a memory, the input device and the display device;
the gaming machine configured to:
   determine a result of the initial wager for the primary game;
   provide a secondary game to the user;
   receive an input from the user for the secondary game, the input for the secondary game including a modified wager;
   modify the result of the primary game according to the modified wager and convert an output of the secondary game to correspond with the modified wager for the primary game; and
   provide the modified output of the secondary game to the user corresponding to the result of the modified wager.

3-2. The gaming machine of any one or a combination of two or more of embodiments 3-1 above and 3-3 to 3-10 below,
wherein the one or more selected events are historical horse races; and/or
wherein the secondary game is a table game, the table game comprising one or more of poker, baccarat, blackjack, craps, roulette, a big six wheel or wheel of fortune, pool, pachinko, chemin de fer, pai gow, a lottery, keno, or any other table game, or bingo; and/or
the input from the user for the secondary game comprises one or more of a “hit”, “stay”, “roll”, a predicted winning number, and a predicted winning entity.

3-3. The gaming machine of any one or a combination of two or more of embodiments 3-1 to 3-2 above and 3-3 to 3-10 below, wherein the primary game comprises selecting a predicted final outcome and/or predicted final ranking of one or more participants in one or more selected events.

3-4. The gaming machine of any one or a combination of two or more of embodiments 3-1 to 3-3 above and 3-5 to 3-10 below, wherein the gaming machine is configured to select the one or more selected events based on odds of available wagers for said one or more selected events.

3-5. The gaming machine of any one or a combination of two or more of embodiments 3-1 to 3-4 above and 3-6 to 3-10 below, wherein the modified wager from the user for the secondary game corresponds to one or more of a “double-down”, “a split”, “an odds wager”, “fold”, and the like.

3-6. The gaming machine of any one or a combination of two or more of embodiments 3-1 to 3-5 above and 3-7 to 3-10 below, wherein the modified wager includes a payment beyond an initial payment made in the initial wager.

3-7. The gaming machine of any one or a combination of two or more of embodiments 3-1 to 3-6 above and 3-8 to 3-10 below, wherein the modified wager comprises a secondary, tertiary or more wagers.

3-8. The gaming machine of any one or a combination of two or more of embodiments 3-1 to 3-7 above and 3-9 to 3-10 below, wherein the modified wager corresponds to different scorecards of the primary game than the initial wager.

3-9. The gaming machine of any one or a combination of two or more of embodiments 3-1 to 3-8 above and 3-10 below, wherein the input from the user for the secondary game corresponds to betting options for the secondary game.

3-10. The gaming machine of any one or a combination of two or more of embodiments 3-1 to 3-9 above, wherein the result of the modified wager comprises a static award and/or a flexible award.

3-11. A method for conducting games, comprising:
providing a primary game at a gaming machine;
determining a result of an initial wager for the primary game;
providing a secondary game to a user at the gaming machine;
receiving an input from the user for the secondary game, the input for the secondary game including a modified wager;
modifying the result of the primary game according to the modified wager and converting an output of the secondary game to correspond with the modified wager for the primary game; and
providing the modified output of the secondary game to the user corresponding to the result of the modified wager.

3-12. The method of any one or a combination of two or more of embodiments 3-11 above and 3-13 to 3-20 below, wherein the one or more selected events are historical horse races; and/or
wherein the secondary game is a table game, the table game comprising one or more of poker, baccarat, blackjack, craps, roulette, a big six wheel or wheel of fortune, pool, pachinko, chemin de fer, pai gow, a lottery, keno, or any other table game, or bingo; and/or
the input from the user for the secondary game comprises one or more of a “hit”, “stay”, “roll”, a predicted winning number, and a predicted winning entity.

3-13. The method of any one or a combination of two or more of embodiments 3-11 to 3-12 above and 3-14 to 3-20 below, wherein the primary game comprises selecting a predicted final outcome and/or predicted final ranking of one or more participants in one or more selected events.

3-14. The method of any one or a combination of two or more of embodiments 3-11 to 3-13 above and 3-15 to 3-20 below, wherein the one or more selected events are selected based on odds of available wagers for said one or more selected events.

3-15. The method of any one or a combination of two or more of embodiments 3-11 to 3-14 above and 3-16 to 3-20 below, wherein the modified wager from the user for the secondary game corresponds to one or more of a “double-down”, “a split”, “an odds wager”, “fold”, and the like.

3-16. The method of any one or a combination of two or more of embodiments 3-11 to 3-15 above and 3-17 to 3-20 below, wherein the modified wager includes a payment beyond an initial payment made in the initial wager.

3-17. The method of any one or a combination of two or more of embodiments 3-11 to 3-16 above and 3-18 to 3-20 below, wherein the modified wager comprises a secondary, tertiary or more wagers.

3-18. The method of any one or a combination of two or more of embodiments 3-11 to 3-17 above and 3-19 to 3-20 below, wherein the modified wager corresponds to different scorecards of the primary game than the initial wager.

3-19. The method of any one or a combination of two or more of embodiments 3-11 to 3-18 above and 3-20 below, wherein the input from the user for the secondary game corresponds to betting options for the secondary game.

3-20. The method of any one or a combination of two or more of embodiments 3-11 to 3-19 above, wherein the result of the modified wager comprises a static award and/or a flexible award.

3-21. A gaming machine comprising:
a display device configured to display an output to a user;
an input device configured to accept a wager from a plurality of players for a primary game, the primary game being based on one or more historic events;
a processor coupled to a memory, the input device and the display device;
the gaming machine configured to:
   provide a secondary game to the plurality of players, the secondary game comprising a multiplayer table game;
   determine a result of the wager for the primary game for each of the plurality of players; and
   provide an output of the secondary game to each of the plurality of players corresponding to the result of the wager for each of the plurality of players.

3-22. The gaming machine of any one or a combination of two or more of embodiments 3-21 above and 3-23 to 3-30 below, wherein the primary game comprises selecting a predicted final outcome and/or predicted final ranking of one or more participants in one or more selected events.

3-23. The gaming machine of any one or a combination of two or more of embodiments 3-21 to 3-22 above and 3-24 to 3-30 below, wherein the one or more selected events are historical horse races; and/or
wherein the secondary game comprises one or more of poker, baccarat, blackjack, craps, roulette, a big six wheel or wheel of fortune, pool, pachinko, chemin de fer, pai gow, a lottery, keno, or any other table game, or bingo.

3-24. The gaming machine of any one or a combination of two or more of embodiments 3-21 to 3-23 above and 3-25 to 3-30 below, wherein the gaming machine is configured to select the one or more selected events based on odds of available wagers for said one or more selected events.

3-25. The gaming machine of any one or a combination of two or more of embodiments 3-21 to 3-24 above and 3-26 to 3-30 below, wherein the gaming machine is configured to receive an input from each of the plurality of players for the secondary game.

3-26. The gaming machine of any one or a combination of two or more of embodiments 3-21 to 3-25 above and 3-27 to 3-30 below, wherein an input to the secondary game for each of the plurality of players corresponds to a predetermined entertaining display having a result matching the result of the wager for the primary game.

3-27. The gaming machine of any one or a combination of two or more of embodiments 3-21 to 3-26 above and 3-28 to 3-30 below, wherein the gaming machine is further configured to provide common parameters in the secondary game for each of the plurality of players.

3-28. The gaming machine of any one or a combination of two or more of embodiments 3-21 to 3-27 above and 3-29 to 3-30 below, wherein the secondary game is blackjack and each of the plurality of players is presented a same dealer hand.

3-29. The gaming machine of any one or a combination of two or more of embodiments 3-21 to 3-28 above and 3-30, wherein the wager from each of the plurality of players for the secondary game corresponds to betting options for the secondary game.

3-30. The gaming machine of any one or a combination of two or more of embodiments 3-21 to 3-29 above, wherein the output for each of the plurality of players corresponds to different scorecards of the primary game.

3-31. A method for conducting games, comprising:
providing a primary game at a gaming machine;
determining a result of a wager for the primary game for each of a plurality of players;
providing a secondary game to the plurality of players at the gaming machine; and
providing an output of the secondary game to each of the plurality of players corresponding to the result of the wager for each of the plurality of players.

3-32. The method of any one or a combination of two or more of embodiments 3-31 above and 3-33 to 3-41 below, wherein the primary game comprises selecting a predicted final outcome and/or predicted final ranking of one or more participants in one or more selected events.

3-33. The method of any one or a combination of two or more of embodiments 3-31 to 3-32 above and 3-34 to 3-41 below, wherein the one or more selected events are historical horse races; and/or
wherein the secondary game comprises one or more of poker, baccarat, blackjack, craps, roulette, a big six wheel or wheel of fortune, pool, pachinko, chemin de fer, pai gow, a lottery, keno, or any other table game, or bingo.

3-34. The method of any one or a combination of two or more of embodiments 3-31 to 3-33 above and 3-35 to 3-41 below, wherein the one or more selected events are selected based on odds of available wagers for said one or more selected events.

3-35. The method of any one or a combination of two or more of embodiments 3-31 to 3-34 above and 3-36 to 3-41 below, further comprising receiving an input from each of the plurality of players for the secondary game.

3-36. The method of any one or a combination of two or more of embodiments 3-31 to 3-35 above and 3-37 to 3-41 below, wherein the input for the secondary game corresponds to the output of the secondary game comprising a predetermined entertaining display having a result matching the result of the wager for the primary game.

3-37. The method of any one or a combination of two or more of embodiments 3-31 to 3-36 above and 3-38 to 3-41 below, wherein the gaming machine is further configured to provide common parameters in the secondary game for each of the plurality of players.

3-38. The method of any one or a combination of two or more of embodiments 3-31 to 3-37 above and 3-39 to 3-41 below, wherein the secondary game is blackjack and each of the plurality of players is presented a same dealer hand.

3-39. The method of any one or a combination of two or more of embodiments 3-31 to 3-38 above and 3-40 to 3-41 below, wherein the wager from each of the plurality of players for the secondary game corresponds to betting options for the secondary game.

3-40. The method of any one or a combination of two or more of embodiments 3-31 to 3-39 above and 3-41 below, wherein the output for each of the plurality of players corresponds to different scorecards of the primary game.

3-41. The method of any one or a combination of two or more of embodiments 3-31 to 3-40 above, further comprising providing an output of the primary game to the user, the output of the secondary game and the output of the primary game being displayed to the user simultaneously.

3-42. One or more hardware storage devices or one or more computer-readable mediums having instructions stored therein, which, when executed by one or more processors of a computer device, cause the one or more processors to perform the method according to any one or a combination of two or more of embodiments 3-11 to 3-20 and 3-31 to 3-41 above.

4-1. A gaming machine comprising:
a display device configured to display an output to a user;
an input device configured to accept a wager from the user for a primary game, the primary game being based on one or more historic events;
a processor coupled to a memory, the input device and the display device;
the gaming machine configured to:
   determine a result of the wager for the primary game;
   provide a secondary game to the user;
   receive an input from the user for the secondary game and convert an output of the secondary game to correspond with the wager for the primary game; and
   provide the output of the secondary game to the user corresponding to the result of the wager.

4-2. The gaming machine of any one or a combination of two or more of embodiments 4-1 above and 4-3 to 4-10 below,
wherein the one or more selected events are historical horse races; and/or
wherein the secondary game is a table game, the table game comprising one or more of poker, baccarat, blackjack, craps, roulette, a big six wheel or wheel of fortune, pool, pachinko, chemin de fer, pai gow, a lottery, keno, or any other table game, or bingo; and/or
the input from the user for the secondary game comprises one or more of a “hit”, “stay”, “roll”, a predicted winning number, and a predicted winning entity.

4-3. The gaming machine of any one or a combination of two or more of embodiments 4-1 to 4-2 above and 4-3 to 4-10 below, wherein the primary game comprises selecting a predicted final outcome and/or predicted final ranking of one or more participants in one or more selected events.

4-4. The gaming machine of any one or a combination of two or more of embodiments 4-1 to 4-3 above and 4-5 to 4-10 below, wherein the gaming machine is configured to select the one or more selected events based on odds of available wagers for said one or more selected events.

4-5. The gaming machine of any one or a combination of two or more of embodiments 4-1 to 4-4 above and 4-6 to 4-10 below, wherein the input from the user for the secondary game corresponds to playing the secondary game.

4-6. The gaming machine of any one or a combination of two or more of embodiments 4-1 to 4-5 above and 4-7 to 4-10 below, wherein converting an output of the secondary game to correspond with the wager for the primary game comprises automatically providing a bonus game to the player concurrent with the secondary game.

4-7. The gaming machine of any one or a combination of two or more of embodiments 4-1 to 4-6 above and 4-8 to 4-10 below, wherein the output of the secondary game includes an initial award of the secondary game and an additional award cumulatively corresponding to the result of the wager in the primary game.

4-8. The gaming machine of any one or a combination of two or more of embodiments 4-1 to 4-7 above and 4-9 to 4-10 below, wherein the gaming machine is configured to provide secondary attributes in the secondary game based on the input from the user for the secondary game, the secondary attributes corresponding to an additional award wherein the output of the secondary game includes an initial award and an additional award cumulatively corresponding to the result of the wager in the primary game.

4-9. The gaming machine of any one or a combination of two or more of embodiments 4-1 to 4-8 above and 4-10 below, wherein the input from the user for the secondary game corresponds to betting options for the secondary game.

4-10. The gaming machine of any one or a combination of two or more of embodiments 4-1 to 4-9 above, wherein the input from the user for the secondary game corresponds to betting options for the bonus game.

4-11. A method for conducting games, comprising:
providing a primary game at a gaming machine;
determining a result of the wager for the primary game;
providing a secondary game to a user at the gaming machine;
receiving an input from the user for the secondary game and converting an output of the secondary game to correspond with the wager for the primary game; and
providing the output of the secondary game to the user corresponding to the result of the wager.

4-12. The method of any one or a combination of two or more of embodiments 4-11 above and 4-13 to 4-20 below, wherein the one or more selected events are historical horse races; and/or
wherein the secondary game is a table game, the table game comprising one or more of poker, baccarat, blackjack, craps, roulette, a big six wheel or wheel of fortune, pool, pachinko, chemin de fer, pai gow, a lottery, keno, or any other table game, or bingo; and/or
the input from the user for the secondary game comprises one or more of a “hit”, “stay”, “roll”, a predicted winning number, and a predicted winning entity.

4-13. The method of any one or a combination of two or more of embodiments 4-11 to 4-12 above and 4-14 to 4-20 below, wherein the primary game comprises selecting a predicted final outcome and/or predicted final ranking of one or more participants in one or more selected events.

4-14. The method of any one or a combination of two or more of embodiments 4-11 to 4-13 above and 4-15 to 4-20 below, wherein the one or more selected events are selected based on odds of available wagers for said one or more selected events.

4-15. The method of any one or a combination of two or more of embodiments 4-11 to 4-14 above and 4-16 to 4-20 below, wherein the input from the user for the secondary game corresponds to playing the secondary game.

4-16. The method of any one or a combination of two or more of embodiments 4-11 to 4-15 above and 4-17 to 4-20 below, wherein converting an output of the secondary game to correspond with the wager for the primary game comprises automatically providing a bonus game to the player concurrent with the secondary game.

4-17. The method of any one or a combination of two or more of embodiments 4-11 to 4-16 above and 4-18 to 4-20 below, wherein the output of the secondary game includes an initial award of the secondary game and an additional award cumulatively corresponding to the result of the wager in the primary game.

4-18. The method of any one or a combination of two or more of embodiments 4-11 to 4-17 above and 4-19 to 4-20 below, wherein the gaming machine is configured to provide secondary attributes in the secondary game based on the input from the user for the secondary game, the secondary attributes corresponding to an additional award wherein the output of the secondary game includes an initial award and an additional award cumulatively corresponding to the result of the wager in the primary game.

4-19. The method of any one or a combination of two or more of embodiments 4-11 to 4-18 above and 4-20 below, wherein the input from the user for the secondary game corresponds to betting options for the secondary game.

4-20. The method of any one or a combination of two or more of embodiments 4-11 to 4-19 above, wherein the input from the user for the secondary game corresponds to betting options for the bonus game.

4-21. A gaming machine comprising:
a display device configured to display an output to a user;
an input device configured to accept a wager from the user for a primary game, the primary game being based on one or more historic events;
a processor coupled to a memory, the input device and the display device;
the gaming machine configured to:
   provide a secondary game to the user, the secondary game comprising a table game;
   determine a result of the wager for the primary game; and
   provide an output of the secondary game to the user corresponding to the result of the wager.

4-22. The gaming machine of any one or a combination of two or more of embodiments 4-21 above and 4-23 to 4-30 below, wherein the primary game comprises selecting a predicted final outcome and/or predicted final ranking of one or more participants in one or more selected events.

4-23. The gaming machine of any one or a combination of two or more of embodiments 4-21 to 4-22 above and 4-24 to 4-30 below, wherein the one or more selected events are historical horse races; and/or
wherein the secondary game comprises one or more of poker, baccarat, blackjack, craps, roulette, a big six wheel or wheel of fortune, pool, pachinko, chemin de fer, pai gow, a lottery, keno, or any other table game, or bingo.

4-24. The gaming machine of any one or a combination of two or more of embodiments 4-21 to 4-23 above and 4-25 to 4-30 below, wherein the gaming machine is configured to select the one or more selected events based on odds of available wagers for said one or more selected events.

4-25. The gaming machine of any one or a combination of two or more of embodiments 4-21 to 4-24 above and 4-26 to 4-30 below, wherein the gaming machine is configured to receive an input from the user for the secondary game.

4-26. The gaming machine of any one or a combination of two or more of embodiments 4-21 to 4-25 above and 4-27 to 4-30 below, wherein the user input to the secondary game corresponds to a predetermined entertaining display having a result matching the result of the wager for the primary game.

4-27. The gaming machine of any one or a combination of two or more of embodiments 4-21 to 4-26 above and 4-28 to 4-30 below, wherein the gaming machine is further configured to provide a bonus game to the user as part of the secondary game, the output of the secondary game including an initial award and a bonus award cumulatively corresponding to the result of the wager in the primary game.

4-28. The gaming machine of any one or a combination of two or more of embodiments 4-21 to 4-27 above and 4-29 to 4-30 below, wherein the gaming machine is configured to provide secondary attributes in the secondary game based on the input from the user for the secondary game, the secondary attributes corresponding to a bonus award wherein the output of the secondary game includes an initial award and the bonus award cumulatively corresponding to the result of the wager in the primary game.

4-29. The gaming machine of any one or a combination of two or more of embodiments 4-21 to 4-28 above and 4-30, wherein the input from the user for the secondary game corresponds to betting options for the secondary game.

4-30. The gaming machine of any one or a combination of two or more of embodiments 4-21 to 4-29 above, wherein the input from the user for the secondary game corresponds to betting options for the bonus game.

4-31. A method for conducting games, comprising:
providing a primary game at a gaming machine;
determining a result of a wager for the primary game;
providing a secondary game to a user at the gaming machine; and
providing an output of the secondary game to the user corresponding to the result of the wager.

4-32. The method of any one or a combination of two or more of embodiments 4-31 above and 4-33 to 4-41 below, wherein the primary game comprises selecting a predicted final outcome and/or predicted final ranking of one or more participants in one or more selected events.

4-33. The method of any one or a combination of two or more of embodiments 4-31 to 4-32 above and 4-34 to 4-41 below, wherein the one or more selected events are historical horse races; and/or
wherein the secondary game comprises one or more of poker, baccarat, blackjack, craps, roulette, a big six wheel or wheel of fortune, pool, pachinko, chemin de fer, pai gow, a lottery, keno, or any other table game, or bingo.

4-34. The method of any one or a combination of two or more of embodiments 4-31 to 4-33 above and 4-35 to 4-41 below, wherein the one or more selected events are selected based on odds of available wagers for said one or more selected events.

4-35. The method of any one or a combination of two or more of embodiments 4-31 to 4-34 above and 4-36 to 4-41 below, further comprising receiving an input from the user for the secondary game.

4-36. The method of any one or a combination of two or more of embodiments 4-31 to 4-35 above and 4-37 to 4-41 below, wherein the input for the secondary game corresponds to the output of the secondary game and a bonus game comprising a predetermined entertaining display having a result matching the result of the wager for the primary game.

4-37. The method of any one or a combination of two or more of embodiments 4-31 to 4-36 above and 4-38 to 4-41 below, wherein the gaming machine is further configured to provide a bonus game to the user as part of the secondary game, the output of the secondary game including an initial award and a bonus award cumulatively corresponding to the result of the wager in the primary game.

4-38. The method of any one or a combination of two or more of embodiments 4-31 to 4-37 above and 4-39 to 4-41 below, wherein the gaming machine is configured to provide secondary attributes in the secondary game based on the input from the user for the secondary game, the secondary attributes corresponding to a bonus award wherein the output of the secondary game includes an initial award and the bonus award cumulatively corresponding to the result of the wager in the primary game.

4-39. The method of any one or a combination of two or more of embodiments 4-31 to 4-38 above and 4-40 to 4-41 below, wherein the input from the user for the secondary game corresponds to betting options for the secondary game.

4-40. The method of any one or a combination of two or more of embodiments 4-31 to 4-39 above and 4-41 below, wherein the input from the user for the secondary game corresponds to betting options for the bonus game.

4-41. The method of any one or a combination of two or more of embodiments 4-31 to 4-40 above, further comprising providing an output of the primary game to the user, the output of the secondary game and the output of the primary game being displayed to the user simultaneously.

4-42. One or more hardware storage devices or one or more computer-readable mediums having instructions stored therein, which, when executed by one or more processors of a computer device, cause the one or more processors to perform the method according to any one or a combination of two or more of embodiments 4-11 to 4-20 and 4-31 to 4-41 above.

5-1. A gaming machine comprising:
a display device configured to display an output to a user;
an input device configured to accept a wager from the user for a primary game, the primary game being based on one or more historic events;
a processor coupled to a memory, the input device and the display device;
the gaming machine configured to:
   provide a secondary game to the user;
   receive an input from the user for the secondary game and convert the user input to the wager for the primary game;
   determine a result of the wager for the primary game; and
   provide an output of the secondary game to the user corresponding to the result of the wager.

5-2. The gaming machine of any one or a combination of two or more of embodiments 5-1 above and 5-3 to 5-10 below,
wherein the one or more selected events are historical horse races; and/or
wherein the secondary game is a table game, the table game comprising one or more of poker, baccarat, blackjack, craps, roulette, a big six wheel or wheel of fortune, pool, pachinko, chemin de fer, pai gow, a lottery, keno, or any other table game, or bingo; and/or
the input from the user for the secondary game comprises one or more of a “hit”, “stay”, “roll”, a predicted winning number, and a predicted winning entity.

5-3. The gaming machine of any one or a combination of two or more of embodiments 5-1 to 5-2 above and 5-3 to 5-10 below, wherein the primary game comprises selecting a predicted final outcome and/or predicted final ranking of one or more participants in one or more selected events.

5-4. The gaming machine of any one or a combination of two or more of embodiments 5-1 to 5-3 above and 5-5 to 5-10 below, wherein the result of the wager for the primary game is based on a combination of at least two final results of at least two predicted final outcomes and/or predicted final rankings of one or more participants in one or more selected events.

5-5. The gaming machine of any one or a combination of two or more of embodiments 5-1 to 5-4 above and 5-6 to 5-10 below, wherein the input from the user for the secondary game includes a modified wager; and
wherein said converting the input to correspond to the primary game comprises modifying the result of the primary game according to the modified wager and converting an output of the secondary game to correspond with the modified wager for the primary game.

5-6. The gaming machine of any one or a combination of two or more of embodiments 5-1 to 5-5 above and 5-7 to 5-10 below, wherein the modified wager includes a payment beyond an initial payment made in the initial wager.

5-7. The gaming machine of any one or a combination of two or more of embodiments 5-1 to 5-6 above and 5-8 to 5-10 below, wherein the modified wager comprises a secondary, tertiary or more wagers.

5-8. The gaming machine of any one or a combination of two or more of embodiments 5-1 to 5-7 above and 5-9 to 5-10 below, wherein the modified wager corresponds to different scorecards of the primary game than the initial wager.

5-9. The gaming machine of any one or a combination of two or more of embodiments 5-1 to 5-8 above and 5-10 below, wherein the modified wager comprises a combination of two or more final results of two or more predicted final outcomes and/or predicted final rankings of one or more participants in one or more selected events.

5-10. The gaming machine of any one or a combination of two or more of embodiments 5-1 to 5-9 above, wherein the result of the primary game is based on a time or number of predicted final rankings required to match a scorecard.

5-11. A method for conducting games, comprising:
providing a primary game at a gaming machine;
providing a secondary game to a user at the gaming machine;
receiving an input from the user for the secondary game and converting the user input to a wager for the primary game;
determining a result of the wager for the primary game; and
providing an output of the secondary game to the user corresponding to the result of the wager.

5-12. The method of any one or a combination of two or more of embodiments 5-11 above and 5-13 to 5-20 below, wherein the one or more selected events are historical horse races; and/or
wherein the secondary game is a table game, the table game comprising one or more of poker, baccarat, blackjack, craps, roulette, a big six wheel or wheel of fortune, pool, pachinko, chemin de fer, pai gow, a lottery, keno, or any other table game, or bingo; and/or
the input from the user for the secondary game comprises one or more of a “hit”, “stay”, “roll”, a predicted winning number, and a predicted winning entity.

5-13. The method of any one or a combination of two or more of embodiments 5-11 to 5-12 above and 5-14 to 5-20 below, wherein the primary game comprises selecting a predicted final outcome and/or predicted final ranking of one or more participants in one or more selected events.

5-14. The method of any one or a combination of two or more of embodiments 5-11 to 5-13 above and 5-15 to 5-20 below, wherein the result of the wager for the primary game is based on a combination of at least two final results of at least two predicted final outcomes and/or predicted final rankings of one or more participants in one or more selected events.

5-15. The method of any one or a combination of two or more of 5-11 to 5-14 above and 5-16 to 5-20 below, wherein the input from the user for the secondary game includes a modified wager; and
wherein said converting the input to correspond to the primary game comprises modifying the result of the primary game according to the modified wager and converting an output of the secondary game to correspond with the modified wager for the primary game.

5-16. The method of any one or a combination of two or more of embodiments 5-11 to 5-15 above and 5-17 to 5-20 below, wherein the modified wager includes a payment beyond an initial payment made in the initial wager.

5-17. The method of any one or a combination of two or more of embodiments 5-11 to 5-16 above and 5-18 to 5-20 below, wherein the modified wager comprises a secondary, tertiary or more wagers.

5-18. The method of any one or a combination of two or more of embodiments 5-11 to 5-17 above and 5-19 to 5-20 below, wherein the modified wager corresponds to different scorecards of the primary game than the initial wager.

5-19. The method of any one or a combination of two or more of embodiments 5-11 to 5-18 above and 5-20 below, wherein the modified wager comprises a combination of two or more final results of two or more predicted final outcomes and/or predicted final rankings of one or more participants in one or more selected events.

5-20. The method of any one or a combination of two or more of embodiments 5-11 to 5-19 above, wherein the result of the primary game is based on a time or number of predicted final rankings required to match a scorecard.

5-21. A gaming machine comprising:
a display device configured to display an output to a user;
an input device configured to accept a wager from the user for a primary game, the primary game being based on one or more historic events;
a processor coupled to a memory, the input device and the display device;
the gaming machine configured to:
   provide a secondary game to the user;
   receive an input from the user for the secondary game and convert the user input to the wager for the primary game;
   determine a result of the wager for the primary game; and
   provide an output of the secondary game to the user corresponding to the result of the wager.

5-22. The gaming machine of any one or a combination of two or more of embodiments 5-21 above and 5-23 to 5-30 below, wherein the primary game comprises selecting a predicted final outcome and/or predicted final ranking of one or more participants in one or more selected events.

5-23. The gaming machine of any one or a combination of two or more of embodiments 5-21 to 5-22 above and 5-24 to 5-30 below, wherein the one or more selected events are historical horse races; and/or wherein the secondary game comprises one or more of poker, baccarat, blackjack, craps, roulette, a big six wheel or wheel of fortune, pool, pachinko, chemin de fer, pai gow, a lottery, keno, or any other table game, or bingo.

5-24. The gaming machine of any one or a combination of two or more of embodiments 5-21 to 5-23 above and 5-25 to 5-30 below, wherein the primary game includes a plurality of scorecards for determining an award value for the result of the wager for the primary game.

5-25. The gaming machine of any one or a combination of two or more of embodiments 5-21 to 5-24 above and 5-26 to 5-30 below, wherein converting the input to correspond to the primary game comprises selecting and/or forfeiting one or more of the plurality of scorecards.

5-26. The gaming machine of any one or a combination of two or more of embodiments 5-21 to 5-25 above and 5-27 to 5-30 below, wherein the secondary game comprises blackjack.

5-27. The gaming machine of any one or a combination of two or more of embodiments 5-21 to 5-26 above and 5-28 to 5-30 below, wherein betting options in the secondary game each correspond to one of the plurality of scorecards.

5-28. The gaming machine of any one or a combination of two or more of embodiments 5-21 to 5-27 above and 5-29 to 5-30 below, wherein a plurality scorecards are provided for each of a plurality of users, each of the plurality of users having scorecards corresponding to betting options of the secondary game.

5-29. The gaming machine of any one or a combination of two or more of embodiments 5-21 to 5-28 above and 5-30, wherein the award value for the result of the wager for the primary game for one of the plurality of users is compared to an award value for the result of the wager for the primary game for another of the plurality of users to determine a winner.

5-30. The gaming machine of any one or a combination of two or more of embodiments 5-21 to 5-29 above, wherein a dealer is provided with a plurality of scorecards and the award value for the result of the wager for the primary game for one of the plurality of users is compared to an award value for the result of the wager for the primary game for the dealer to determine a winner.

5-31. A method for conducting games, comprising:
providing a primary game at a gaming machine;
providing a secondary game to a user at the gaming machine;
receiving an input from the user for the secondary game and converting the user input to a wager for the primary game;
determining a result of the wager for the primary game; and
providing an output of the secondary game to the user corresponding to the result of the wager.

5-32. The method of any one or a combination of two or more of embodiments 5-31 above and 5-33 to 5-41 below, wherein the primary game comprises selecting a predicted final outcome and/or predicted final ranking of one or more participants in one or more selected events.

5-33. The method of any one or a combination of two or more of embodiments 5-31 to 5-32 above and 5-34 to 5-41 below, wherein the one or more selected events are historical horse races; and/or
wherein the secondary game comprises one or more of poker, baccarat, blackjack, craps, roulette, a big six wheel or wheel of fortune, pool, pachinko, chemin de fer, pai gow, a lottery, keno, or any other table game, or bingo.

5-34. The method of any one or a combination of two or more of embodiments 5-31 to 5-33 above and 5-35 to 5-41 below, wherein the primary game includes a plurality of scorecards for determining an award value for the result of the wager for the primary game.

5-35. The method of any one or a combination of two or more of embodiments 5-31 to 5-34 above and 5-36 to 5-41 below, wherein converting the input to correspond to the primary game comprises selecting and/or forfeiting one or more of the plurality of scorecards.

5-36. The method of any one or a combination of two or more of embodiments 5-31 to 5-35 above and 5-37 to 5-41 below, wherein the secondary game comprises blackjack.

5-37. The method of any one or a combination of two or more of embodiments 5-31 to 5-36 above and 5-38 to 5-41 below, wherein betting options in the secondary game each correspond to one of the plurality of scorecards.

5-38. The method of any one or a combination of two or more of embodiments 5-31 to 5-37 above and 5-39 to 5-41 below, wherein a plurality scorecards are provided for each of a plurality of users, each of the plurality of users having scorecards corresponding to betting options of the secondary game.

5-39. The method of any one or a combination of two or more of embodiments 5-31 to 5-38 above and 5-40 to 5-41 below, wherein the award value for the result of the wager for the primary game for one of the plurality of users is compared to an award value for the result of the wager for the primary game for another of the plurality of users to determine a winner.

5-40. The method of any one or a combination of two or more of embodiments 5-31 to 5-39 above and 5-41 below, wherein a dealer is provided with a plurality of scorecards and the award value for the result of the wager for the primary game for one of the plurality of users is compared to an award value for the result of the wager for the primary game for the dealer to determine a winner.

5-41. One or more hardware storage devices or one or more computer-readable mediums having instructions stored therein, which, when executed by one or more processors of a computer device, cause the one or more processors to perform the method according to any one or a combination of two or more of embodiments 5-11 to 5-20 and 5-31 to 5-40 above.

1. A gaming machine comprising:
a display device configured to display an output to a user;
an input device configured to accept a wager from the user for a primary game, the primary game being based on one or more historic events;
a processor coupled to a memory, the input device and the display device;
the gaming machine configured to:
provide a secondary game to the user;
receive an input from the user for the secondary game and convert the user input to the wager for the primary game;
determine a result of the wager for the primary game; and
provide an output of the secondary game to the user corresponding to the result of the wager.

2. The gaming machine of claim 1,
wherein the one or more selected events are historical horse races; and/or
wherein the secondary game is a table game, the table game comprising one or more of poker, baccarat, blackjack, craps, roulette, a big six wheel or wheel of fortune, pool, pachinko, chemin de fer, pai gow, a lottery, keno, or any other table game, or bingo; and/or
the input from the user for the secondary game comprises one or more of a “hit”, “stay”, “roll”, a predicted winning number, and a predicted winning entity.

3. The gaming machine of claim 1, wherein the primary game comprises selecting a predicted final outcome and/or predicted final ranking of one or more participants in one or more selected events.

4. The gaming machine of claim 3, wherein the gaming machine is configured to select the one or more selected events based on odds of available wagers for said one or more selected events.

5. The gaming machine of claim 1, wherein the input from the user for the secondary game corresponds to betting odds for the secondary game.

6. The gaming machine of claim 1, wherein converting the user input to the wager for the primary game comprises automatically selecting a predicted final outcome and/or predicted final ranking of one or more participants for one or more selected events having wager odds corresponding to the betting odds for the secondary game.

7. The gaming machine of claim 1, wherein the gaming machine is further configured to provide a plurality of secondary games to the user, the outputs of the secondary games cumulatively corresponding to the result of the wager.

8. The gaming machine of claim 3, wherein the gaming machine is configured to select the one or more selected events based on the input from the user for the secondary game.

9. The gaming machine of claim 1, wherein the input from the user for the secondary game corresponds to betting options for the secondary game.

10. The gaming machine of claim 1, wherein converting the user input to the wager for the primary game comprises automatically selecting a scorecard for the primary game based on the betting options selected for the secondary game.

11. A method for conducting games, comprising:
providing a primary game at a gaming machine;
providing a secondary game to a user at the gaming machine;
receiving an input from the user for the secondary game and converting the user input to a wager for the primary game;
determining a result of the wager for the primary game; and
providing an output of the secondary game to the user corresponding to the result of the wager.

12. The method of claim 11, wherein the one or more selected events are historical horse races; and/or
wherein the secondary game is a table game, the table game comprising one or more of poker, baccarat, blackjack, craps, roulette, a big six wheel or wheel of fortune, pool, pachinko, chemin de fer, pai gow, a lottery, keno, or any other table game, or bingo; and/or
the input from the user for the secondary game comprises one or more of a “hit”, “stay”, “roll”, a predicted winning number, and a predicted winning entity.

13. The method of claim 11, wherein the primary game comprises selecting a predicted final outcome and/or predicted final ranking of one or more participants in one or more selected events.

14. The method of claim 13, wherein the one or more selected events are selected based on odds of available wagers for said one or more selected events.

15. The method of claim 11, wherein the input from the user for the secondary game corresponds to betting odds for the secondary game.

16. The method of claim 11, wherein converting the user input to the wager for the primary game comprises automatically selecting a predicted final outcome and/or predicted final ranking of one or more participants for one or more selected events having wager odds corresponding to the betting odds for the secondary game.

17. The method of claim 11, further comprising providing a plurality of secondary games to the user, the outputs of the secondary games cumulatively corresponding to the result of the wager.

18. The method of claim 11, wherein the one or more selected events are selected based on the input from the user for the secondary game.

19. The method of claim 11, wherein the input from the user for the secondary game corresponds to betting options for the secondary game.

20. The method of claim 11, wherein converting the user input to the wager for the primary game comprises automatically selecting a scorecard for the primary game based on the betting options selected for the secondary game.

21. One or more computer-readable mediums having stored thereon instructions, which, when executed by one or more processors of a computer device cause the one or more processors to perform the method according to claim 11.
